(19) United States
(12) Patent Application Publication
(10) Pub. No.: US 2022/0193587 A1
(43) Pub. Date: Jun. 23, 2022

(54) FILTER MEDIA COMPRISING FIBRILLATED FIBERS AND GLASS FIBERS

(71) Applicant: Hollingsworth & Vose Company, East Walpole, MA (US)

(72) Inventors: Xinquan Cheng, Nashua, NH (US); Sudhakar Jaganathan, Northborough, MA (US); Sudheer Jinka, Pelham, NH (US); Praveen Kumar Yegya Raman, Nashua, NH (US)

(73) Assignee: Hollingsworth & Vose Company, East Walpole, MA (US)

(21) Appl. No.: 17/166,526

(22) Filed: Feb. 3, 2021

Related U.S. Application Data
(63) Continuation-in-part of application No. 17/127,830, filed on Dec. 18, 2020.

(51) Int. Cl. B01D 39/16

(52) U.S. Cl. CPC B01D 39/1623; B01D 2239/0618; B01D 2239/065; B01D 2239/1233

(57) ABSTRACT

Filter media comprising non-woven fiber webs having one or more advantageous physical properties are generally described. In some embodiments, a filter media and/or non-woven fiber web described herein comprises a combination of fibers that results in enhanced physical properties. For example, the non-woven fiber web may comprise a combination of fiber types that is advantageous, such as a combination comprising fibrillated fibers, glass fibers, and/or binder fibers. In some cases, the filter media and/or non-woven fiber web comprising the combination of fibers may be formed into undulations (e.g., by a creping and/or microcreping process) to further enhance the physical properties of the filter media and/or non-woven fiber.

### RELATED APPLICATIONS

This application is a continuation-in-part of U.S. patent application Ser. No. 17/127,830, filed Dec. 18, 2020, and entitled “Filter Media Comprising Fibrillated Fibers and Glass Fibers”, which is incorporated herein by reference in its entirety for all purposes.

### FIELD

The present invention relates generally to filter media, and, more particularly, to filter media comprising fibrillated fibers and glass fibers. Some such filter media may further comprise binder fibers.

### BACKGROUND

Filter media may be employed in a variety of applications. For instance, filter media may be employed to remove contaminants from fluids. Some filter media may exhibit undesirable properties such as low dust holding capacities, low filtration efficiencies, and/or poor mechanical strength. Additionally, some filter media may experience fiber shedding and cleanliness issues.

Accordingly, improved filter media designs are needed.

### SUMMARY

Filter media, related components, and related methods are generally described.

In some embodiments, a filter media is provided. The filter media comprises a non-woven fiber web comprising fibrillated fibers, glass fibers, and binder fibers. The fibrillated fibers have an average Canadian Standard Freeness value of greater than or equal to 105 mL. The glass fibers are present in an amount of greater than 20 wt % of the non-woven fiber web. The binder fibers are present in an amount of greater than or equal to 11 wt % of the non-woven fiber web.

In some embodiments, a filter media comprises a non-woven fiber web comprising fibrillated fibers and glass fibers. The glass fibers have an average fiber diameter D_{glass}. D_{glass} is measured in microns. The fibrillated fibers have an average Canadian Standard Freeness value measured in mL. The average Canadian Standard Freeness value of the fibrillated fibers deviates from CSF_{fibrillated} in the following equation by less than or equal to 50%: D_{glass}=0.25+0.0045 CSF_{fibrillated}. CSF_{fibrillated} is measured in mL.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic depiction showing a cross-section of a filter media, according to one set of embodiments;

FIG. 2 is a schematic depiction showing a cross-section of a non-woven fiber web, according to one set of embodiments;

FIG. 3 is a schematic depiction showing a cross-section of a filter media comprising more than one non-woven fiber web, according to one set of embodiments;

FIG. 4 is a schematic depiction showing a cross-section of a filter media comprising more than two non-woven fiber webs, according to one set of embodiments;

FIG. 5 is a schematic depiction of a non-woven fiber web comprising a plurality of undulations, according to one set of embodiments;

FIG. 6 is a schematic depiction of a filter media including a non-woven fiber web that comprises a second plurality of undulations positioned within a first plurality of undulations and is pleated, according to one set of embodiments;

FIGS. 7A and 7B are schematic depictions of a non-woven fiber web comprising two pluralities of undulations, according to one set of embodiments;

FIG. 8 is a plot of initial efficiency and dust holding capacity (DHC) of various non-woven fiber webs, according to one set of embodiments;

FIG. 9 is a plot of air permeability of various non-woven fiber webs, according to one set of embodiments;

FIG. 10 is a plot showing the correlation between average fiber diameter of glass fibers and Canadian Standard Freeness value of fibrillated fibers, according to one set of embodiments;

FIG. 11 is a plot of initial efficiency and dust holding capacity versus average fiber diameter of glass fibers for various non-woven fiber webs, according to one set of embodiments;

FIG. 12 is a plot of initial efficiency and dust holding capacity versus amount of glass fibers for various non-woven fibers comprising fibrillated fibers having an average Canadian Standard Freeness value of 120 mL and glass fibers having an average fiber diameter of 0.8 microns, according to one set of embodiments;

FIG. 13 is a plot of initial efficiency and dust holding capacity versus amount of glass fibers for various non-woven fiber webs comprising fibrillated fibers having an average Canadian Standard Freeness value of 50 mL and glass fibers having an average fiber diameter of 0.6 microns, according to one set of embodiments;

FIG. 14 is a plot of air permeability versus amount of glass fibers for non-woven fiber webs containing fibrillated fibers with different levels of fibrillation, according to one set of embodiments; and

FIG. 15 is a plot of fuel gamma versus amount of glass fibers in a non-woven fiber web, according to one set of embodiments.

### DETAILED DESCRIPTION

Filter media comprising non-woven fiber webs having one or more advantageous physical properties are generally described. In some embodiments, a filter media and/or non-woven fiber web described herein comprises a combination of fibers that results in enhanced physical properties. For example, the non-woven fiber web may comprise a combination of fiber types that is advantageous, such as a combination comprising fibrillated fibers, glass fibers, and/or binder fibers. In some cases, the filter media and/or non-woven fiber web comprising the combination of fibers may be undulated to further enhance the physical properties of the filter media and/or non-woven fiber web.

Non-woven fiber webs and filter media comprising one or more of the fiber types described herein may have certain advantages that can result in desirable fiber web and/or filter media properties. For example, glass fibers may enhance liquid filtration efficiency of the fiber webs in which they are positioned due to their small fiber size. As another example, fibrillated fibers may enhance the wet strength of non-woven fiber webs in which they are positioned, may have high mechanical flexibility, may exhibit low fiber migration, may exhibit low fiber shedding, and/or may enhance the cleanliness of the non-woven fiber webs in which they are positioned.

Some embodiments relate to non-woven fiber webs comprising two or more types of fibers that each contribute different benefits thereto. For instance, in some embodiments, a non-woven fiber web and/or filter media comprises a combination of fibers comprising fibrillated fibers, glass fibers, and/or binder fibers. Some or all of the fiber types in the combination of fibers may lead to one or more advantageous properties. For example, some combinations may comprise fibrillated fibers that have a particularly advantageous level of fibrillation (e.g., an average Canadian Standard Freeness value of greater than or equal to 105 mL), which may enhance one or more physical properties (e.g., air permeability, dust holding capacity, etc.) and/or mechanical properties of the non-woven fiber web and/or filter media (e.g., wet strength, flexibility, reduced fiber shedding, enhanced cleanliness, etc.). Alternatively or additionally, glass fibers, when used in a particular amount (e.g., greater than 20 wt % of the non-woven fiber web) and/or having a particular range of average fiber diameters, may improve the initial filtration efficiency and dust holding capacity of the non-woven fiber web and/or filter media. In some embodiments, a filter media comprises a combination of glass fibers, fibrillated fibers, and binder fibers that enhances one or more physical properties of the non-woven fiber web and/or filter media (e.g., dust holding capacity, filtration efficiency, air permeability, fuel gamma, Mullen burst strength, tensile strength, tensile elongation at break, media cleanliness, fiber shedding, etc.), compared to a non-woven fiber web and/or filter media lacking glass fibers and/or fibrillated fibers.

In some embodiments, a non-woven fiber web comprises a combination of fibers that are matched in one or more ways. As one example, a non-woven fiber web may comprise fibrillated fibers and glass fibers, and the average level of fibrillation of the fibrillated fibers may be matched to the average fiber diameter of the glass fibers. The matching may comprise selecting fibrillated fibers that affect the air permeability of the non-woven fiber web in a relatively similar manner. For instance, the air permeability of the non-woven fiber web may be independent of the relative amounts of the glass fibers and fibrillated fibers therein. Such non-woven fiber webs may advantageously have an air permeability in a favorable range and display the advantages associated with using both fibrillated fibers and glass fibers described elsewhere herein.

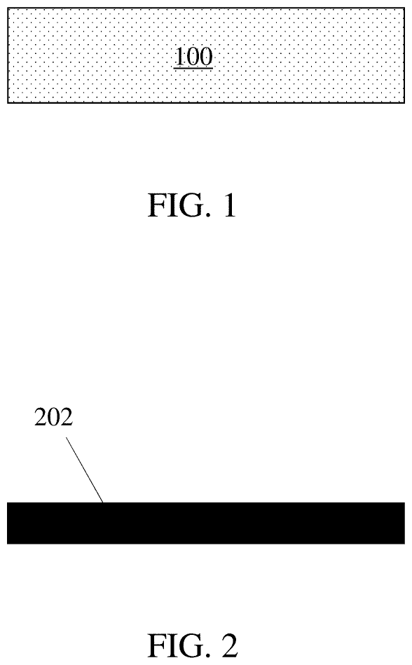

FIG. 1 shows one non-limiting embodiment of a filter media 100. In some embodiments, a filter media comprises a non-woven fiber web. FIG. 2 shows one non-limiting example of a non-woven fiber web 202 that may be positioned in a filter media (e.g., a filter media like the filter media 100 shown in FIG. 1). In some embodiments, the non-woven fiber web is a non-woven fiber web of a first type as described elsewhere herein, such as a non-woven fiber web of the first type comprising fibrillated fibers, glass fibers, and/or binder fibers.

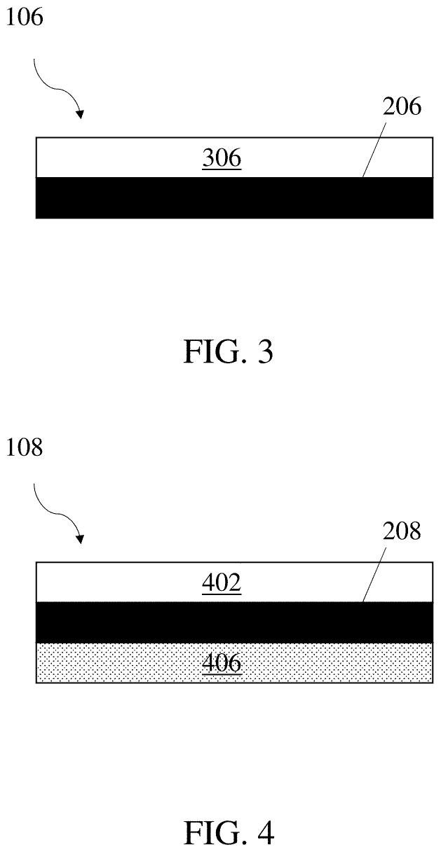

In some embodiments, a filter media comprises a single layer that is a non-woven fiber web (e.g., as shown in FIG. 2). However, it should be noted that filter media may comprise two or more layers that are non-woven fiber webs. For example, in some embodiments, a filter media comprises two or more layers, one or more of which may be non-woven fiber webs (e.g., non-woven fiber web of the first type). FIG. 3 shows one example of a filter media having this property. In FIG. 3, a filter media 106 comprises a first layer 206 that is a non-woven fiber web (e.g., non-woven fiber web of the first type) and a second layer 306. In some embodiments, a media comprises three or more layers, four or more layers, or even more layers. It should be noted that any additional layers present (e.g., the second layer 306 in FIG. 3) may be non-woven fiber webs (e.g., non-woven fiber web of the first type, non-woven fiber webs of another type) or may be types of layers other than non-woven fiber webs. As an example of the former, in some embodiments, a filter media comprises a solvent spun layer (e.g., an electrospun layer, such as a melt-electrospun layer, a centrifugal spun layer), a spunbond layer, and/or a meltblown layer.

It should be noted that the one or more additional layer may be disposed in any suitable location in the filter media. For instance, although FIG. 3 shows an embodiment in which the second layer is disposed directly above the first layer 206 that is a non-woven fiber web (e.g., a non-woven fiber web of the first type), it is also possible for the second layer to be positioned below the first layer. In embodiments where the filter media comprises more than two layers (e.g., three or more layers, etc.), a non-woven fiber web (e.g., non-woven fiber web of the first type) may be disposed between any two layers and/or on top or below any appropriate layers. For instance, as shown in FIG. 4, a filter media 108 may comprise three layers that are non-woven fiber webs, in which a first layer 208 (e.g., a non-woven web identical to the non-woven fiber webs 202 in FIG. 2 and 206 in FIG. 3) may be disposed between two other layers (e.g., layers 402 and 406).

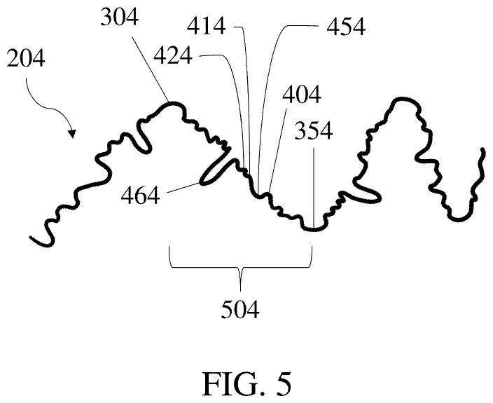

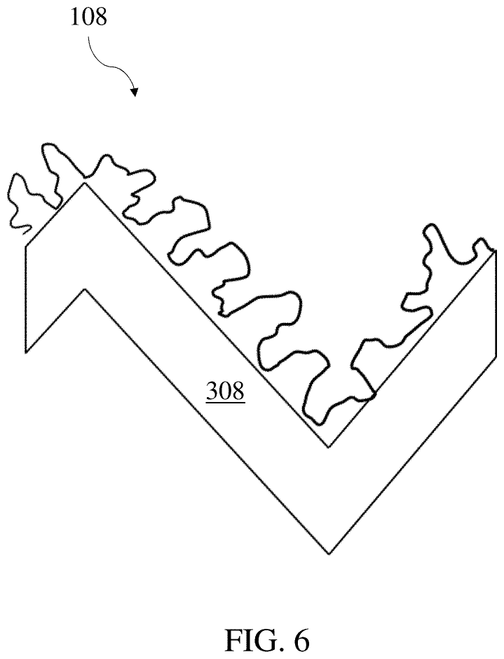

Some non-woven fiber webs described herein (e.g., non-woven fiber web of a first type) comprise two or more pluralities of undulations. FIG. 5 schematically depicts one example of a non-woven fiber web having this property. In FIG. 5, the non-woven fiber web 204 comprises a first plurality of undulations comprising a peak 304 and a trough 354. The non-woven fiber web 204 depicted in FIG. 5 further comprises a second plurality of undulations comprising a peak 404 and a trough 454.

In some embodiments, like the embodiment shown in FIG. 5, a non-woven fiber web comprises a second plurality of undulations that is positioned within a first plurality of undulations. For instance, in some embodiments, a non-woven fiber web may comprise portions that are positioned between the peaks and the troughs of the first plurality of undulations and a second plurality of undulations that is present in one or more of these portions. With reference to FIG. 5, the portion 504 of the non-woven fiber web 204 is positioned between the peak 304 and the trough 354 and a second plurality of undulations is present therein. A plurality of undulations that is positioned within another plurality of undulations may start and terminate in a portion of the non-woven fiber web positioned between a peak present in the first plurality of undulations and an adjacent trough (e.g., a trough not separated from the peak by any other peaks).

In some embodiments, a non-woven fiber web (e.g., a non-woven fiber web of the first type described herein) comprises one or more pluralities of undulations that are irregular. For instance, in a non-woven fiber web comprising a first and second plurality of undulations in which the second plurality of undulations is positioned within the first plurality of undulations, either or both of the first and second plurality of undulations may be irregular. The irregularity may take the form of variations in peak height, trough depth, peak spacing, trough spacing, peak shape, and/or trough spacing across the plurality of undulations. With reference to FIG. 5, the trough 464 has a different depth and shape than the trough 454 although both belong to the same plurality of undulations. As another example, and also with reference to FIG. 5, the spacing between the peak 404 and the peak 414 is different from the spacing between the peak 414 and the peak 424. Although not shown in FIG. 5, it is possible for a plurality of undulations that is irregular to have one or more regular features. For instance, a plurality of undulations that is irregular may have one or more irregular features but also have one or more regular features. As one example, a plurality of undulations that is irregular may comprise peaks of differing heights but common shapes and spacings. It is also possible for a plurality of undulations to be irregular in many ways.

Some non-woven fiber webs may comprise two or more pluralities of undulations that are positioned within a first plurality of undulations. As one example, and as shown in FIG. 5, such pluralities of undulations may span each portion of the non-woven fiber web positioned between an adjacent peak and an adjacent trough. However, it is also possible for a non-woven fiber web to comprise a first plurality of undulations comprising some pairs of adjacent peaks and troughs between which a further plurality of undulations is positioned and some pairs of adjacent peaks and troughs between which no further plurality of undulations is positioned.

One or more layers in the filter media may be a layer comprising two or more pluralities of undulations. In some embodiments, a filter media comprises two or more layers that each comprise two or more pluralities of undulations. For instance, a filter media may comprise two or more layers that are undulated together and/or two or more layers that are undulated separately. In layers that are undulated together, the peaks and troughs in the undulations in the different layers may substantially track each other. Layers that are undulated together and directly adjacent to each other may directly contact each other over relatively large portions of their directly adjacent surfaces. Layers that are undulated separately may lack peaks and troughs that substantially track each other and/or, for layers that are undulated separately and directly adjacent to each other, may have adjacent surfaces including substantial portions that are not in direct contact with each other.

It should also be noted that it is also possible for one or more layers in the filter media to lack any undulations at all. Layers that lack undulations may be positioned on external surfaces of the filter media, adjacent layers comprising two or more pluralities of undulations, and/or between layers that comprise two or more pluralities of undulations. In some embodiments, a filter media comprises two external layers that lack undulations and/or include fewer than two pluralities of undulations. One or more layers comprising two or more pluralities of undulations may be positioned between such external layers.

In some embodiments, a filter media is pleated. Such filter media may comprise one or more non-woven fiber webs comprising two or more pluralities of undulations, or may lack such fiber webs. When the filter media comprises a non-woven fiber web comprising two or more pluralities of undulations, the pleats may be on a different length scale than the pluralities of undulations. For instance, the pleats may comprise one or more features (e.g., peaks, troughs) with a size greater in magnitude than a feature (e.g., a peak, a trough) of some or all of the pluralities of undulations. It is also possible for the pluralities of undulations present in one or more non-woven fiber webs and/or layers to have, at least partially, a different orientation than undulations forming the pleats. A non-limiting example of a filter media including a non-woven fiber web that comprises a second plurality of undulations positioned within a first plurality of undulations and is pleated is shown in FIG. 6. As illustrated in FIG. 6, a filter media 108 may include a non-woven fiber web 208 (e.g., non-woven fiber web of the first type) comprising a second plurality of undulations positioned within a first plurality of undulations, may include a second layer 308, and may be pleated. Filter media may comprise non-woven fiber webs comprising two or more pluralities of undulations in addition to any pleats that are external layers or inner layers. Similarly, filter media may comprise external and/or internal layers lacking undulations other than pleats.

As described elsewhere herein, some embodiments relate to methods of manufacturing filter media with the assistance of a creper, such as a microcreper. The method may comprise passing a non-woven fiber web through the creper to form a creped non-woven fiber web. The non-woven fiber web may be passed through the creper when in the form of a single, stand-alone layer, or the non-woven fiber web may be positioned in a stack of layers that are together creped. After passing through the creper, the non-woven fiber web may be assembled with one or more further layers (e.g., that may comprise creped layers and/or uncreped layers) and/or positioned in a filter element.

Crepers are instruments that form undulations in articles passed therethrough. Crepers may include a drive roll, a pressing member, and a retarding member. The filter media being creped may be pressed onto the drive roll by the pressing member and retarded by a retarding member. The pressing member may advance the roll and the filter media disposed thereon forward, and the retarding member may resist forward motion of the article. The interplay between the pressing member and the retarding member may cause the filter media disposed on the drive roll to wrinkle and/or develop undulations, such as undulations having one or more of the features described herein. In some embodiments, filter media formed by a creping process comprise one or more portions that are compressed through their thicknesses (e.g., troughs in a plurality of undulations). Suitable crepers include microcrepers that may be obtained from Micrex corporation. Additionally, further details regarding some types of microcrepers are provided in U.S. Pat. Nos. 7,854,046, 3,260,778, 3,810,280, 4,090,385, 4,894,196, 4,717,329, 5,969,349, 5,666,703, and 5,678,288, each of which are incorporated herein by reference in their entirety.

As mentioned, according to some embodiments, a filter media comprises a non-woven fiber web of a first type. In some such embodiments, the filter media comprises a single layer that is a non-woven fiber web of a first type. For instance, a filter media may comprise a single non-woven fiber web of the first type that serves as an efficiency layer. It is also possible for a filter media to comprise two or more layers that are non-woven fiber webs of the first type. For example, the filter media may comprise a first non-woven fiber web of the first type that serves as a prefilter layer and a second non-woven fiber web of the first type that serves as an efficiency layer. In some embodiments, a filter media comprising at least one non-woven fiber web of the first type (e.g., exactly one, two or more) may additionally include other types of non-woven fiber webs, as described in further detail elsewhere herein. Non-limiting examples of suitable structures for non-woven fiber webs of the first type include wet laid non-woven fiber webs and carded non-woven fiber webs. In some embodiments, a filter media may comprise a non-woven fiber web of the first type that is a composite of two or more non-woven fiber webs (e.g., two or more previously-identified non-woven fiber webs).

In some embodiments, a non-woven fiber web of the first type comprises fibrillated fibers. A fibrillated fiber may include a parent fiber that branches into smaller diameter fibrils, which can, in some instances, branch further out into even smaller diameter fibrils with further branching also being possible. The branched nature of the fibrils may enhance the surface area of a non-woven fiber web in which the fibrillated fibers are employed, and can increase the number of contact points between the fibrillated fibers and other fibers in the non-woven fiber web. Such an increase in points of contact between the fibrillated fibers and other fibers in the non-woven fiber web may enhance one or more mechanical properties (e.g., flexibility, strength, liquid filtration efficiency) of the non-woven fiber web.

Fibrillated fibers may make up a variety of suitable amounts of the non-woven fiber webs of the first type described herein. In some embodiments, fibrillated fibers make up greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, or greater than or equal to 65 wt % of a non-woven fiber web of the first type. In some embodiments, fibrillated fibers make up less than or equal to 69 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % a non-woven fiber web of the first type. Combinations of the above-referenced ranges are also possible (e.g., greater than or equal to 1 wt % and less than or equal to 69 wt %, or greater than or equal to 10 wt % and less than or equal to 50 wt %, or greater than or equal to 20 wt % and less than or equal to 40 wt %). Other ranges are also possible.

When a non-woven fiber web of the first type comprises two or more types of fibrillated fibers, each type of fibrillated fiber may independently make up an amount of the non-woven fiber web of the first type in one or more of the ranges described above and/or all of the fibrillated fibers in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of fibrillated fiber in one or more of the ranges described above and/or may comprise a total amount of fibrillated fibers in one or more of the ranges described above.

Some fibrillated fibers comprise synthetic fibrillated fibers, non-limiting examples of which include poly(ester) fibers, poly(acrylonitrile) fibers, nylon fibers, poly(aramid) fibers (e.g., para-poly(aramid) fibers, meta-poly(aramid) fibers), poly(imide) fibers, poly(olefin) fibers (e.g., poly(ethylene) fibers, poly(propylene) fibers), poly(ether ether ketone) fibers, poly(ethylene terephthalate) fibers, acrylic fibers, liquid crystal polymeric fibers (e.g., poly(p-phenylene-2,6-benzobisoxazole fibers; poly(ester)-based liquid crystal polymers, such as fibers produced by the polycondensation of 4-hydroxybenzoic acid and 6-hydroxynaphthalene-2-carboxylic acid), nano-cellulose, regenerated cellulose (e.g., lyocell, rayon), celluloid, cellulose acetate, and carboxymethylcellulose. Such synthetic fibrillated fibers may also be considered to be a type of synthetic fiber as described elsewhere herein. It is also possible for the fibrillated fibers to, alternatively or additionally, comprise natural fibers, such as natural cellulose fibers, cotton fibers, and/or wool. When a fiber web comprises natural cellulose fibers, the natural cellulose fibers may be wood (e.g., cedar) fibers, such as softwood fibers and/or hardwood fibers. It is also possible for the natural cellulose fibers to be non-wood fibers. In one set of embodiments, a non-woven fiber web of the first type comprises fibrillated fibers that comprise lyocell. Lyocell fibers may be produced from regenerated cellulose by solvent spinning.

Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, CT (“Westvaco fibers”), and (6) Georgia-Pacific, Atlanta, Ga. (“Leaf River fibers”). When a filter media comprises two or more non-woven fiber webs of the first type, each non-woven fiber web of the first type may independently comprise one or more of the above-described types of fibrillated fibers.

Fibrillated fibers in a non-woven fiber web of a first type may have a variety of suitable dimensions. As mentioned, a fibrillated fiber may include a parent fiber and fibrils. In some embodiments, the parent fibers may have an average fiber diameter of greater than or equal to 1 micron, greater than or equal to 2 microns, greater than or equal to 3 microns, greater than or equal to 5 microns, greater than or equal to 7.5 microns, greater than or equal to 10 microns, greater than or equal to 12.5 microns, greater than or equal to 15 microns, or greater than or equal to 17.5 microns. In some embodiments, the parent fibers may have an average fiber diameter of less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 3 microns, or less than or equal to 2 microns. Combinations of the above-referenced ranges are also possible (e.g., greater than or equal to 1 micron and less than or equal to 20 microns). Other ranges are also possible.

When a non-woven fiber web of the first type comprises two or more types of fibrillated fibers, each type of fibrillated fiber may independently have an average fiber diameter for the parent fibers in one or more of the ranges described above and/or all of the fibrillated fibers in a non-woven fiber web of the first type may together have an average fiber diameter for the parent fibers in one or more of the ranges described above. Similarly, when a filter media comprises two or more non-woven fiber webs of the first type, each non-woven fiber web of the first type may independently comprise one or more types of fibrillated fibers having an average fiber diameter for the parent fibers in one or more of the ranges described above and/or may comprise fibrillated fibers that overall have an average fiber diameter for the parent fibers in one or more of the ranges described above.

In some embodiments, fibrillated fibers present in a non-woven fiber web of the first type comprise fibrils having an average fiber diameter of greater than or equal to 0.1 microns, greater than or equal to 0.2 microns, greater than or equal to 0.3 microns, greater than or equal to 0.4 microns, greater than or equal to 0.5 microns, greater than or equal to 0.6 microns, greater than or equal to 0.8 microns, greater than or equal to 1 micron, greater than or equal to 1.2 microns, greater than or equal to 1.4 microns, greater than or equal to 1.6 microns, greater than or equal to 1.8 microns, greater than or equal to 2 microns, greater than or equal to 2.5 microns, greater than or equal to 3 microns, or greater than or equal to 3.5 microns. In some embodiments, the fibrils may have an average fiber diameter of less than or equal to 4 microns, less than or equal to 3.5 microns, less than or equal to 3 microns, less than or equal to 2.5 microns, less than or equal to 2 microns, less than or equal to 1.8 microns, less than or equal to 1.6 microns, less than or equal to 1.4 microns, less than or equal to 1.2 microns, less than or equal to 1 micron, less than or equal to 0.8 microns, less than or equal to 0.6 microns, less than or equal to 0.5 microns, less than or equal to 0.4 microns, less than or equal to 0.3 microns, or less than or equal to 0.2 microns. Combinations of the above-referenced ranges are also possible (e.g., greater than or equal to 0.1 microns and less than or equal to 4 microns). Other ranges are also possible.

When a non-woven fiber web of the first type comprises two or more types of fibrillated fibers, each type of fibrillated fiber may independently have an average fiber diameter for the fibrils in one or more of the ranges described above and/or all of the fibrillated fibers in a non-woven fiber web of the first type may together have an average fiber diameter for the fibrils in one or more of the ranges described above. Similarly, when a filter media comprises two or more non-woven fiber webs of the first type, each non-woven fiber web of the first type may independently comprise one or more types of fibrillated fibers having an average fiber diameter for the fibrils in one or more of the ranges described above and/or may comprise fibrillated fibers that overall have an average fiber diameter for the and fibrils in one or more of the ranges described above.

Fibrillated fibers may have a variety of suitable average lengths. In some embodiments, a non-woven fiber web of the first type comprises fibrillated fibers having an average length of greater than or equal to 0.01 inches, greater than or equal to 0.03 inches, greater than or equal to 0.05 inches, greater than or equal to 0.1 inches, greater than or equal to 0.2 inches, greater than or equal to 0.3 inches, greater than or equal to 0.4 inches, greater than or equal to 0.5 inches, greater than or equal to 0.6 inches, greater than or equal to 0.7 inches, greater than or equal to 0.8 inches, or greater than or equal to 0.9 inches. In some embodiments, a non-woven fiber web of the first type comprises fibrillated fibers having an average length of less than or equal to 1 inch, less than or equal to 0.9 inches, less than or equal to 0.8 inches, less than or equal to 0.7 inches, less than or equal to 0.6 inches, less than or equal to 0.5 inches, less than or equal to 0.4 inches, less than or equal to 0.3 inches, less than or equal to 0.2 inches, less than or equal to 0.1 inches, less than or equal to 0.05 inches, less than or equal to 0.03 inches, or less than or equal to 0.02 inches. Combinations of the above-referenced ranges are also possible (e.g., greater than or equal to 0.01 inches and less than or equal to 1 inch, greater than or equal to 0.1 inches and less than or equal to 0.5 inches, or greater than or equal to 0.1 inches and less than or equal to 0.3 inches). Other ranges are also possible.

When a non-woven fiber web of the first type comprises two or more types of fibrillated fibers, each type of fibrillated fiber may independently have an average fiber length in one or more of the ranges described above and/or all of the fibrillated fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of fibrillated fibers having an average fiber length in one or more of the ranges described above and/or may comprise fibrillated fibers that overall have an average fiber length in one or more of the ranges described above.

Fibrillated fibers may have a variety of suitable average levels of fibrillation. In some embodiments, a non-woven fiber web of the first type comprises fibrillated fibers having a particularly beneficial level of fibrillation that results in one or more enhanced physical properties (e.g., dust holding capacity, air permeability, tensile strength, tensile elongation at break, etc.). In some embodiments, a non-woven fiber web of the first type comprises fibrillated fibers having an average level of fibrillation (i.e., average Canadian Standard Freeness value) of greater than or equal to 10 mL, greater than or equal to 15 mL, greater than or equal to 20 mL, greater than or equal to 50 mL, greater than or equal to 75 mL, greater than or equal to 100 mL, greater than or equal to 105 mL, greater than or equal to 110 mL, greater than or equal to 115 mL, greater than or equal to 120 mL, greater than or equal to 125 mL, greater than or equal to 150 mL, greater than or equal to 175 mL, greater than or equal to 200 mL, greater than or equal to 250 mL, greater than or equal to 300 mL, greater than or equal to 400 mL, greater than or equal to 500 mL, greater than or equal to 600 mL, or greater than or equal to 700 mL. In some embodiments, a non-woven fiber web of the first type comprises fibrillated fibers having an average level of fibrillation of less than or equal to 800 mL, less than or equal to 700 mL, less than or equal to 600 mL, less than or equal to 500 mL, less than or equal to 400 mL, less than or equal to 300 mL, less than or equal to 250 mL, less than or equal to 200 mL, less than or equal to 175 mL, less than or equal to 150 mL, less than or equal to 125 mL, less than or equal to 120 mL, less than or equal to 115 mL, less than or equal to 110 mL, less than or equal to 105 mL, less than or equal to 100 mL, less than or equal to 75 mL, less than or equal to 50 mL, less than or equal to 20 mL, less than or equal to 15 mL, or less than or equal to 10 mL. Combinations of the above-referenced ranges are also possible (e.g., greater than or equal to 10 mL and less than or equal to 800 mL, greater than or equal to 50 mL and less than or equal to 500 mL, or greater than or equal to 100 mL and less than or equal to 300 mL). Other ranges are also possible.

The average level of fibrillation of fibrillated fibers can be measured according to a Canadian Standard Freeness test, specified by TAPPI test method T-227-om-09 Freeness of pulp (2009). The test can provide an average level of fibrillation (i.e., average Canadian Standard Freeness value) in mL. This average level of fibrillation is a characteristic of the plurality of fibers being measured. In other words, a plurality of fibers having a certain average level of fibrillation may comprise some fibers that have a higher degree of fibrillation than that average and some fibers that have a lower degree of fibrillation than that average. It is also possible for a plurality of fibers to comprise, consist essentially of, and/or consist of, fibers having a level of fibrillation that is identical to the average level of fibrillation for the plurality.

When a non-woven fiber web of the first type comprises two or more types of fibrillated fibers, each type of fibrillated fiber may independently have an average level of fibrillation in one or more of the ranges described above and/or all of the fibrillated fibers in a non-woven fiber web of the first type may together have an average level of fibrillation in one or more of the ranges described above. Similarly, when a filter media comprises two or more non-woven fiber webs of the first type, each non-woven fiber web of the first type may independently comprise one or more types of fibrillated fibers having an average level of fibrillation in one or more of the ranges described above and/or may comprise fibrillated fibers that overall have an average level of fibrillation in one or more of the ranges described above.

In some embodiments, a non-woven fiber web of the first type includes glass fibers. Examples of glass fibers may include chopped strand glass fibers and microglass fibers. In some embodiments, the non-woven fiber web of the first type may comprise microglass fibers and/or chopped strand glass fibers.

As mentioned, in some embodiments, a non-woven fiber web of the first type comprises glass fibers. In some such embodiments, the non-woven fiber web of the first type comprises glass fibers at a particularly beneficial amount that may result in one or more enhanced physical properties (e.g., dust holding capacity, air permeability, filtration efficiency, etc.) of the non-woven fiber web and/or filter media. In some embodiments, glass fibers make up greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, or greater than or equal to 85 wt % of the non-woven fiber web of the first type. In some embodiments, glass fibers make up less than or equal to 88 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, or less than or equal to 20 wt % of the non-woven fiber web of the first type. Combinations of the above-referenced ranges are also possible (e.g., greater than or equal to 20 wt % and less than or equal to 88 wt %, greater than or equal to 20 wt % and less than or equal to 60 wt %, or greater than or equal to 20 wt % and less than or equal 40 wt %). Other ranges are also possible.

When a non-woven fiber web of the first type comprises two or more types of glass fibers, each type of glass fiber may independently make up an amount of the non-woven fiber web of the first type in one or more of the ranges described above and/or all of the glass fibers in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of glass fiber in one or more of the ranges described above and/or may comprise a total amount of glass fibers in one or more of the ranges described above.

Glass fibers may have a variety of suitable average fiber diameters. In some embodiments, a non-woven fiber web of the first type comprises glass fibers having an average fiber diameter of greater than or equal to 0.1 microns, greater than or equal to 0.15 microns, greater than or equal to 0.20 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, or greater than or equal to 25 microns. In some embodiments, a non-woven fiber web of the first type comprises glass fibers having an average fiber diameter of less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.1 microns. Combinations of the above-referenced ranges are also possible (e.g., greater than or equal to 0.1 microns and less than or equal to 30 microns, greater than or equal to 0.25 microns and less than or equal to 10 microns, greater than or equal to 0.4 microns and less than or equal to 5 microns, or greater than or equal to 0.2 microns and less than or equal to 2 microns). Other ranges are also possible.

When a non-woven fiber web of the first type comprises two or more types of glass fibers, each type of glass fiber may independently have an average fiber diameter in one or more of the ranges described above and/or all of the glass fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of glass fibers having an average fiber diameter in one or more of the ranges described above and/or may comprise glass fibers that overall have an average fiber diameter in one or more of the ranges described above.

Glass fibers may have a variety of suitable average fiber lengths. In some embodiments, a non-woven fiber web of the first type comprises glass fibers having an average fiber length of greater than or equal to 0.001 inches, greater than or equal to 0.002 inches, greater than or equal to 0.003 inches, greater than or equal to 0.004 inches, greater than or equal to 0.006 inches, greater than or equal to 0.008 inches, greater than or equal to 0.01 inches, greater than or equal to 0.025 inches, greater than or equal to 0.05 inches, greater than or equal to 0.075 inches, greater than or equal to 0.1 inches, greater than or equal to 0.2 inches, greater than or equal to 0.3 inches, greater than or equal to 0.4 inches, greater than or equal to 0.5 inches, greater than or equal to 0.6 inches, greater than or equal to 0.75 inches, or greater than or equal to 0.9 inches. In some embodiments, a non-woven fiber web of the first type comprises glass fibers having an average fiber length of less than or equal to 1 inch, less than or equal to 0.9 inches, less than or equal to 0.75 inches, less than or equal to 0.6 inches, less than or equal to 0.5 inches, less than or equal to 0.4 inches, less than or equal to 0.3 inches, less than or equal to 0.2 inches, less than or equal to 0.1 inches, less than or equal to 0.075 inches, less than or equal to 0.05 inches, less than or equal to 0.025 inches, less than or equal to 0.01 inches, less than or equal to 0.008 inches, less than or equal to 0.006 inches, less than or equal to 0.004 inches, less than or equal to 0.003 inches, less than or equal to 0.002 inches, or less than or equal to 0.001 inches. Combinations of the above-referenced ranges are also possible (e.g., greater than or equal to 0.001 inches and less than or equal to 1 inch, greater than or equal to 0.003 inches and less than or equal to 0.75 inches, or greater than or equal to 0.01 inches and less than or equal to 0.5 inches). Other ranges are also possible.

When a non-woven fiber web of the first type comprises two or more types of glass fibers, each type of glass fiber may independently have an average fiber length in one or more of the ranges described above and/or all of the glass fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of glass fibers having an average fiber length in one or more of the ranges described above and/or may comprise glass fibers that overall have an average fiber length in one or more of the ranges described above.

Glass fibers may have a variety of suitable aspect ratios. In some embodiments, a non-woven fiber web of the first type comprises glass fibers having an aspect ratio of greater than or equal to 100, greater than or equal to 150, greater than or equal to 200, greater than or equal to 300, greater than or equal to 400, greater than or equal to 500, greater than or equal to 750, greater than or equal to 1000, greater than or equal to 1500, greater than or equal to 2000, greater than or equal to 2500, greater than or equal to 3000, greater than or equal to 3500, greater than or equal to 4000, greater than or equal to 5000, greater than or equal to 6000, greater than or equal to 7000, greater than or equal to 8000, greater than or equal to 9000, greater than or equal to 10000, greater than or equal to 20000, greater than or equal to 30000, greater than or equal to 40000, greater than or equal to 50000, greater than or equal to 60000, greater than or equal to 70000, greater than or equal to 80000, or greater than or equal to 90000. In some embodiments, a non-woven fiber web of the first type comprises glass fibers having an aspect ratio of less than or equal to 100000, less than or equal to 90000, less than or equal to 80000, less than or equal to 70000, less than or equal to 60000, less than or equal to 50000, less than or equal to 40000, less than or equal to 30000, less than or equal to 20000, less than or equal to 10000, less than or equal to 9000, less than or equal to 8000, less than or equal to 7000, less than or equal to 6000, less than or equal to 5000, less than or equal to 4000, less than or equal to 3500, less than or equal to 3000, less than or equal to 2500, less than or equal to 2000, less than or equal to 1500, less than or equal to 1000, less than or equal to 750, less than or equal to 500, less than or equal to 400, less than or equal to 300, less than or equal to 200, or less than or equal to 150. Combinations of the above-referenced ranges are also possible (e.g., greater than or equal to 100 and less than or equal to 100000, greater than or equal to 100 and less than or equal to 10000, greater than or equal to 200 and less than or equal to 2500, or greater than or equal to 300 and less than or equal to 1000). Other ranges are also possible.

When a non-woven fiber web of the first type comprises two or more types of glass fibers, each type of glass fiber may independently have an aspect ratio in one or more of the ranges described above and/or all of the glass fibers in a non-woven fiber web of the first type may together have an aspect ratio in one or more of the ranges described above. Similarly, when a filter media comprises two or more non-woven fiber webs of the first type, each non-woven fiber web of the first type may independently comprise one or more types of glass fibers having an aspect ratio in one or more of the ranges described above and/or may comprise glass fibers that overall have an aspect ratio in one or more of the ranges described above.

In some embodiments, a non-woven fiber web of the first type comprises microglass fibers. The microglass fibers may comprise microglass fibers drawn from bushing tips and further subjected to flame blowing or rotary spinning processes. In some cases, microglass fibers may be made using a remelting process. The microglass fibers may be microglass fibers for which alkali metal oxides (e.g., sodium oxides, magnesium oxides) make up 10-20 wt % of the fibers. Such fibers may have relatively lower melting and processing temperatures. Non-limiting examples of microglass fibers are B glass fibers, M glass fibers according to Man Made Vitreous Fibers by Nomenclature Committee of TIMA Inc. March 1993, Page 45, C glass fibers (e.g., Lauscha C glass fibers, JM 253 C glass fibers), and non-persistent glass fibers (e.g., fibers that are configured to dissolve completely in the fluid present in human lungs in less than or equal to 40 days, such as Johns Manville 481 fibers). It should be understood that microglass fibers present in a non-woven fiber web of the first type may comprise one or more of the types of microglass fibers described herein.

A non-woven fiber web of the first type may comprise microglass fibers in variety of suitable amounts. In some embodiments, microglass fibers make up greater than or equal to 10 wt %, greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, or greater than or equal to 85 wt % of the non-woven fiber web of the first type. In some embodiments, microglass fibers make up less than or equal to 88 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, or less than or equal to 20 wt % of the non-woven fiber web of the first type. Combinations of the above-referenced ranges are also possible (e.g., greater than or equal to 10 wt % and less than or equal to 88 wt %, greater than or equal to 20 wt % and less than or equal to 88 wt %, greater than or equal to 20 wt % and less than or equal to 60 wt %, or greater than or equal to 20 wt % and less than or equal 40 wt %). Other ranges are also possible.

When a non-woven fiber web of the first type comprises two or more types of microglass fibers, each type of microglass fiber may independently make up an amount of the non-woven fiber web of the first type in one or more of the ranges described above and/or all of the microglass fibers in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of microglass fiber in one or more of the ranges described above and/or may comprise a total amount of microglass fibers in one or more of the ranges described above.

In some embodiments, microglass fibers make up greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the glass fibers in a non-woven fiber web of the first type. In some embodiments, microglass fibers make up less than or equal to 100 wt %, less than or equal to 95 wt %, less than or equal to 90 wt %, less than or equal to less than or equal to 85 wt %, less than or equal to 80 wt %, less than or equal to 75 wt %, less than or equal to 70 wt %, less than or equal to 65 wt %, less than or equal to 60 wt %, or less than or equal to 55 wt % of the glass fibers in a non-woven fiber web of the first type. Combinations of the above-referenced ranges are also possible (e.g., greater than or equal to 50 wt % and less than or equal to 100 wt %). Other ranges are also possible. In some embodiments, microglass fibers make up exactly 100 wt % of the glass fibers in a non-woven fiber web of the first type.

When a non-woven fiber web of the first type comprises two or more types of microglass fibers, each type of microglass fiber may independently make up an amount of the non-woven fiber web of the first type in one or more of the ranges described above and/or all of the microglass fibers in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of microglass fiber in one or more of the ranges described above and/or may comprise a total amount of microglass fibers in one or more of the ranges described above.

Microglass fibers present in non-woven fiber webs of the first type may have a variety of suitable average fiber diameters. In some embodiments, a non-woven fiber web of the first type comprises microglass fibers having an average fiber diameter of greater than or equal to 0.1 microns, greater than or equal to 0.15 microns, greater than or equal to 0.2 microns, greater than or equal to 0.25 microns, greater than or equal to 0.3 microns, greater than or equal to 0.35 microns, greater than or equal to 0.4 microns, greater than or equal to 0.5 microns, greater than or equal to 0.6 microns, greater than or equal to 0.8 microns, greater than or equal to 1 micron, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, or greater than or equal to 8 microns. In some embodiments, a non-woven fiber web of the first type comprises microglass fibers having an average fiber diameter of less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.6 microns, less than or equal to 0.5 microns, less than or equal to 0.4 microns, less than or equal to 0.35 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 microns and less than or equal to 10 microns, greater than or equal to 0.2 microns and less than or equal to 6 microns, or greater than or equal to 0.3 microns and less than or equal to 2 microns). Other ranges are also possible.

When a non-woven fiber web of the first type comprises two or more types of microglass fibers, each type of microglass fiber may independently have an average fiber diameter in one or more of the ranges described above and/or all of the microglass fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of microglass fibers having an average fiber diameter in one or more of the ranges described above and/or may comprise microglass fibers that overall have an average fiber diameter in one or more of the ranges described above.

Microglass fibers present in the non-woven fiber webs of the first type described herein may have a variety of suitable aspect ratios. In some embodiments, a non-woven fiber web of the first type comprises microglass fibers having an aspect ratio in one or more of the ranges described elsewhere herein with respect to the aspect ratio of glass fibers.

In some embodiments, a non-woven fiber web of the first type comprises chopped strand glass fibers. The chopped strand glass fibers may comprise chopped strand glass fibers which were produced by drawing a melt of glass from bushing tips into continuous fibers and then cutting the continuous fibers into short fibers. In some embodiments, a non-woven fiber web of the first type comprises chopped strand glass fibers for which alkali metal oxides (e.g., sodium oxides, magnesium oxides) make up a relatively low amount of the fibers. It is also possible for a non-woven fiber web to comprise chopped strand glass fibers that include relatively large amounts of calcium oxide and/or alumina (Al₂O₃). In some embodiments, a non-woven fiber web of the first type comprises S-glass fibers, which include approximately 10 wt % magnesium oxide. It should be understood that chopped strand glass fibers present in a non-woven fiber web of the first type may comprise one or more of the types of chopped strand glass fibers described herein.

A non-woven fiber web of the first type may comprise chopped strand glass fibers in variety of suitable amounts. In some embodiments, chopped strand glass fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 22.5 wt %, greater than or equal to 25 wt %, greater than or equal to 30 wt %, greater than or equal to 35 wt %, or greater than or equal to 40 wt %. In some embodiments, chopped strand glass fibers make up less than or equal to 45 wt %, less than or equal to 40 wt %, less than or equal to 35 wt %, less than or equal to 30 wt %, less than or equal to 25 wt %, less than or equal to 22.5 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the non-woven fiber web of the first type. Combinations of the above-referenced ranges are also possible (e.g., greater than or equal to 20 wt % and less than or equal to 45 wt %, greater than or equal to 20 wt % and less than or equal to 45 wt %, or greater than or equal to 20 wt % and less than or equal 40 wt %). Other ranges are also possible. In some embodiments, chopped strand glass fibers make up exactly 0 wt % of a non-woven fiber web of the first type

When a non-woven fiber web of the first type comprises two or more types of chopped strand glass fibers, each type of chopped strand glass fiber may independently make up an amount of the non-woven fiber web of the first type in one or more of the ranges described above and/or all of the chopped strand glass fibers in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of chopped strand glass fiber in one or more of the ranges described above and/or may comprise a total amount of chopped strand glass fibers in one or more of the ranges described above.

In some embodiments, chopped strand glass fibers make up greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of the glass fibers in a non-woven fiber web of the first type. In some embodiments, chopped strand glass fibers make up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of the glass fibers in a non-woven fiber web of the first type. Combinations of the above-referenced ranges are also possible (e.g., greater than or equal to 0 wt % and less than or equal to 50 wt %). Other ranges are also possible. In some embodiments, chopped strand glass fibers make up exactly 0 wt % of the glass fibers in a non-woven fiber web of the first type.

When a non-woven fiber web of the first type comprises two or more types of chopped strand glass fibers, each type of chopped strand glass fiber may independently make up an amount of the non-woven fiber web of the first type in one or more of the ranges described above and/or all of the chopped strand glass fibers in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of chopped strand glass fiber in one or more of the ranges described above and/or may comprise a total amount of chopped strand glass fibers in one or more of the ranges described above.

Chopped strand glass fibers present in non-woven fiber webs of the first type may have a variety of suitable average fiber diameters. In some embodiments, a non-woven fiber web of the first type comprises chopped strand glass fibers having an average fiber diameter of greater than or equal to 5 microns, greater than or equal to 6 microns, greater than or equal to 6.5 microns, greater than or equal to 7.5 microns, greater than or equal to 10 microns, greater than or equal to 12.5 microns, greater than or equal to 15 microns, greater than or equal to 20 microns, or greater than or equal to 25 microns. In some embodiments, a non-woven fiber web of the first type comprises chopped strand glass fibers having an average fiber diameter of less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 6.5 microns, or less than or equal to 6 microns. Combinations of the above-referenced ranges are also possible (e.g., greater than or equal to 5 microns and less than or equal to 30 microns). Other ranges are also possible.

When a non-woven fiber web of the first type comprises two or more types of chopped strand glass fibers, each type of chopped strand glass fiber may independently have an average fiber diameter in one or more of the ranges described above and/or all of the chopped strand glass fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of chopped strand glass fibers having an average fiber diameter in one or more of the ranges described above and/or may comprise chopped strand glass fibers that overall have an average fiber diameter in one or more of the ranges described above.

Chopped strand glass fibers present in the non-woven fiber webs of the first type described herein may have a variety of suitable lengths. In some embodiments, a non-woven fiber web of the first type comprises chopped strand glass fibers having an average fiber length of greater than or equal to 0.1 inches, greater than or equal to 0.125 inches, greater than or equal to 0.150 inches, greater than or equal to 0.175 inches, greater than or equal to 0.2 inches, greater than or equal to 0.225 inches, greater than or equal to 0.25 inches, greater than or equal to 0.275 inches, greater than or equal to 0.3 inches, greater than or equal to 0.35 inches, greater than or equal to 0.4 inches, greater than or equal to 0.45 inches, greater than or equal to 0.5 inches, greater than or equal to 0.6 inches, greater than or equal to 0.7 inches, greater than or equal to 0.8 inches, or greater than or equal to 0.9 inches. In some embodiments, a non-woven fiber web of the first type comprises chopped strand glass fibers having an average fiber length of less than or equal to 1 inch, less than or equal to 0.9 inches, less than or equal to 0.8 inches, less than or equal to 0.7 inches, less than or equal to 0.6 inches, less than or equal to 0.5 inches, less than or equal to 0.45 inches, less than or equal to 0.4 inches, less than or equal to 0.35 inches, less than or equal to 0.3 inches, less than or equal to 0.275 inches, less than or equal to 0.25 inches, less than or equal to 0.225 inches, less than or equal to 0.2 inches, less than or equal to 0.175 inches, less than or equal to 0.15 inches, or less than or equal to 0.125 inches. Combinations of the above-referenced ranges are also possible (e.g., greater than or equal to 0.1 inches and less than or equal to 1 inch, or greater than or equal to 0.25 inches and less than or equal to 0.5 inches). Other ranges are also possible.

When a non-woven fiber web of the first type comprises two or more types of chopped strand glass fibers, each type of chopped strand glass fiber may independently have an average fiber length in one or more of the ranges described above and/or all of the chopped strand glass fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of chopped strand glass fibers having an average fiber length in one or more of the ranges described above and/or may comprise chopped strand glass fibers that overall have an average fiber length in one or more of the ranges described above.

In some embodiments, a non-woven fiber web of the first type comprises binder fibers. In some such embodiments, the binder fibers may include one type of binder fibers (e.g., monocomponent fibers, multicomponent fibers) or more than one type of binder fibers (e.g., both monocomponent fibers and multicomponent fibers, two types of monocomponent fibers, two types of multicomponent fibers). In some such embodiments, the binder fibers may serve as a binder for the non-woven fiber web that binds fibers within the web together, as disclosed elsewhere herein.

The non-woven fiber webs of the first type described herein may comprise binder fibers in a variety of suitable amounts. In some embodiments, binder fibers make up greater than or equal to 11 wt %, greater than or equal to 11.5 wt %, greater than or equal to 12 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, or greater than or equal to 75 wt % of the non-woven fiber web of the first type. In some embodiments, binder fibers make up less than or equal to 79 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 12 wt %, less than or equal to 11.5 wt %, or less than or equal to 11 wt % of the non-woven fiber web of the first type. Combinations of the above-referenced ranges are also possible (e.g., greater than or equal to 11 wt % and less than or equal to 79 wt %, greater than or equal to 20 wt % and less than or equal to 60 wt %, or greater than or equal to 20 wt % and less than or equal to 40 wt %). Other ranges are also possible.

When a non-woven fiber web of the first type comprises two or more types of binder fibers, each type of binder fiber may independently make up an amount of the non-woven fiber web of the first type in one or more of the ranges described above and/or all of the binder fibers in a non-woven fiber web of the first type may together make up an amount of the non-woven fiber web of the first type in one or more of the ranges described above. Similarly, when a filter media comprises two or more non-woven fiber webs of the first type, each non-woven fiber web of the first type may independently comprise an amount of any particular type of binder fiber in one or more of the ranges described above and/or may comprise a total amount of binder fibers in one or more of the ranges described above.

In some embodiments, a non-woven fiber web of the first type comprises binder fibers that are multicomponent fibers. In some such embodiments, the multicomponent fibers may comprise bicomponent fibers (i.e., fibers including two components), may comprise tricomponent fibers (i.e., fibers including three components), and/or may comprise fibers comprising four or more components. Multicomponent fibers may have a variety of suitable structures. For instance, a non-woven fiber web of the first type may comprise one or more of the following types of bicomponent fibers: core/sheath fibers (e.g., concentric core/sheath fibers, non-concentric core-sheath fibers), segmented pie fibers, side-by-side fibers, tip-trilobal fibers, split fibers, and “island in the sea” fibers. Core-sheath bicomponent fibers may comprise a sheath that has a lower melting point than that of the core. When heated (e.g., during a binding step), the sheath may melt prior to the core, binding the binder fibers together while the core remains solid. In such embodiments, the binder fibers may serve as a binder for the non-woven fiber web of the first type.

Non-limiting examples of suitable materials that may be included in binder fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; halogenated polymers such as poly(tetrafluoroethylene); epoxy; phenolic resins; and melamine. Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

As can be seen from the preceding paragraph, binder fibers may comprise one or more components that are synthetic. In such embodiments, the binder fibers may be considered to be a type of synthetic fiber.

Non-limiting examples of suitable pairs of materials that may be included in bicomponent fibers include poly(ethylene)/poly(ester) (e.g., poly(ethylene)/poly(ethylene terephthalate)), poly(propylene)/poly(ester) (e.g., poly(propylene)/poly(ethylene terephthalate)), co-poly(ester)/poly(ester) (e.g., co-poly(ethylene terephthalate)/poly(ethylene terephthalate)), poly(butylene terephthalate)/poly(ethylene terephthalate), co-poly(amide)/poly(amide), poly(amide)/poly(propylene), and poly(ethylene)/poly(propylene). In the preceding list, the material having the lower melting point is listed first and the material having the higher melting point is listed second. Core-sheath bicomponent fibers comprising one of the above such pairs may have a sheath comprising the first material and a core comprising the second material. In one set of embodiments, core-sheath bicomponent fibers may comprise a core that comprises a thermoset polymer and a sheath that comprises a thermoplastic polymer.

The binder fibers described herein may comprise components having a variety of suitable melting points. In some embodiments, a binder fiber comprises a component having a melting point of greater than or equal to 70° C., greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., greater than or equal to 220° C., greater than or equal to 250° C., greater than or equal to 300° C., greater than or equal to 250° C., greater than or equal to 300° C., greater than or equal to 350° C., or greater than or equal to 400° C. In some embodiments, a binder fiber comprises a component having a melting point less than or equal to 450° C., less than or equal to 400° C., less than or equal to 350° C., less than or equal to 300° C., less than or equal to 250° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., less than or equal to 90° C., or less than or equal to 80° C. Combinations of the above-referenced ranges are also possible (e.g., greater than or equal to 70° C. and less than or equal to 450° C., greater than or equal to 80° C. and less than or equal to 450° C., greater than or equal to 80° C. and less than or equal to 230° C., or greater than or equal to 110° C. and less than or equal to 230° C.). Other ranges are also possible. In some embodiments, a binder fiber comprises a component having a melting point of less than or equal to 100° C.

The melting point of the components of a binder fiber may be determined by performing differential scanning calorimetry. The differential scanning calorimetry measurement may be carried out by heating the binder fiber to 500° C. at 20° C./minute, cooling the binder fiber to room temperature, and then determining the melting point during a reheating to 500° C. at 20° C./minute.

When a binder fiber comprises two components, each component may independently have a melting point in one or more of the above-referenced ranges. Binder fibers comprising two or more components may comprise exclusively components having the same melting point, exclusively components having different melting points, or at least one pair of components that have the same melting point and at least one pair of components that have different melting points.

In some embodiments, a binder fiber comprises two components that have melting points that differ by greater than or equal to 50° C., greater than or equal to 75° C., greater than or equal to 100° C., greater than or equal to 125° C., greater than or equal to 150° C., greater than or equal to 175° C., greater than or equal to 200° C., greater than or equal to 225° C., greater than or equal to 250° C., greater than or equal to 275° C., greater than or equal to 300° C., greater than or equal to 325° C., or greater than or equal to 350° C. In some embodiments, a binder fiber comprises two components that have melting points that differ by less than or equal to 380° C., less than or equal to 350° C., less than or equal to 325° C., less than or equal to 300° C., less than or equal to 275° C., less than or equal to 250° C., less than or equal to 225° C., less than or equal to 200° C., less than or equal to 175° C., less than or equal to 150° C., less than or equal to 125° C., less than or equal to 100° C., or less than or equal to 75° C. Combinations of the above-referenced ranges are also possible (e.g., greater than or equal to 50° C. and less than or equal to 75° C.). Other ranges are also possible.

When a filter media comprises two or more non-woven fiber webs of the first type, each non-woven fiber web of the first type may independently comprise one or more of the above-described types of binder fibers.

Binder fibers may have a variety of suitable average fiber diameters. In some embodiments, a non-woven fiber web of the first type comprises binder fibers having an average fiber diameter of greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In some embodiments, a non-woven fiber web of the first type comprises binder fibers having an average fiber diameter of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, or less than or equal to 1 micron. Combinations of the above-referenced ranges are also possible (e.g., greater than or equal to 1 micron and less than or equal to 100 microns, greater than or equal to 2 microns and less than or equal to 50 microns, greater than or equal to 5 microns and less than or equal to 20 microns, or greater than or equal to 1 micron and less than or equal to 20 microns). Other ranges are also possible.

When a non-woven fiber web of the first type comprises two or more types of binder fibers, each type of binder fiber may independently have an average fiber diameter in one or more of the ranges described above and/or all of the binder fibers in a non-woven fiber web of the first type may together have an average fiber diameter in one or more of the ranges described above. Similarly, when a filter media comprises two or more non-woven fiber webs of the first type, each non-woven fiber web of the first type may independently comprise one or more types of binder fibers having an average fiber diameter in one or more of the ranges described above and/or may comprise binder fibers that overall have an average fiber diameter in one or more of the ranges described above.

Binder fibers may have a variety of suitable average fiber lengths. In some embodiments, a non-woven fiber web of the first type comprises binder fibers having an average fiber length of greater than or equal to 0.02 inches, greater than or equal to 0.04 inches, greater than or equal to 0.06 inches, greater than or equal to 0.08 inches, greater than or equal to 0.1 inches, greater than or equal to 0.12 inches, greater than or equal to 0.16 inches, greater than or equal to 0.18 inches, greater than or equal to 0.2 inches, greater than or equal to 0.25 inches, greater than or equal to 0.3 inches, greater than or equal to 0.35 inches, greater than or equal to 0.4 inches, greater than or equal to 0.45 inches, greater than or equal to 0.5 inches, greater than or equal to 0.6 inches, greater than or equal to 0.7 inches, greater than or equal to 0.8 inches, greater than or equal to 0.9 inches, greater than or equal to 1 inch, greater than or equal to 1.1 inches, greater than or equal to 1.2 inches, greater than or equal to 1.3 inches, or greater than or equal to 1.4 inches. In some embodiments, a non-woven fiber web of the first type comprises binder fibers having an average fiber length of less than or equal to 1.5 inches, less than or equal to 1.4 inches, less than or equal to 1.3 inches, less than or equal to 1.2 inches, less than or equal to 1.1 inches, less than or equal to 1 inch, less than or equal to 0.9 inches, less than or equal to 0.8 inches, less than or equal to 0.7 inches, less than or equal to 0.6 inches, less than or equal to 0.5 inches, less than or equal to 0.4 inches, less than or equal to 0.3 inches, less than or equal to 0.2 inches, less than or equal to 0.15 inches, less than or equal to 0.1 inches, less than or equal to 0.08 inches, less than or equal to 0.06 inches, less than or equal to 0.04 inches, or less than or equal to 0.03 inches. Combinations of the above-referenced ranges are also possible (e.g., greater than or equal to 0.02 inches and less than or equal to 1.5 inches, greater than or equal to 0.1 inches and less than or equal to 1 inch, or greater than or equal to 0.2 inches and less than or equal to 0.5 inches). Other ranges are also possible.

When a non-woven fiber web of the first type comprises two or more types of binder fibers, each type of binder fiber may independently have an average fiber length in one or more of the ranges described above and/or all of the binder fibers in a non-woven fiber web of the first type may together have an average fiber length in one or more of the ranges described above. Similarly, when a filter media comprises two or more non-woven fiber webs of the first type, each non-woven fiber web of the first type may independently comprise one or more types of binder fibers having an average fiber length in one or more of the ranges described above and/or may comprise binder fibers that overall have an average fiber length in one or more of the ranges described above.

In some embodiments, a non-woven fiber web of the first type comprises a particularly beneficial weight ratio of fibrillated fibers to glass fibers, e.g., that may give rise to a fiber web and/or filter media having one or more enhanced properties (e.g., dust holding capacity, initial efficiency, mechanical properties, etc.), as will be described in more detail elsewhere herein. In some embodiments, the weight ratio of fibrillated fibers to glass fibers may be greater than or equal to 1:50, greater than or equal to 1:45, greater than or equal to 1:40, greater than or equal to 1:30, greater than or equal to 1:20, greater than or equal to 1:15, greater than or equal to 1:10, greater than or equal to 1:7, greater than or equal to 1:6, greater than or equal to 1:5, greater than or equal to 1:4, greater than or equal to 1:3, greater than or equal to 2:5, greater than or equal to 1:2, greater than or equal to 3:4, greater than or equal to 1:1, greater than or equal to 4:3, greater than or equal to 2:1, greater than or equal to 5:2, greater than or equal to 3:1, greater than or equal to 4:1, greater than or equal to 5:1, greater than or equal to 6:1, greater than or equal to 7:1, greater than or equal to 8:1, greater than or equal to 10:1, greater than or equal to 15:1, greater than or equal to 20:1, greater than or equal to 30:1, greater than or equal to 40:1, or greater than or equal to 45:1. In some embodiments, the weight ratio of fibrillated fibers to glass fibers may be less than or equal to 50:1, less than or equal to 45:1, less than or equal to 40:1, less than or equal to 30:1, less than or equal to 20:1, less than or equal to 15:1, less than or equal to 10:1, less than or equal to 7:1, less than or equal to 6:1, less than or equal to 5:1, less than or equal to 4:1, less than or equal to 3:1, less than or equal to 5:2, less than or equal to 2:1, less than or equal to 4:3, less than or equal to 1:1, less than or equal to 3:4, less than or equal to 1:2, less than or equal to 2:5, less than or equal to 1:3, less than or equal to 1:4, less than or equal to 1:5, less than or equal to 1:6, less than or equal to 1:7, less than or equal to 1:8, less than or equal to 1:10, less than or equal to 1:15, less than or equal to 1:20, less than or equal to 1:25, less than or equal to 1:30, or less than or equal to 1:40. Combinations of the above-referenced ranges are also possible (e.g., greater than or equal to 1:50 and less than or equal to 50:1, greater than or equal to 1:20 and less than or equal to 20:1, or greater than or equal to 1:5 and less than or equal to 5:1). Other ranges are also possible.

When a filter media comprises two or more non-woven fiber webs of the first type, each non-woven fiber web of the first type may have a weight ratio of fibrillated fibers to glass fibers in one or more of the ranges described above.

As mentioned, according to certain embodiments, a non-woven fiber web of the first type comprises both fibrillated fibers and glass fibers. In some embodiments, the non-woven fiber web of the first type comprises a particularly beneficial combination of glass fibers having a suitable average fiber diameter described herein and fibrillated fibers having a suitable level of fibrillation (i.e., average Canadian Standard Freeness value) described herein. In some such embodiments, fibrillated fibers having a certain level of fibrillation may be matched and blended with glass fibers having a certain average fiber diameter, e.g., to form a fiber web and/or a filter media with one or more enhanced performance properties (e.g., dust holding capacity, initial efficiency, one or more mechanical properties, etc.). For example, the fibrillated fibers and the glass fibers may be matched based on the empirical formula shown below as Equation [1]:

D_{glass}=0.25+0.0045 CSF_{fibrillated} [1]

where D_{glass} is the average fiber diameter (microns) of the glass fibers, and CSF_{fibrillated} is the level of fibrillation of the fibrillated fibers measured as an average Canadian Standard Freeness value in mL. For example, in one set of embodiments, fibrillated fibers having a level of fibrillation of about 100 mL may be matched and blended with glass fibers having an average fiber diameter of about 0.7 microns. In another set of embodiments, fibrillated fibers having a level of fibrillation of about 120 mL may be matched and blended with glass fibers having an average fiber diameter of about 0.8 microns.

Without wishing to be bound by any particular theory, it is believed that the more closely the fibrillated and glass fibers are matched with each other according to Equation [1], the more enhanced the performance properties (e.g., initial efficiencies, dust holding capacities, one or more enhanced performance properties, etc.) of the resultant non-woven fiber web and/or filter media are. In some embodiments, when the fibrillated and glass fibers are matched with each other according to equation [1], the air permeability of the resultant non-woven fiber web and/or filter media is relatively independent of the relative amounts of the fibrillated fibers and glass fibers therein. It should be noted that in some embodiments, fibrillated fibers having a certain level of fibrillation may be matched with a glass fiber having an average fiber diameter that deviates from the calculated average fiber diameter based on Equation [1] by no more than 50%, no more than 45%, no more than 40%, no more than 35%, no more than 30%, no more than 25%, no more than 20%, no more than 15%, no more than 10%, and/or no more than 5%. Similarly, in some embodiments, glass fibers having an average fiber diameter may be matched with fibrillated fibers having a level of fibrillation that differs from the calculated level of fibrillation in Equation [1] by no more than 50%, no more than 45%, no more than 40%, no more than 35%, no more than 30%, no more than 25%, no more than 20%, no more than 15%, no more than 10%, and/or no more than 5%. It should be noted that the deviation may be either a positive or negative deviation. As an example, for fibrillated fibers having a level of fibrillation of about 100 mL, a deviation of no more than 15% from the calculated average fiber diameter of the glass fibers may correspond to glass fibers having an average fiber diameter of between about 0.6 microns and about 0.8 microns. Additionally, some non-woven fiber webs of the first type comprising combinations of fibrillated and glass fibers (and/or filter media in which they are positioned) that are not perfectly matched may still exhibit improved physical properties, compared to a fiber web including glass fibers and fibrillated fibers not at all matched and/or matched to a lesser degree.

As mentioned previously, a non-woven fiber web of the first type may comprise a particularly beneficial combination of fibers that results in an improvement in one or more properties of a fiber web and/or filter media in which they are positioned (e.g., dust holding capacity, initial efficiency, mechanical properties, etc.). In one set of embodiments, a non-woven fiber web of the first type comprises a particularly beneficial combination of glass fibers at a suitable amount and fibrillated fibers having a suitable level of fibrillation described herein. For instance, in some embodiments, a non-woven fiber web of the first type comprises fibrillated fibers having a level of fibrillation (i.e., average Canadian Standard Freeness value) of greater than or equal to 105 mL (e.g., about 120 mL) and comprises glass fibers that are present in a suitable amount described herein (e.g., between 20 wt % and 88 wt %, between 20 wt % and 60 wt %, or between 20 wt % and 40 wt %). In a specific embodiment, a non-woven fiber web of the first type comprises fibrillated fibers that have a level of fibrillation of about 120 mL and glass fibers that are present in an amount of about 30 wt % thereof.

As another example, in one set of embodiments, a non-woven fiber web of the first type has a particularly beneficial weight ratio of fibrillated fibers to glass fibers and comprises fibrillated fibers having a suitable level of fibrillation. For instance, according to certain embodiments, a non-woven fiber web of the first type comprises fibrillated fibers having a level of fibrillation of greater than or equal to 105 mL (e.g., about 120 mL) and a weight ratio of fibrillated fibers to glass fibers in one or more of the ranges described herein (e.g., between 1:50 and 50:1, between 1:20 and 20:1, or between 1:5 and 5:1). In a specific embodiment, a non-woven fiber web of the first type comprises fibrillated fibers having a level of fibrillation value of about 120 mL and exhibits a weight ratio of fibrillated fibers to glass fibers of about 4:3.

In one set of embodiments, a non-woven fiber web of the first type comprises a particularly beneficial combination of a suitable amount glass fibers with a suitable average fiber diameter and fibrillated fibers having a suitable level of fibrillation. For example, in accordance with certain embodiments, a non-woven fiber web of the first type may comprise fibrillated fibers having a level of fibrillation of greater than or equal to 105 mL (e.g., about 120 mL) and glass fibers with an average fiber diameter of at least 0.6 microns (e.g., 0.8 microns), where the glass fibers are present in any suitable amount described herein (e.g., between 20 wt % and 88 wt %, between 20 wt % and 60 wt %, or between 20 wt % and 40 wt %). In a specific embodiment, a non-woven fiber web of the first type comprises fibrillated fibers having a level of fibrillation (i.e., average Canadian Standard Freeness value) of about 120 mL, comprises glass fibers having an average fiber diameter of about 0.8 microns, and comprises the glass fibers in an amount of about 30 wt %.

In some embodiments, a non-woven fiber web of the first type comprises a particularly beneficial combination of glass fibers having a suitable average fiber diameter and fibrillated fibers having a suitable level of fibrillation, where the fibrillated fibers and glass fibers are present in the non-woven fiber web of the first at a suitable weight ratio described herein. For example, in accordance with certain embodiments, a non-woven fiber web of the first type may comprise fibrillated fibers having a level of fibrillation of greater than or equal to 105 mL (e.g., about 120 mL) and glass fibers with an average fiber diameter of at least 0.6 microns (e.g., 0.8 microns), where the weight ratio of the fibrillated fibers to glass fibers may be any suitable ratio described herein (e.g., between 1:50 and 50:1, between 1:20 and 20:1, or between 1:5 and 5:1). In a specific embodiment, a non-woven fiber web of the first type comprises fibrillated fibers having an average Canadian Standard Freeness value of about 120 mL, comprises glass fibers having an average fiber diameter of about 0.8 microns, and has a weight ratio of fibrillated fibers to glass fibers of about 4:3.

In some embodiments, a non-woven fiber web of the first type may include other fiber types than those described above. For instance, in one set of embodiments, fibers such as unfibrillated natural fibers (e.g., unfibrillated cellulose fibers) and/or non-binder synthetic fibers (e.g., as monocomponent synthetic fibers, such as monocomponent staple synthetic fibers, comprising one or more of the polymers described elsewhere herein with respect to multicomponent synthetic fibers, such as poly(ester)) may be included in a non-woven fiber web of the first type. Suitable non-binder synthetic fibers may have a variety of suitable cross-sections (e.g., round, oval, trilobal, pentalobal, 4DG, etc.). In another set of embodiments, alternatively or additionally, a non-woven fiber web of the first type may also include cellulosic nanofibers and/or cellulosic nano fibrils.

In some embodiments, one or more additives (e.g., particles such as activated carbon, diatomaceous earth, etc.) may be incorporated into a non-woven fiber web of the first type described herein. Additionally or alternatively, fibers with different properties than those described above and/or fibers that have undergone one or more modifications may be used make the non-woven fiber web, depending on the desired properties of the resultant fiber web. For example, according to some such embodiments, a non-woven fiber web of the first type may comprise fibers that have fire resistance properties, fibers that are surface-modified (e.g., to be hydrophilic or hydrophobic), fibers that comprise an anti-bacterial finish, and/or fibers that have been surface-modified to exhibit a catalytical effect (e.g., that comprise TiO₂ on the surface thereof). Any appropriate methods may be employed to modify the non-woven fiber web and fibers within the web. For instance, in some embodiments, individual non-woven fiber webs and/or a filter media comprising one or more non-woven fibers and/or layers web may be treated via chemical vapor deposition to enhance the hydrophobicity or hydrophilicity of the non-woven fiber web(s).

In some embodiments, binder resins may be included in the non-woven fiber webs of the first type described herein. In some embodiments, a binder resin makes up greater than or equal to 0 wt %, greater than or equal to 1 wt %, greater than or equal to 2 wt %, greater than or equal to 3 wt %, greater than or equal to 5 wt %, greater than or equal to 7.5 wt %, greater than or equal to 10 wt %, greater than or equal to 12.5 wt %, greater than or equal to 15 wt %, or greater than or equal to 17.5 wt % of a non-woven fiber web of the first type. In some embodiments, a binder resin makes up less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 3 wt %, less than or equal to 2 wt %, or less than or equal to 1 wt % of a non-woven fiber web of the first type. Combinations of the above-referenced ranges are also possible (e.g., greater than or equal to 0 wt % and less than or equal to 20 wt %). Other ranges are also possible. In some embodiments, a binder resin makes up exactly 0 wt % of a non-woven fiber web of the first type.

When a non-woven fiber web of the first type comprises two or more types of binder resin, each type of binder resin may independently make up an amount of the non-woven fiber web of the first type in one or more of the ranges described above and/or all of the binder resin in a non-woven fiber web of the first type may together make up an amount of the non-woven fiber web in one or more of the ranges described above. Similarly, when a filter media comprises two or more non-woven fiber webs of the first type, each non-woven fiber web of the first type may independently comprise an amount of any particular type of binder resin in one or more of the ranges described above and/or may comprise a total amount of binder resin in one or more of the ranges described above.

Binder resins may have a variety of suitable compositions. For instance, in one set of embodiments, a filter media may comprise a binder resin that comprises a thermoplastic polymer (e.g. acrylic, polyvinyl acetate, polyester, polyamide, etc.), a thermoset polymer (e.g., epoxy, phenolic resin, melamine, etc.), or a combination thereof. In some embodiments, a binder resin includes one or more of a vinyl acetate resin and a polyvinyl alcohol resin.

The non-woven fiber webs of the first type described herein may have a variety of suitable basis weights. In some embodiments, a non-woven fiber web of the first type has a basis weight of greater than or equal to 5 gsm, greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, or greater than or equal to 300 gsm. In some embodiments, a non-woven fiber web of the first type has a basis weight of less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 30 gsm, less than or equal to 25 gsm, less than or equal to 20 gsm, less than or equal to 15 gsm, or less than or equal to 10 gsm. Combinations of the above-referenced ranges are also possible (e.g., greater than or equal to 5 gsm and less than or equal to 300 gsm, greater than or equal to 15 gsm and less than or equal to 200 gsm, or greater than or equal to 30 gsm and less than or equal to 100 gsm). Other ranges are also possible.

The basis weight of a non-woven fiber web of the first type may be determined in accordance with ISO 536:2012.

When a filter media comprises two or more non-woven fiber webs of the first type, each non-woven fiber web of the first type may independently have a basis weight in one or more of the above-referenced ranges. The non-woven fiber webs of the first type described herein may have a variety of suitable thicknesses. In some embodiments, a non-woven fiber web of the first type has a thickness of greater than or equal to 0.05 mm, greater than or equal to 0.075 mm, greater than or equal to 0.1 mm, greater than or equal to 0.15 mm, greater than or equal to 0.2 mm, greater than or equal to 0.25 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.1 mm, greater than or equal to 1.2 mm, greater than or equal to 1.3 mm, greater than or equal to 1.4 mm, greater than or equal to 1.5 mm, greater than or equal to 1.6 mm, greater than or equal to 1.7 mm, greater than or equal to 1.8 mm, or greater than or equal to 1.9 mm. In some embodiments, a non-woven fiber web of the first type has a thickness of less than or equal to 2 mm, less than or equal to 1.9 mm, less than or equal to 1.8 mm, less than or equal to 1.7 mm, less than or equal to 1.6 mm, less than or equal to 1.5 mm, less than or equal to 1.4 mm, less than or equal to 1.3 mm, less than or equal to 1.2 mm, less than or equal to 1.1 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, less than or equal to 0.3 mm, less than or equal to 0.2 mm, less than or equal to 0.15 mm, less than or equal to 0.1 mm, or less than or equal to 0.075 mm. Combinations of the above-referenced ranges are also possible (e.g., greater than or equal to 0.05 mm and less than or equal to 2 mm, greater than or equal to 0.1 mm and less than or equal to 1 mm, or greater than or equal to 0.2 mm and less than or equal to 0.6 mm). Other ranges are also possible.

The thickness of a non-woven fiber web of the first type may be determined in accordance with ISO 534 (2011) under an applied pressure of 2 N/cm².

When a filter media comprises two or more non-woven fiber webs of the first type, each non-woven fiber web of the first type may independently have a thickness in one or more of the above-referenced ranges. In some embodiments, a non-woven fiber web of the first type has a variety of suitable apparent densities. The apparent density of a non-woven fiber web of the first type may be greater than or equal to 5 gsm/mm, greater than or equal to 10 gsm/mm, greater than or equal to 25 gsm/mm, greater than or equal to 50 gsm/mm, greater than or equal to 75 gsm/mm, greater than or equal to 100 gsm/mm, greater than or equal to 150 gsm/mm, greater than or equal to 200 gsm/mm, greater than or equal to 300 gsm/mm, greater than or equal to 400 gsm/mm, greater than or equal to 500 gsm/mm, greater than or equal to 600 gsm/mm, greater than or equal to 700 gsm/mm, greater than or equal to 800 gsm/mm, greater than or equal to 900 gsm/mm, greater than or equal to 1000 gsm/mm, greater than or equal to 1500 gsm/mm, greater than or equal to 2000 gsm/mm, or greater than or equal to 2500 gsm/mm. The apparent density of a non-woven fiber web of the first type may be less than or equal to 3000 gsm/mm, less than or equal to 2500 gsm/mm, less than or equal to 2000 gsm/mm, less than or equal to 1500 gsm/mm, less than or equal to 1000 gsm/mm, less than or equal to 900 gsm/mm, less than or equal to 800 gsm/mm, less than or equal to 700 gsm/mm, less than or equal to 600 gsm/mm, less than or equal to 500 gsm/mm, less than or equal to 400 gsm/mm, less than or equal to 300 gsm/mm, less than or equal to 200 gsm/mm, less than or equal to 150 gsm/mm, less than or equal to 100 gsm/mm, less than or equal to 75 gsm/mm, less than or equal to 50 gsm/mm, less than or equal to 25 gsm/mm, or less than or equal to 10 gsm/mm. Combinations of the above-referenced ranges are also possible (e.g., greater than or equal to 5 gsm/mm and less than or equal to 3000 gsm/mm, greater than or equal to 100 gsm/mm and less than or equal to 1000 gsm/mm, or greater than or equal to 150 gsm/mm and less than or equal to 800 gsm/mm). Other ranges are also possible.

The apparent density of a non-woven fiber web of the first type may be determined by dividing the density of the non-woven fiber web of the first type by the thickness of the non-woven fiber web of the first type.

When a filter media comprises two or more non-woven fiber webs of the first type, each non-woven fiber web of the first type may independently have an apparent density in one or more of the above-referenced ranges.

The non-woven fiber webs of the first type described herein may a variety of suitable mean flow pore sizes. The mean flow pore size of a non-woven fiber web of the first type may be greater than or equal to 0.1 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 40 microns, greater than or equal to 60 microns, greater than or equal to 80 microns, greater than or equal to 100 microns, or greater than or equal to 125 microns. The mean flow pore size of a non-woven fiber web of the first type may be less than or equal to 150 microns, less than or equal to 100 microns, less than or equal to 80 microns, less than or equal to 60 microns, less than or equal to 40 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 microns and less than or equal to 150 microns, greater than or equal to 1 micron and less than or equal to 100 microns, or greater than or equal to 1 micron and less than or equal to 60 microns). Other ranges are also possible.

The mean flow pore size of a non-woven fiber web of the first type may be determined in accordance with ASTM F316 (2003).

When a filter media comprises two or more non-woven fiber webs of the first type, each non-woven fiber web of the first type may independently have a mean flow pore size in one or more of the above-referenced ranges.

The non-woven fiber webs of the first type described herein may have any suitable solidity values. In some embodiments, a non-woven fiber web of the first type has a solidity of greater than or equal to 0.001%, greater than or equal to 0.002%, greater than or equal to 0.004%, greater than or equal to 0.006%, greater than or equal to 0.008%, greater than or equal to 0.01%, greater than or equal to 0.02%, greater than or equal to 0.04%, greater than or equal to 0.06%, greater than or equal to 0.08%, greater than or equal to 0.1%, greater than or equal to 0.5%, greater than or equal to 1%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, or greater than or equal to 45%. The solidity of a non-woven fiber web of the first type may be less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, less than or equal to 1%, less than or equal to 0.5%, less than or equal to 0.1%, less than or equal to 0.08%, less than or equal to 0.06%, less than or equal to 0.04%, less than or equal to 0.02%, less than or equal to 0.01%, less than or equal to 0.008%, less than or equal to 0.006%, less than or equal to 0.004%, or less than or equal to 0.002%. Combinations of the above-referenced ranges are also possible (e.g., greater than or equal to 0.001% and less than or equal to 50%, greater than or equal to 0.01% and less than or equal to 40%, or greater than or equal to 0.1% and less than or equal to 30%). Other ranges are also possible.

The solidity of a non-woven fiber web of the first type may be determined by using the following formula: solidity=[basis weight/(fiber density*thickness)]*100%. The basis weight and thickness may be determined as described elsewhere herein. The fiber density is equivalent to the average density of the material or material(s) forming the fiber, which is typically specified by the fiber manufacturer. The average density of the materials forming the fibers may be determined by: (1) determining the total volume of all of the fibers in the filter media; and (2) dividing the total mass of all of the fibers in the filter media by the total volume of all of the fibers in the filter media. If the mass and density of each type of fiber in the filter media are known, the volume of all the fibers in the filter media may be determined by: (1) for each type of fiber, dividing the total mass of the type of fiber in the filter media by the density of the type of fiber; and (2) summing the volumes of each fiber type. If the mass and density of each type of fiber in the filter media are not known, the volume of all the fibers in the filter media may be determined in accordance with Archimedes' principle. When a filter media comprises two or more non-woven fiber webs of the first type, each non-woven fiber web of the first type may independently have a solidity in one or more of the above-referenced ranges.

The non-woven fiber webs of the first type described herein may have a variety of suitable air permeabilities. In some embodiments, a non-woven fiber web of the first type has an air permeability of greater than or equal to 0.1 cfm/sf (CFM), greater than or equal to 0.2 CFM, greater than or equal to 0.5 CFM, greater than or equal to 0.75 CFM, greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, or greater than or equal to 325 CFM. In some embodiments, a non-woven fiber web of the first type has an air permeability of less than or equal to 350 CFM, less than or equal to 325 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, less than or equal to 2 CFM, less than or equal to 1 CFM, less than or equal to 0.75 CFM, less than or equal to 0.5 CFM, or less than or equal to 0.2 CFM. Combinations of the above-referenced ranges are also possible (e.g., greater than or equal to 1 CFM and less than or equal to 1000 CFM, greater than or equal to 1 CFM and less than or equal to 250 CFM, or greater than or equal to 1 CFM and less than or equal to 100 CFM). Other ranges are also possible.

The air permeability of a non-woven fiber web of the first type may be determined in accordance with the standard TAPPI T-2551 (1985) using a test area of 38 cm² and a pressure drop of 125 Pa, which corresponds to 0.5 inches of water.

When a filter media comprises two or more non-woven fiber webs of the first type, each non-woven fiber web of the first type may independently have an air permeability in one or more of the above-referenced ranges. In some embodiments, the non-woven fiber webs of the first type described herein may have improved mechanical properties (e.g., relatively high mechanical strength) compared to other types of fiber webs, e.g., fiber webs lacking fibrillated fibers. Non-limiting examples of such properties include dry Mullen burst strength, dry tensile strength, and dry tensile elongation at break.

The non-woven fiber webs of the first type described herein may have relatively high values of dry Mullen burst strength. The dry Mullen burst strength of a non-woven fiber web of the first type may be greater than or equal to 1 psi, greater than or equal to 2 psi, greater than or equal to 3 psi, greater than or equal to 4 psi, greater than or equal to 5 psi, greater than or equal to 6 psi, greater than or equal to 7 psi, greater than or equal to 8 psi, greater than or equal to 10 psi, greater than or equal to 15 psi, greater than or equal to 20 psi, greater than or equal to 30 psi, greater than or equal to 40 psi, greater than or equal to 50 psi, greater than or equal to 60 psi, greater than or equal to 70 psi, greater than or equal to 80 psi, greater than or equal to 90 psi, greater than or equal to 100 psi, or greater than or equal to 125 psi. The dry Mullen burst strength of a non-woven fiber web of the first type may be less than or equal to 150 psi, less than or equal to 125 psi, less than or equal to 100 psi, less than or equal to 90 psi, less than or equal to 80 psi, less than or equal to 70 psi, less than or equal to 60 psi, less than or equal to 50 psi, less than or equal to 40 psi, less than or equal to 30 psi, less than or equal to 20 psi, less than or equal to 15 psi, less than or equal to 10 psi, less than or equal to 8 psi, less than or equal to 7 psi, less than or equal to 6 psi, less than or equal to 5 psi, less than or equal to 4 psi, less than or equal to 3 psi, or less than or equal to 2 psi. Combinations of the above-referenced ranges are also possible (e.g., greater than or equal to 1 psi and less than or equal to 150 psi, greater than or equal to 5 psi and less than or equal to 100 psi, or greater than or equal to 8 psi and less than or equal to 60 psi). Other ranges are also possible.

The dry Mullen burst strength of a non-woven fiber web of the first type may be determined in accordance with the standard TAPPI T403 (1997) test.

When a filter media comprises two or more non-woven fiber webs of the first type, each non-woven fiber web of the first type may independently have a dry Mullen burst strength in one or more of the above-referenced ranges.

The non-woven fiber webs of the first type described herein may have relatively high values of dry tensile strength in the machine direction. A non-woven fiber web of the first type may have a dry tensile strength in the machine direction of greater than or equal to 1 lb/in, greater than or equal to 2 lb/in, greater than or equal to 3 lb/in, greater than or equal to 4 lb/in, greater than or equal to 5 lb/in, greater than or equal to 7.5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, greater than or equal to 50 lb/in, greater than or equal to 60 lb/in, or greater than or equal to 70 lb/in. A non-woven fiber web of the first type may have a dry tensile strength in the machine of less than or equal to 80 lb/in, less than or equal to 70 lb/in, less than or equal to 60 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, less than or equal to 15 lb/in, less than or equal to 10 lb/in, less than or equal to 7.5 lb/in, less than or equal to 5 lb/in, less than or equal to 4 lb/in, less than or equal to 3 lb/in, or less than or equal to 2 lb/in. Combinations of the above-referenced ranges are also possible (e.g., greater than or equal to 1 lb/in and less than or equal to 80 lb/in, greater than or equal to 1 lb/in and less than or equal to 40 lb/in, or greater than or equal to 4 lb/in and less than or equal to 20 lb/in). Other ranges are also possible.

The dry tensile strength in the machine direction of a non-woven fiber web of the first type may be determined in accordance with the standard T494 om-96 (1996) test using a test span of 5 inches and a jaw separation speed of 12 in/min.

When a filter media comprises two or more non-woven fiber webs of the first type, each non-woven fiber web of the first type may independently have a dry tensile strength in the machine direction in one or more of the above-referenced ranges.

The non-woven fiber webs of the first type described herein may have relatively high values of dry tensile strength in the cross direction. A non-woven fiber web of the first type may have a dry tensile strength in the cross direction of greater than or equal to 1 lb/in, greater than or equal to 2 lb/in, greater than or equal to 3 lb/in, greater than or equal to 4 lb/in, greater than or equal to 5 lb/in, greater than or equal to 7.5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, or greater than or equal to 50 lb/in. A non-woven fiber web of the first type may have a dry tensile strength in the cross direction of less than or equal to 60 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, less than or equal to 15 lb/in, less than or equal to 10 lb/in, less than or equal to 7.5 lb/in, less than or equal to 5 lb/in, less than or equal to 4 lb/in, less than or equal to 3 lb/in, or less than or equal to 2 lb/in. Combinations of the above-referenced ranges are also possible (e.g., greater than or equal to 1 lb/in and less than or equal to 60 lb/in, greater than or equal to 1 lb/in and less than or equal to 30 lb/in, or greater than or equal to 4 lb/in and less than or equal to 20 lb/in). Other ranges are also possible.

The dry tensile strengths in the cross direction of a non-woven fiber web of the first type may be determined in accordance with the standard T494 om-96 (1996) test using a test span of 5 inches and a jaw separation speed of 12 in/min.

When a filter media comprises two or more non-woven fiber webs of the first type, each non-woven fiber web of the first type may independently have a dry tensile strength in the cross direction in one or more of the above-referenced ranges.

The non-woven fiber webs of the first type described herein may have relatively high values of dry tensile elongation at break in the machine direction and/or in the cross direction. The dry tensile elongation at break of a non-woven fiber web of the first type may be greater than or equal to 1%, greater than or equal to 1.5%, greater than or equal to 2%, greater than or equal to 2.5%, greater than or equal to 5%, greater than or equal to 7.5%, greater than or equal to 10%, greater than or equal to 15%, greater than or equal to 20%, greater than or equal to 25%, greater than or equal to 30%, or greater than or equal to 35%. The dry tensile elongation at break of a non-woven fiber web of the first type may be less than or equal to 40%, less than or equal to 35%, less than or equal to 30%, less than or equal to 25%, less than or equal to 20%, less than or equal to 15%, less than or equal to 10%, less than or equal to 7.5%, less than or equal to 5%, less than or equal to 2.5%, less than or equal to 2%, or less than or equal to 1.5%. Combinations of the above-referenced ranges are also possible (e.g., greater than or equal to 1% and less than or equal to 40%, greater than or equal to 1% and less than or equal to 30%, or greater than or equal to 5% and less than or equal to 20%). Other ranges are also possible.

The dry tensile elongations at break in the machine direction and the cross direction of a non-woven fiber web of the first type may be determined in accordance with the standard T494 om-96 (1996) test using a test span of 5 inches and a jaw separation speed of 12 in/min.

When a filter media comprises two or more non-woven fiber webs of the first type, each non-woven fiber web of the first type may independently have a dry tensile elongation at break in the machine direction in one or more of the above-referenced ranges. Similarly, when a filter media comprises two or more non-woven fiber webs of the first type, each non-woven fiber web of the first type may independently have a dry tensile elongation at break in the cross direction in one or more of the above-referenced ranges. The non-woven fiber webs of the first type described herein may have relatively high values of stiffness in the cross-direction. A non-woven fiber web of the first type may have a stiffness in the cross-direction of greater than or equal to 80 mg, greater than or equal to 90 mg, greater than or equal to 100 mg, greater than or equal to 125 mg, greater than or equal to 150 mg, greater than or equal to 175 mg, greater than or equal to 200 mg, greater than or equal to 250 mg, greater than or equal to 300 mg, greater than or equal to 400 mg, greater than or equal to 500 mg, greater than or equal to 750 mg, greater than or equal to 1000 mg, greater than or equal to 1250 mg, greater than or equal to 1500 mg, greater than or equal to 1750 mg, greater than or equal to 2000 mg, greater than or equal to 2500 mg, greater than or equal to 3000 mg, or greater than or equal to 4000 mg. A non-woven fiber web of the first type may have a stiffness in the cross-direction of less than or equal to 5000 mg, less than or equal to 3000 mg, less than or equal to 2500 mg, less than or equal to 2000 mg, less than or equal to 1750 mg, less than or equal to 1500 mg, less than or equal to 1250 mg, less than or equal to 1000 mg, less than or equal to 750 mg, less than or equal to 500 mg, less than or equal to 400 mg, less than or equal to 300 mg, less than or equal to 250 mg, less than or equal to 200 mg, less than or equal to 175 mg, less than or equal to 150 mg, less than or equal to 125 mg, less than or equal to 100 mg, or less than or equal to 90 mg. Combinations of the above-referenced ranges are also possible (e.g., greater than or equal to 80 mg and less than or equal to 5000 mg, greater than or equal to 100 mg and less than or equal to 3000 mg, or greater than or equal to 300 mg and less than or equal to 2000 mg). Other ranges are also possible.

The stiffness in the cross-direction of a non-woven fiber web of the first type may be determined in accordance with TAPPI T543 om-05 (2005) using a sample size of 2 in×2.5 in.

When a filter media comprises two or more non-woven fiber webs of the first type, each non-woven fiber web of the first type may independently have a stiffness in the cross-direction in one or more of the above-referenced ranges.

The non-woven fiber webs of the first type described herein may have a variety of suitable fuel gamma values. The fuel gamma value of a non-woven fiber web is a rating of liquid filtration performance that is based on the relationship between filtration efficiency, dust holding capacity, and air permeability of non-woven fiber web. Generally, higher fuel gamma values are indicative of better filter performance. Fuel gamma is a dimensionless value defined by the following equation:

$$Fuel Gamma = \frac{\begin{matrix}\{ - {log}_{10} [ ( 100 - Efficiency ) \text{/} 100 ] \} * \\ ( Specific DHC \text{/} Apparent Density )\end{matrix}}{( \frac{Face velocity}{Air Permeability} )} \qquad [ 2 ]$$

where the efficiency is the efficiency at 4 microns, specific DHC is measured in kg/m³ and can be calculated by dividing the dust holding capacity by fiber web thickness, face velocity is measured in cm/s, air permeability is measured in cm/s, and density is the apparent density of the fiber web measured in units of kg/m³. The efficiency and dust holding capacity of a non-woven fiber web may be determined by performing a Multipass Filter Test in accordance with ISO 19438 (2013). The relevant dust holding capacity for this equation is the injected dust holding capacity. Additionally, the face velocity during this test is equivalent to the face velocity in Equation [2]. It should be noted that the non-woven fiber webs described herein may be characterized by both an initial fuel gamma and an overall fuel gamma. For the initial fuel gamma, the initial efficiency is employed in Equation [2]. For the overall fuel gamma, the overall efficiency is employed in Equation [2].

The Multipass Filter Test comprises exposing the fiber web to Mobil Aero HFA Aviation Hydraulic Fluid in which ISO12103-A3 Medium grade test dust manufactured by FTI is suspended. The test may be performed at 50 mg/L base upstream gravimetric level (BUGL), a face velocity of 0.06 cm/s, and a flow rate of 1 L/min following the ISO 19438 (2013) procedure. This test is performed until a 100 kPa terminal pressure drop is achieved. The initial efficiency is an average of the efficiencies measured at 4, 5, and 6 minutes after running the test. The overall efficiency is the average efficiency that is measured over the course of the entire test (i.e., from the beginning of the test until the 100 kPa terminal pressure drop is achieved).

In some embodiments, a fiber web of the first type described herein has a relatively high initial fuel gamma value. The initial fuel gamma value of a non-woven fiber web of the first type may be greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, greater than or equal to 95, greater than or equal to 100, greater than or equal to 125, greater than or equal to 140, greater than or equal to 160, greater than or equal to 180, greater than or equal to 200, greater than or equal to 220, greater than or equal to 240, greater than or equal to 260, greater than or equal to 280, greater than or equal to 300, greater than or equal to 325, greater than or equal to 350, greater than or equal to 375, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, greater than or equal to 850, greater than or equal to 900, greater than or equal to 950, greater than or equal to 1000, greater than or equal to 2000, greater than or equal to 5000, or greater than or equal to 8000. The initial fuel gamma value of a non-woven fiber web of the first type may be less than or equal to 10000, less than or equal to 8000, less than or equal to 5000, less than or equal to 2000, less than or equal to 1000, less than or equal to 950, less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 375, less than or equal to 350, less than or equal to 325, less than or equal to 300, less than or equal to 280, less than or equal to 260, less than or equal to 240, less than or equal to 220, less than or equal to 200, less than or equal to 180, less than or equal to 160, less than or equal to 140, less than or equal to 125, less than or equal to 100, less than or equal to 95, less than or equal to 90, less than or equal to 85, less than or equal to 80, less than or equal to 75, less than or equal to 70, less than or equal to 65, less than or equal to 60, or less than or equal to 55. Combinations of the above-referenced ranges are also possible (e.g., greater than or equal to 50 and less than or equal to 10000, greater than or equal to 75 and less than or equal to 8000, or greater than or equal to 125 and less than or equal to 5000). Other ranges are also possible.

When a filter media comprises two or more non-woven fiber webs of the first type, each non-woven fiber web of the first type may independently have an initial fuel gamma in one or more of the above-referenced ranges.

In some embodiments, a fiber web of the first type described herein has a relatively high overall fuel gamma value. The overall fuel gamma value of a non-woven fiber web of the first type may be greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, greater than or equal to 95, greater than or equal to 100, greater than or equal to 120, greater than or equal to 140, greater than or equal to 160, greater than or equal to 180, greater than or equal to 200, greater than or equal to 220, greater than or equal to 240, greater than or equal to 260, greater than or equal to 280, greater than or equal to 300, greater than or equal to 325, greater than or equal to 350, greater than or equal to 375, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, greater than or equal to 850, greater than or equal to 900, or greater than or equal to 950. The overall fuel gamma value of a non-woven fiber web of the first type may be less than or equal to 1000, less than or equal to 950, less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 375, less than or equal to 350, less than or equal to 325, less than or equal to 300, less than or equal to 280, less than or equal to 260, less than or equal to 240, less than or equal to 220, less than or equal to 200, less than or equal to 180, less than or equal to 160, less than or equal to 140, less than or equal to 120, less than or equal to 100, less than or equal to 95, less than or equal to 90, less than or equal to 85, less than or equal to 80, less than or equal to 75, less than or equal to 70, less than or equal to 65, less than or equal to 60, or less than or equal to 55. Combinations of the above-referenced ranges are also possible (e.g., greater than or equal to 50 and less than or equal to 1000, greater than or equal to 75 and less than or equal to 500, or greater than or equal to 120 and less than or equal to 300). Other ranges are also possible.

When a filter media comprises two or more non-woven fiber webs of the first type, each non-woven fiber web of the first type may independently have an overall fuel gamma in one or more of the above-referenced ranges.

The non-woven fiber webs of the first type described herein may have a relatively high initial efficiency at 4 microns. The initial efficiency at 4 microns of a non-woven fiber web of the first type may be greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 97%, greater than or equal to 98%, greater than or equal to 99%, greater than or equal to 99.5%, greater than or equal to 99.6%, greater than or equal to 99.7%, greater than or equal to 99.8%, greater than or equal to 99.9%, greater than or equal to 99.95%, greater than or equal to 99.99%, or greater than or equal to 99.999%. The initial efficiency at 4 microns of a non-woven fiber web of the first type may be less than or equal to 100%, less than or equal to 99.999%, less than or equal to 99.99%, less than or equal to 99.95%, less than or equal to 99.9%, less than or equal to 99.8%, less than or equal to 99.7%, less than or equal to 99.6%, less than or equal to 99.5%, less than or equal to 99%, less than or equal to 98%, less than or equal to 97%, less than or equal to 95%, less than or equal to 90%, less than or equal to 80%, less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 10% and less than or equal to 100%, greater than or equal to 20% and less than or equal to 99.999%, or greater than or equal to 30% and less than or equal to 99.99%). Other ranges are also possible.

When a filter media comprises two or more non-woven fiber webs of the first type, each non-woven fiber web of the first type may independently have an initial efficiency at 4 microns in one or more of the above-referenced ranges.

The non-woven fiber webs of the first type described herein may have a relatively high overall efficiency at 4 microns. The overall efficiency at 4 microns of a non-woven fiber web of the first type may be greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 97%, greater than or equal to 98%, greater than or equal to 99%, greater than or equal to 99.5%, greater than or equal to 99.6%, greater than or equal to 99.7%, greater than or equal to 99.8%, greater than or equal to 99.9%, greater than or equal to 99.95%, greater than or equal to 99.99%, or greater than or equal to 99.999%. The overall efficiency at 4 microns of a non-woven fiber web of the first type may be less than or equal to 100%, less than or equal to 99.999%, less than or equal to 99.99%, less than or equal to 99.95%, less than or equal to 99.9%, less than or equal to 99.8%, less than or equal to 99.7%, less than or equal to 99.6%, less than or equal to 99.5%, less than or equal to 99%, less than or equal to 98%, less than or equal to 97%, less than or equal to 95%, less than or equal to 90%, less than or equal to 80%, less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 10% and less than or equal to 100%, greater than or equal to 20% and less than or equal to 99.999%, or greater than or equal to 30% and less than or equal to 99.99%). Other ranges are also possible.

When a filter media comprises two or more non-woven fiber webs of the first type, each non-woven fiber web of the first type may independently have an overall efficiency at 4 microns in one or more of the above-referenced ranges.

The non-woven fiber webs of the first type described herein may have a relatively high dust holding capacity. The dust holding capacity of a non-woven fiber web of the first type may be greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 200 gsm, greater than or equal to 250 gsm, greater than or equal to 300 gsm, or greater than or equal to 400 gsm. The dust holding capacity of a non-woven fiber web of the first type may be less than or equal to 500 gsm, less than or equal to 400 gsm, less than or equal to 300 gsm, less than or equal to 250 gsm, less than or equal to 200 gsm, less than or equal to 100 gsm, less than or equal to 90 gsm, less than or equal to 80 gsm, less than or equal to 70 gsm, less than or equal to 60 gsm, less than or equal to 50 gsm, or less than or equal to 40 gsm. Combinations of the above-referenced ranges are also possible (e.g., greater than or equal to 30 gsm and less than or equal to 500 gsm, greater than or equal to 60 gsm and less than or equal to 400 gsm, or greater than or equal to 90 gsm and less than or equal to 250 gsm). Other ranges are also possible.

As mentioned, references herein to dust holding capacity refer to the injected dust holding capacity. In other words, the ranges provided above relate to the injected dust holding capacity of the non-woven fiber webs of the first type. This dust holding capacity may be measured as described elsewhere herein according to ISO 19438 (2013) using ISO medium test dust (A3) and a flow velocity of 0.06 cm/s; dust holding capacity is measured when the pressure drop across the fiber web reaches 100 kPa.

When a filter media comprises two or more non-woven fiber webs of the first type, each non-woven fiber web of the first type may independently have a dust holding capacity in one or more of the above-referenced ranges.

As described above, in some embodiments, a non-woven fiber web of the first type is fabricated by a wet laying process. In general, a wet laying process involves mixing together fibers of one or more type; for example, a plurality of glass fibers may be mixed together on its own or with a plurality of fibrillated fibers and/or a plurality of binder fibers to provide a fiber slurry. The slurry may be, for example, an aqueous-based slurry. In some embodiments, fibers are optionally stored separately, or in combination, in various holding tanks prior to being mixed together.

In some embodiments, each plurality of fibers may be mixed and pulped together in separate containers. As an example, a plurality of glass fibers may be mixed and pulped together in one container, a plurality of fibrillated fibers may be mixed and pulped in a second container, and a plurality of binder fibers may be mixed and pulped in a third container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture (e.g., additives). Furthermore, it should be appreciated that other combinations of fibers types may be used in fiber mixtures, such as the fiber types described herein.

A wet laying process may comprise applying a single dispersion (e.g., a pulp) in a solvent (e.g., an aqueous solvent such as water) or slurry onto a wire conveyor in a papermaking machine (e.g., a fourdrinier or a rotoformer) to form a single layer supported by the wire conveyor. Vacuum may be continuously applied to the dispersion of fibers during the above process to remove the solvent from the fibers, thereby resulting in an article containing the single layer.

In some embodiments, multiple layers (e.g., comprising at least one non-woven fiber web of the first type) may be formed simultaneously or sequentially in a wet laying process. For instance, a layer may be formed as described above, and then one or more layers may be formed on that layer by following the same procedure. As an example, a dispersion in a solvent or slurry may be applied to a first layer on a wire conveyor, and vacuum applied to the dispersion or slurry to form a second layer on the first layer. Further layers may be formed on the first layer and the second layer by following this same process. The first layer, second layer, and/or one or more of the further layers may be non-woven fiber webs of the first type.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, a wet laying process uses similar equipment as in a conventional papermaking process, for example, a hydropulper, a former or a headbox, a dryer, and/or an optional converter. A layer can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of the fibers is in a suitable range, such as for example, between about 0.1% and 0.5% by weight.

In some cases, the pH of the slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

As mentioned, in some embodiments, a filter media comprises one or more additional layers in addition to a non-woven fiber web of a first type. In some embodiments, the one or more additional layers may serve as a prefilter for a non-woven fiber web of the first type described herein. For instance, the one or more additional layers may serve as a prefilter for a non-woven fiber web of the first type that serves as an efficiency layer. A prefilter may be positioned upstream of an efficiency layer and may assist with filtering out large particles from a fluid prior to exposing the fluid to the efficiency layer. In some such embodiments, the one or more additional layers that serve as the prefilter may improve the physical properties (e.g., dust holding capacity, air permeability, etc.) of the filter media. In some embodiments, the one or more additional layers may comprise a synthetic layer, such as a meltblown layer. As described above, it is also possible for a filter media to comprise two or more non-woven fiber webs of the first type. In some embodiments, a filter media comprises two or more non-woven fiber webs of the same type that have the same design and/or serve the same function. It is also possible for a filter media to comprise two or more non-woven fiber webs of the same type that differ in one or more ways.

In one set of embodiments, the one or more additional layers described herein may be synthetic media layers. In some such embodiments, the synthetic media layer may serve as a prefilter for a non-woven fiber web of a first type that serves as an efficiency layer. Filter media comprising both a non-woven fiber web of the first type and a synthetic media layer may be manufactured by a process that comprises fabricating both of these layers together in a single step. At the conclusion of this step, these two layers may comprise fibers that intermingle therebetween. Alternatively, the two layers may be fabricated separately and then joined together.

In some embodiments, a non-woven fiber web of the first type comprises monocomponent synthetic staple fibers. Such fibers may comprise a variety of materials, including, but not limited to, poly(ester)s (e.g., poly(ethylene terephthalate), poly(butylene terephthalate)), poly(carbonate), poly(amide)s (e.g., various nylon polymers), poly(aramid)s, poly(imide)s, poly(olefin)s (e.g., poly(ethylene), poly(propylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), fluorinated polymers (e.g., poly(vinylidene difluoride) (PVDF)), copolymers of poly(ethylene) and PVDF, and poly(ether sulfone)s.

Monocomponent synthetic staple fibers may make up a variety of suitable amounts of the synthetic media layers described herein. In some embodiments, monocomponent synthetic staple fibers make up greater than or equal than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of a synthetic media layer. In some embodiments, monocomponent synthetic staple fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, or less than or equal to 2 wt % of a synthetic media layer. Combinations of the above-referenced ranges are also possible (e.g., greater than or equal to 1 wt % and less than or equal to 100 wt %, or greater than or equal to 1 wt % and less than or equal to 90 wt %). Other ranges are also possible. In some embodiments, synthetic staple fibers make up exactly 100 wt % of a synthetic media layer.

When a synthetic media layer comprises two or more types of monocomponent synthetic staple fibers, each type of monocomponent synthetic staple fiber may independently make up an amount of the synthetic media layer in one or more of the ranges described above and/or all of the monocomponent synthetic staple fibers in a synthetic media layer may together make up an amount of the synthetic media layer in one or more of the ranges described above. Similarly, when a filter media comprises two or more synthetic media layers, each synthetic media layer may independently comprise an amount of any particular type of monocomponent synthetic staple fiber in one or more of the ranges described above and/or may comprise a total amount of monocomponent synthetic staple fibers in one or more of the ranges described above.

In some embodiments, a non-woven fiber web of the first type comprises binder fibers (e.g., multicomponent binder fibers). Such binder fibers may have one or more of the properties of the binder fibers described elsewhere herein with respect to non-woven fiber webs of the first type.

Binder fibers may make up a variety of suitable amounts of the synthetic media layers described herein. In some embodiments, binder fibers make up greater than or equal than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, or greater than or equal to 70 wt % of a synthetic media layer. In some embodiments, binder fibers make up less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, or less than or equal to 2 wt % of a synthetic media layer. Combinations of the above-referenced ranges are also possible (e.g., greater than or equal to 1 wt % and less than or equal to 80 wt %). Other ranges are also possible.

When a synthetic media layer comprises two or more types of binder fibers, each type of binder fiber may independently make up an amount of the synthetic media layer in one or more of the ranges described above and/or all of the binder fibers in a synthetic media layer may together make up an amount of the synthetic media layer in one or more of the ranges described above. Similarly, when a filter media comprises two or more synthetic media layers, each synthetic media layer may independently comprise an amount of any particular type of binder fiber in one or more of the ranges described above and/or may comprise a total amount of binder fibers in one or more of the ranges described above.

In some embodiments, a synthetic layer comprises a binder resin. Such binder resins may have one or more of the properties of the binder resins described elsewhere herein with respect to non-woven fiber webs of the first type.

Binder resins may make up a variety of suitable amounts of the synthetic media layers described herein. In some embodiments, a binder resin makes up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, or greater than or equal to 40 wt % of a synthetic media layer. In some embodiments, a binder resin makes up less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of a synthetic media layer. Combinations of the above-referenced ranges are also possible (e.g., greater than or equal to 0 wt % and less than or equal to 50 wt %). Other ranges are also possible. In some embodiments, a binder resin makes up exactly 0 wt % of a synthetic media layer.

When a synthetic media layer comprises two or more types of binder resins, each type of binder resin may independently make up an amount of the synthetic media layer in one or more of the ranges described above and/or all of the binder resins in a synthetic media layer may together make up an amount of the synthetic media layer in one or more of the ranges described above. Similarly, when a filter media comprises two or more synthetic media layers, each synthetic media layer may independently comprise an amount of any particular type of binder resin in one or more of the ranges described above and/or may comprise a total amount of binder resin in one or more of the ranges described above.

The synthetic media layers described herein may have a variety of suitable basis weights. In some embodiments, the basis weight of a synthetic media layer is greater than or equal to 5 gsm, greater than or equal to 7.5 gsm, greater than or equal to 10 gsm, greater than or equal to 15 gsm, greater than or equal to 20 gsm, greater than or equal to 30 gsm, greater than or equal to 50 gsm, greater than or equal to 75 gsm, greater than or equal to 100 gsm, greater than or equal to 125 gsm, greater than or equal to 150 gsm, or greater than or equal to 175 gsm. In some embodiments, the basis weight of a synthetic media layer is less than or equal to 200 gsm, less than or equal to 175 gsm, less than or equal to 150 gsm, less than or equal to 125 gsm, less than or equal to 100 gsm, less than or equal to 75 gsm, less than or equal to 50 gsm, less than or equal to 30 gsm, less than or equal to 20 gsm, less than or equal to 15 gsm, less than or equal to 10 gsm, or less than or equal to 7.5 gsm. Combinations of the above-referenced ranges are also possible (e.g., greater than or equal to 5 gsm and less than or equal to 200 gsm). Other ranges are also possible.

The basis weight of a synthetic media layer may be determined in accordance with ISO 536:2012.

When a filter media comprises two or more synthetic media layers, each synthetic media layer may independently have a basis weight in one or more of the above-referenced ranges.

In some embodiments, a filter media comprises a synthetic media layer that has a higher air permeability than a non-woven fiber web of the first type also present therein. In some embodiments, a ratio of the air permeability of a synthetic media layer to the air permeability of a non-woven fiber web of the first type also present in the filter media is greater than or equal to 1, greater than or equal to 1.5, greater than or equal to 2, greater than or equal to 3, greater than or equal to 4, greater than or equal to 5, greater than or equal to 7.5, greater than or equal to 10, greater than or equal to 12.5, greater than or equal to 15, greater than or equal to 20, greater than or equal to 25, greater than or equal to 30, greater than or equal to 40, greater than or equal to 50, greater than or equal to 60, or greater than or equal to 80. In some embodiments, a ratio of the air permeability of a synthetic media layer to the air permeability of a non-woven fiber web of the first type also present in the filter media is less than or equal to 100, less than or equal to 80, less than or equal to 60, less than or equal to 50, less than or equal to 40, less than or equal to 30, less than or equal to 25, less than or equal to 20, less than or equal to 15, less than or equal to 12.5, less than or equal to 10, less than or equal to 7.5, less than or equal to 5, less than or equal to 4, less than or equal to 3, less than or equal to 2, or less than or equal to 1.5. Combinations of the above-referenced ranges are also possible (e.g., greater than or equal to 1 and less than or equal to 100, greater than or equal to 1 and less than or equal to 30, or greater than or equal to 2 and less than or equal to 25). Other ranges are also possible.

The air permeabilities for the synthetic media layer and the non-woven fiber web of the first type may be determined as described elsewhere herein with respect to the air permeabilities of the non-woven fiber web of the first type.

When a filter media comprises two or more synthetic media layers and/or two or more non-woven fiber webs of the first type, each pair of synthetic media layers and non-woven fiber webs of the first type may independently have a ratio of air permeabilities in one or more of the above-referenced ranges.

In one set of embodiments, a filter media comprises two or more non-woven fiber webs of the first type that serve different functions. In some such embodiments, a first non-woven fiber web of the first type may serve as a prefilter for a second non-woven fiber web of the first type that serves as an efficiency layer. The composition of the non-woven fiber web of the first type serving as the prefilter may be same or different from the composition of the non-woven fiber web of the first type serving as the efficiency layer. For instance, the non-woven fiber webs serving as the prefilter and the efficiency layer may be identical, such that all of their properties (e.g., amount of each fiber type, fiber properties (e.g., diameter, length, level of fibrillation)) are identical to each other. In another example, one or more properties of the non-woven fiber webs of the first type serving as the prefilter and the efficiency layer may differ. For instance, the non-woven fiber web of the first type serving as the prefilter may have a higher air permeability and/or lower efficiency than the non-woven fiber web of the first type serving as the efficiency layer.

Filter media comprising two or more non-woven fiber webs of the first type may be manufactured by a process that comprises fabricating the non-woven fiber webs of the first type together in a single step. At the conclusion of this step, the two non-woven fiber webs of the first type may comprise fibers that intermingle therebetween. It is also possible for two non-woven fiber webs of the first type to be fabricated separately and then joined together. The joining may comprise lamination, thermal dot bonding, copleating, and/or collation.

As described above, in some embodiments, a filter media comprises two non-woven fiber webs of the first type that have different air permeabilities. In some embodiments, a ratio of the air permeabilities of a pair of non-woven fiber webs of the first type is greater than or equal to 1, greater than or equal to 1.5, greater than or equal to 2, greater than or equal to 3, greater than or equal to 4, greater than or equal to 5, greater than or equal to 7.5, greater than or equal to 10, greater than or equal to 12.5, greater than or equal to 15, greater than or equal to 20, greater than or equal to 25, greater than or equal to 30, greater than or equal to 40, greater than or equal to 50, greater than or equal to 60, or greater than or equal to 80. In some embodiments, a ratio of the air permeabilities of a pair of non-woven fiber webs of the first type is less than or equal to 100, less than or equal to 80, less than or equal to 60, less than or equal to 50, less than or equal to 40, less than or equal to 30, less than or equal to 25, less than or equal to 20, less than or equal to 15, less than or equal to 12.5, less than or equal to 10, less than or equal to 7.5, less than or equal to 5, less than or equal to 4, less than or equal to 3, less than or equal to 2, or less than or equal to 1.5. Combinations of the above-referenced ranges are also possible (e.g., greater than or equal to 1 and less than or equal to 100, greater than or equal to 1 and less than or equal to 30, or greater than or equal to 2 and less than or equal to 25). Other ranges are also possible.

The air permeabilities for the non-woven fiber webs of the first type may be determined as described elsewhere herein.

When a filter media comprises three non-woven fiber webs of the first type, each pair of non-woven fiber webs of the first type may independently have a ratio of air permeabilities in one or more of the above-referenced ranges.

In some embodiments, a filter media comprises one or more additional layers that are non-wetlaid layers. A non-wetlaid layer may comprise a non-wetlaid non-woven fiber web. The non-woven fiber web may be a non-woven fiber web formed by a continuous process and/or comprising continuous fibers, such as a meltblown layer, a meltspun layer, a solvent spun layer (e.g., an electrospun layer, such as a melt-electrospun layer, a centrifugal spun layer), and/or a spunbond layer. In some embodiments, the non-wetlaid layer may serve as a prefilter for a non-woven fiber web of the first type described herein. In some embodiments, a non-wetlaid layer may serve as a prefilter for a non-woven fiber web of a first type that serves as an efficiency layer. In some such embodiments, the non-wetlaid layer may comprise coarser fibers than the efficiency layer and/or may serve to filter out larger particles from a fluid prior to exposure of an efficiency layer of the efficiency layer to the fluid. This may advantageously reduce clogging of either or both of these layers by such larger particles, thereby extending the lifetime of the filter media. It is also possible for the non-wetlaid layers described herein to serve as capacity layers in a filter media and/or to provide stiffness to a filter media that enhances the ease with which it is pleated. In some embodiments, a non-wetlaid layer may serve to protect (e.g., mechanically) a relatively delicate efficiency layer to which it is adjacent. In some embodiments, a non-wetlaid layer may be joined to another layer via adhesive lamination, thermal dot bonding, copleating, and/or collation.

In some embodiments, a non-wetlaid layer comprises synthetic fibers. One example of a suitable type of synthetic fiber is poly(propylene) fibers.

The fibers in a non-wetlaid layer may have a variety of suitable average fiber diameters. In some embodiments, a non-wetlaid layer comprises fibers having an average fiber diameter of greater than or equal to 0.1 microns, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 50 microns, or greater than or equal to 75 microns. In some embodiments, a non-wetlaid layer comprises fibers having an average fiber diameter of greater than or equal to 100 microns, less than or equal to 75 microns, less than or equal to 50 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 microns and less than or equal to 100 microns). Other ranges are also possible.

When a non-wetlaid layer comprises two or more types of fibers, each type of fiber may independently have an average fiber diameter in one or more of the ranges described above and/or all of the fibers in a non-wetlaid layer may together have an average fiber diameter in one or more of the ranges described above. Similarly, when a filter media comprises two or more non-wetlaid layers, each non-wetlaid layer may independently comprise one or more types of fibers having an average fiber diameter in one or more of the ranges described above and/or may comprise fibers that overall have an average fiber diameter in one or more of the ranges described above.

The non-wetlaid layers described herein may have a variety of suitable basis weights. In some embodiments, the basis weight of a synthetic media layer is greater than or equal to 5 gsm, greater than or equal to 7.5 gsm, greater than or equal to 10 gsm, greater than or equal to 15 gsm, greater than or equal to 20 gsm, greater than or equal to 30 gsm, greater than or equal to 50 gsm, greater than or equal to 75 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, or greater than or equal to 275 gsm. In some embodiments, the basis weight of a non-wetlaid layer is less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 75 gsm, less than or equal to 50 gsm, less than or equal to 30 gsm, less than or equal to 20 gsm, less than or equal to 15 gsm, less than or equal to 10 gsm, less than or equal to 7.5 gsm, or less than or equal to 5 gsm. Combinations of the above-referenced ranges are also possible (e.g., greater than or equal to 5 gsm and less than or equal to 300 gsm). Other ranges are also possible.

The basis weight of a non-wetlaid layer may be determined in accordance with ISO 536:2012.

When a filter media comprises two or more non-wetlaid layers, each non-wetlaid layer may independently have a basis weight in one or more of the above-referenced ranges.

The non-wetlaid layers described herein may have a variety of suitable air permeabilities. In some embodiments, a non-wetlaid layer has an air permeability of greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 325 CFM, greater than or equal to 350 CFM, greater than or equal to 375 CFM, greater than or equal to 400 CFM, or greater than or equal to 450 CFM. In some embodiments, a non-wetlaid layer has an air permeability of less than or equal to 500 CFM, less than or equal to 400 CFM, less than or equal to 375 CFM, less than or equal to 350 CFM, less than or equal to 325 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, or less than or equal to 5 CFM. Combinations of the above-referenced ranges are also possible (e.g., greater than or equal to 2 CFM and less than or equal to 500 CFM). Other ranges are also possible.

The air permeability of a non-wetlaid layer may be determined in accordance with the standard TAPPI T-2551 (1985) using a test area of 38 cm² and a pressure drop of 125 Pa, which corresponds to 0.5 inches of water.

When a filter media comprises two or more non-wetlaid layers, each non-wetlaid layer may independently have an air permeability in one or more of the above-referenced ranges.

In some embodiments, a filter media comprises one or more support layers in addition to a non-woven fiber web of a first type. The support layer(s) may support and protect one or more other layer(s) of the filter media (e.g., an efficiency layer that is a non-woven fiber web of the first type). In some embodiments, a filter media comprises one or more support layers that are backer(s), spunbond layer(s), and/or wire meshes. Support layers serving as backers may be relatively open (e.g., they may contribute only minimally to the air resistance of the filter media) and/or may provide structural support to the filter media. In some embodiments, a support layer may be a backer that is relatively stiff and/or pleatable. In some embodiments, a backer may be a cellulose backer, synthetic backer, or a backer that comprises cellulose mixed with glass or synthetic fibers. In some embodiments, a backer layer may be joined to an efficiency layer via the intermingling of fibers extending from the backer layer and/or the efficiency layer (e.g., a non-woven fiber web of the first type).

In some embodiments, a backer may comprise a binder resin. The binder resin may comprise a thermoset and/or a thermoplastic, such as those described previously. One example of a suitable thermoplastic binder resin is a hot melt adhesive (e.g., a hot melt adhesive comprising a poly(olefin), a poly(ester), a poly(amide), a poly(urethane), and/or ethylene vinyl acetate). Non-limiting examples of suitable thermoset binder resins include acrylic binders, binder resins comprising vinyl ester (and/or reaction products thereof), phenolic binders, thermosetting poly(urethane)s, epoxy, and unsaturated poly(ethylene terephthalate).

In some embodiments, a filter media comprises an efficiency layer that is a non-woven fiber web of the first type, a prefilter layer positioned upstream of the efficiency layer, and a support layer positioned downstream of the efficiency layer. The prefilter and the support layers may include any suitable materials and have any physical properties described elsewhere herein.

In some embodiments, a backer includes natural fibers. The natural fibers may have one or more of the properties described elsewhere herein with respect to natural fibers that may be present in non-woven fiber webs of the first type. In some embodiments, natural fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the fibers in the backer. In some embodiments, natural fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a backer. Combinations of the above-referenced ranges are also possible (e.g., greater than or equal to 0 wt % and less than or equal to 100 wt %). Other ranges are also possible. In some embodiments, natural fibers make up exactly 0 wt % of a backer. In some embodiments, natural fibers make up exactly 100 wt % of a backer.

In embodiments in which a filter media comprises two or more backers, each backer may independently comprise an amount of natural fibers in one or more of the ranges described above.

In some embodiments, a backer comprises synthetic fibers. In some embodiments, synthetic fibers make up a relatively high percentage of a backer. For instance, synthetic fibers may make up greater than or equal to 0 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the fibers in the backer. In some embodiments, synthetic fibers make up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 10 wt % of the fibers in the backer. Combinations of the above-referenced ranges are also possible (e.g., greater than or equal to 0 wt % and less than or equal to 100 wt %, greater than or equal to 50 wt % and less than or equal to 100 wt %, greater than or equal to 90 wt % and less than or equal to 100 wt %, or greater than or equal to 95 wt % and less than or equal to 100 wt %). Other ranges are also possible. In some embodiments, 0 wt % of the fibers in the backer are synthetic fibers. In some embodiments, 100 wt % of the fibers in the backer are synthetic fibers.

In embodiments in which a filter media comprises two or more backers, each backer may independently comprise an amount of synthetic fibers in one or more of the ranges described above.

The backers described herein may include a variety of suitable amounts of binder fibers (e.g., multicomponent fibers and/or monocomponent fibers, such as those described previously).

In some embodiments, binder fibers make up greater than or equal to 0 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 45 wt %, greater than or equal to 50 wt %, greater than or equal to 60 wt %, greater than or equal to 70 wt %, greater than or equal to 75 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the fibers in the backer. In some embodiments, binder fibers make up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 75 wt %, less than or equal to 70 wt %, less than or equal to 60 wt %, less than or equal to 50 wt %, less than or equal to 45 wt %, less than or equal to 40 wt %, less than or equal to 30 wt %, less than or equal to 25 wt %, less than or equal to 20 wt %, less than or equal to 15 wt %, or less than or equal to 10 wt % of the fibers in the backer. Combinations of the above-referenced ranges are also possible (e.g., greater than or equal to 0 wt % and less than or equal to 100 wt %, greater than or equal to 10 wt % and less than or equal to 100 wt %, greater than or equal to 10 wt % and less than or equal to 80 wt %, greater than or equal to 20 wt % and less than or equal to 50 wt %, greater than or equal to 30 wt % and less than or equal to 90 wt %, greater than or equal to 50 wt % and less than or equal to 85 wt %, or greater than or equal to 70 wt % and less than or equal to 90 wt %). Other ranges are also possible. In some embodiments, 0 wt % of the fibers in the backer are binder fibers.

It should be understood that any of the following binder fibers may independently make up a wt % of a backer in one or more of the ranges described above: (1) a particular type of multicomponent fiber in the backer; (2) all of the multicomponent fibers in the backer together; (3) a particular type of monocomponent fiber in the backer; (4) all of the monocomponent fibers in the backer together; and (5) all of the multicomponent fibers and monocomponent fibers in the backer together. It should also be understood that a filter media may comprise two or more backers, for which the above may independently be true for each.

In some embodiments, a backer includes a binder resin. The binder resin may have one or more of the properties described elsewhere herein with respect to binder resins that may be present in non-woven fiber webs of the first type. In some embodiments, a binder resin makes up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, or greater than or equal to 35 wt % of a backer. In some embodiments, a binder resin makes up less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of a backer. Combinations of the above-referenced ranges are also possible (e.g., greater than or equal to 0 wt % and less than or equal to 40 wt %). In some embodiments, a binder resin makes up exactly 0 wt % of a backer.

In embodiments in which a filter media comprises two or more backers, each backer may independently comprise an amount of binder resin in one or more of the ranges described above.

The backers described herein may have relatively high values of dry tensile strength in the machine direction. In some embodiments, a backer has a dry tensile strength in the machine direction of greater than or equal to 5 lb/in, greater than or equal to 7.5 lb/in, greater than or equal to 10 lb/in, greater than or equal to 11 lb/in, greater than or equal to 12 lb/in, greater than or equal to 13 lb/in, greater than or equal to 14 lb/in, greater than or equal to 15 lb/in, greater than or equal to 16 lb/in, greater than or equal to 17 lb/in, greater than or equal to 18 lb/in, greater than or equal to 20 lb/in, greater than or equal to 22 lb/in, greater than or equal to 24 lb/in, greater than or equal to 26 lb/in, greater than or equal to 28 lb/in, greater than or equal to 30 lb/in, greater than or equal to 32.5 lb/in, greater than or equal to 35 lb/in, greater than or equal to 37.5 lb/in, greater than or equal to 40 lb/in, greater than or equal to 42.5 lb/in, greater than or equal to 45 lb/in, greater than or equal to 50 lb/in, greater than or equal to 60 lb/in, greater than or equal to 70 lb/in, greater than or equal to 80 lb/in, or greater than or equal to 90 lb/in. In some embodiments, a backer has a dry tensile strength in the machine direction of less than or equal to 100 lb/in, less than or equal to 90 lb/in, less than or equal to 80 lb/in, less than or equal to 70 lb/in, less than or equal to 60 lb/in, less than or equal to 50 lb/in, less than or equal to 45 lb/in, less than or equal to 42.5 lb/in, less than or equal to 40 lb/in, less than or equal to 37.5 lb/in, less than or equal to 35 lb/in, less than or equal to 32.5 lb/in, less than or equal to 30 lb/in, less than or equal to 28 lb/in, less than or equal to 26 lb/in, less than or equal to 24 lb/in, less than or equal to 22 lb/in, less than or equal to 20 lb/in, less than or equal to 18 lb/in, less than or equal to 17 lb/in, less than or equal to 16 lb/in, less than or equal to 15 lb/in, less than or equal to 14 lb/in, less than or equal to 13 lb/in, less than or equal to 12 lb/in, less than or equal to 11 lb/in, less than or equal to 10 lb/in, or less than or equal to 7.5 lb/in. Combinations of the above-referenced ranges are also possible (e.g., greater than or equal to 5 lb/in and less than or equal to 100 lb/in, greater than or equal to 10 lb/in and less than or equal to 50 lb/in, or greater than or equal to 15 lb/in and less than or equal to 30 lb/in). Other ranges are also possible.

The dry tensile strength in the machine direction of a backer may be determined as described elsewhere herein with respect to the determination of the dry tensile strength of a non-woven fiber web of the first type.

In embodiments in which a filter media comprises two or more backers, each backer may independently have a dry tensile strength in the machine direction in one or more of the above-referenced ranges.

In some embodiments, a backer has a relatively high dry tensile strength in the cross direction. The backer may have a dry tensile strength in the cross direction of greater than or equal to 2 lb/in, greater than or equal to 2.5 lb/in, greater than or equal to 3 lb/in, greater than or equal to 3.5 lb/in, greater than or equal to 4 lb/in, greater than or equal to 4.5 lb/in, greater than or equal to 5 lb/in, greater than or equal to 6 lb/in, greater than or equal to 7 lb/in, greater than or equal to 8 lb/in, greater than or equal to 9 lb/in, greater than or equal to 10 lb/in, greater than or equal to 11 lb/in, greater than or equal to 12 lb/in, greater than or equal to 15 lb/in, greater than or equal to 17.5 lb/in, greater than or equal to 20 lb/in, greater than or equal to 25 lb/in, greater than or equal to 30 lb/in, greater than or equal to 35 lb/in, greater than or equal to 40 lb/in, greater than or equal to 50 lb/in, greater than or equal to 60 lb/in, or greater than or equal to 70 lb/in. The backer may have a dry tensile strength in the cross direction of less than or equal to 80 lb/in, less than or equal to 70 lb/in, less than or equal to 60 lb/in, less than or equal to 50 lb/in, less than or equal to 40 lb/in, less than or equal to 35 lb/in, less than or equal to 30 lb/in, less than or equal to 25 lb/in, less than or equal to 20 lb/in, less than or equal to 17.5 lb/in, less than or equal to 15 lb/in, less than or equal to 12 lb/in, less than or equal to 11 lb/in, less than or equal to 10 lb/in, less than or equal to 9 lb/in less than or equal to 8 lb/in, less than or equal to 7 lb/in, less than or equal to 6 lb/in, less than or equal to 5 lb/in, less than or equal to 4.5 lb/in, less than or equal to 4 lb/in, less than or equal to 3.5 lb/in, less than or equal to 3 lb/in, or less than or equal to 2.5 lb/in. Combinations of the above-referenced ranges are also possible (e.g., greater than or equal to 2 lb/in and less than or equal to 80 lb/in, greater than or equal to 5 lb/in and less than or equal to 40 lb/in, or greater than or equal to 5 lb/in and less than or equal to 20 lb/in). Other ranges are also possible.

The dry tensile strength in the cross direction of a backer may be determined as described elsewhere herein with respect to the determination of the dry tensile strength of a non-woven fiber web of the first type.

In embodiments in which a filter media comprises two or more backers, each backer may independently have a dry tensile strength in the cross direction in one or more of the above-referenced ranges.

A backer may have a variety of suitable ratios of dry tensile strength in the machine direction to dry tensile strength in the cross direction. In some embodiments, the ratio of dry tensile strength in the machine direction to dry tensile strength in the cross direction for a backer is greater than or equal to 1.5, greater than or equal to 1.75, greater than or equal to 2, greater than or equal to 2.25, greater than or equal to 2.5, greater than or equal to 2.75, greater than or equal to 3, greater than or equal to 3.25, greater than or equal to 3.5, greater than or equal to 4, greater than or equal to 4.5, greater than or equal to 5, greater than or equal to 6, greater than or equal to 7, greater than or equal to 8, greater than or equal to 9, greater than or equal to 10, greater than or equal to 11, greater than or equal to 12, greater than or equal to 13, or greater than or equal to 14. In some embodiments, the ratio of dry tensile strength in the machine direction to dry tensile strength in the cross direction for a backer is less than or equal to 15, less than or equal to 14, less than or equal to 13, less than or equal to 12, less than or equal to 11, less than or equal to 10, less than or equal to 9, less than or equal to 8, less than or equal to 7, less than or equal to 6, less than or equal to 5, less than or equal to 4.5, less than or equal to 4, less than or equal to 3.5, less than or equal to 3.25, less than or equal to 3, less than or equal to 2.75, less than or equal to 2.5, less than or equal to 2.25, less than or equal to 2, or less than or equal to 1.75. Combinations of the above-referenced ranges are also possible (e.g., greater than or equal to 1.5 and less than or equal to 15, greater than or equal to 2 and less than or equal to 10, or greater than or equal to 3 and less than or equal to 6). Other ranges are also possible.

In embodiments in which a filter media comprises two or more backers, each backer may independently have a ratio of dry tensile strength in the machine direction to dry tensile strength in the cross direction in one or more of the above-referenced ranges.

The backers described herein may have a variety of suitable basis weights. In some embodiments, a backer has a basis weight of greater than or equal to 20 gsm, greater than or equal to 25 gsm, greater than or equal to 30 gsm, greater than or equal to 35 gsm, greater than or equal to 40 gsm, greater than or equal to 45 gsm, greater than or equal to 50 gsm, greater than or equal to 60 gsm, greater than or equal to 80 gsm, greater than or equal to 100 gsm, greater than or equal to 120 gsm, greater than or equal to 150 gsm, greater than or equal to 175 gsm, greater than or equal to 200 gsm, greater than or equal to 250 gsm, greater than or equal to 300 gsm, greater than or equal to 400 gsm, or greater than or equal to 450 gsm. In some embodiments, a backer has a basis weight of less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 175 gsm, less than or equal to 150 gsm, less than or equal to 120 gsm, less than or equal to 100 gsm, less than or equal to 80 gsm, less than or equal to 60 gsm, less than or equal to 50 gsm, less than or equal to 45 gsm, less than or equal to 40 gsm, less than or equal to 35 gsm, less than or equal to 30 gsm, or less than or equal to 25 gsm. Combinations of the above-referenced ranges are also possible (e.g., greater than or equal to 20 gsm and less than or equal to 500 gsm, greater than or equal to 30 gsm and less than or equal to 300 gsm, or greater than or equal to 50 gsm and less than or equal to 200 gsm).

The basis weight of a backer may be determined in accordance with ISO 536:2012.

In embodiments in which a filter media comprises two or more backers, each backer may independently have a basis weight in one or more of the above-referenced ranges.

The thickness of a backer may generally be selected as desired. In some embodiments, a backer has a thickness of greater than or equal to 0.1 mm, greater than or equal to 0.125 mm, greater than or equal to 0.15 mm, greater than or equal to 0.175 mm, greater than or equal to 0.2 mm, greater than or equal to 0.225 mm, greater than or equal to 0.25 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 1 mm, greater than or equal to 1.1 mm, greater than or equal to 1.25 mm, greater than or equal to 1.4 mm, greater than or equal to 1.5 mm, greater than or equal to 1.6 mm, greater than or equal to 1.8 mm, greater than or equal to 2 mm, greater than or equal to 2.5 mm, greater than or equal to 3 mm, greater than or equal to 4 mm, greater than or equal to 5 mm, greater than or equal to 6 mm, or greater than or equal to 8 mm. In some embodiments, a backer has a thickness of less than or equal to 10 mm, less than or equal to 8 mm, less than or equal to 6 mm, less than or equal to 5 mm, less than or equal to 4 mm, less than or equal to 3 mm, less than or equal to 2.5 mm, less than or equal to 2 mm, less than or equal to 1.8 mm, less than or equal to 1.6 mm, less than or equal to 1.5 mm, less than or equal to 1.4 mm, less than or equal to 1.25 mm, less than or equal to 1.1 mm, less than or equal to 1 mm, less than or equal to 0.7 mm, less than or equal to 0.6 mm, less than or equal to 0.5 mm, less than or equal to 0.4 mm, less than or equal to 0.3 mm, less than or equal to 0.2 mm, less than or equal to 0.175 mm, less than or equal to 0.15 mm, or less than or equal to 0.125 mm. Combinations of the above-referenced ranges are also possible (e.g., greater than or equal to 0.1 mm and less than or equal to 10 mm, greater than or equal to 0.2 mm and less than or equal to 1 mm, or greater than or equal to 0.3 mm and less than or equal to 0.7 mm).

The thickness of a backer may be determined in accordance with ISO 534 (2011) under an applied pressure of 2 N/cm².

In embodiments in which a filter media comprises two or more backers, each backer may independently have a thickness in one or more of the above-referenced ranges.

When present, a backer may have a variety of suitable air permeabilities. In some embodiments, a backer has an air permeability of greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 350 CFM, greater than or equal to 400 CFM, greater than or equal to 500 CFM, or greater than or equal to 750 CFM. In some embodiments, a backer has an air permeability of less than or equal to 1000 CFM, less than or equal to 750 CFM, less than or equal to 500 CFM, less than or equal to 400 CFM, less than or equal to 350 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, or less than or equal to 2 CFM. Combinations of the above-referenced ranges are also possible (e.g., greater than or equal to 1 CFM and less than or equal to 1000 CFM, greater than or equal to 5 CFM and less than or equal to 500 CFM, or greater than or equal to 10 CFM and less than or equal to 100 CFM). Other ranges are also possible.

The air permeability of a backer may be determined in accordance with the standard TAPPI T-2551 (1985) using a test area of 38 cm² and a pressure drop of 125 Pa, which corresponds to 0.5 inches of water.

In embodiments in which a filter media comprises two or more backers, each backer may independently have an air permeability in one or more of the above-referenced ranges.

When present, a backer may have a variety of suitable mean flow pore sizes. In some embodiments, a backer has a mean flow pore size of greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 80 microns, greater than or equal to 100 microns, greater than or equal to 125 microns, greater than or equal to 150 microns, or greater than or equal to 175 microns. In some embodiments, a backer has a mean flow pore size of less than or equal to 200 microns, less than or equal to 175 microns, less than or equal to 150 microns, less than or equal to 125 microns, less than or equal to 100 microns, less than or equal to 80 microns, less than or equal to 60 microns, less than or equal to 50 microns, less than or equal to 40 microns, less than or equal to 30 microns, less than or equal to 25 microns, less than or equal to 20 microns, or less than or equal to 15 microns. Combinations of the above-referenced ranges are also possible (e.g., greater than or equal to 10 microns and less than or equal to 200 microns, greater than or equal to 20 microns and less than or equal to 150 microns, or greater than or equal to 30 microns and less than or equal to 100 microns). Other ranges are also possible.

The mean flow pore size of a backer may be determined in accordance with ASTM F316 (2003).

In embodiments in which a filter media comprises two or more backers, each backer may independently have a mean flow pore size in one or more of the above-referenced ranges.

In some embodiments, a backer has a relatively high stiffness in the cross direction. A backer may have a stiffness in the cross direction of greater than or equal to 45 mg, greater than or equal to 100 mg, greater than or equal to 125 mg, greater than or equal to 150 mg, greater than or equal to 175 mg, greater than or equal to 200 mg, greater than or equal to 250 mg, greater than or equal to 300 mg, greater than or equal to 350 mg, greater than or equal to 400 mg, greater than or equal to 450 mg, greater than or equal to 500 mg, greater than or equal to 525 mg, greater than or equal to 550 mg, greater than or equal to 575 mg, greater than or equal to 600 mg, greater than or equal to 700 mg, greater than or equal to 800 mg, greater than or equal to 900 mg, greater than or equal to 950 mg, greater than or equal to 1000 mg, greater than or equal to 1250 mg, greater than or equal to 1500 mg, greater than or equal to 1750 mg, greater than or equal to 2000 mg, greater than or equal to 3000 mg, greater than or equal to 5000 mg, greater than or equal to 7500 mg, greater than or equal to 9000 mg, greater than or equal to 10000 mg, or greater than or equal to 12000 mg. A backer may have a stiffness in the cross direction of less than or equal to 15000 mg, less than or equal to 12000 mg, less than or equal to 1000 mg, less than or equal to 9000 mg, less than or equal to 7500 mg, less than or equal to 5000 mg, less than or equal to 3000 mg, less than or equal to 2000 mg, less than or equal to 1750 mg, less than or equal to 1500 mg, less than or equal to 1250 mg, less than or equal to 1000 mg, less than or equal to 950 mg, less than or equal to 900 mg, less than or equal to 800 mg, less than or equal to 700 mg, less than or equal to 600 mg, less than or equal to 575 mg, less than or equal to 550 mg, less than or equal to 525 mg, less than or equal to 500 mg, less than or equal to 450 mg, less than or equal to 400 mg, less than or equal to 350 mg, less than or equal to 300 mg, less than or equal to 250 mg, less than or equal to 200 mg, less than or equal to 175 mg, less than or equal to 150 mg, or less than or equal to 125 mg. Combinations of the above-referenced ranges are also possible (e.g., greater than or equal to 100 mg and less than or equal to 15000 mg, greater than or equal to 500 mg and less than or equal to 1200 mg, or greater than or equal to 1000 mg and less than or equal to 1000 mg). Other ranges are also possible.

The stiffness of a backer in the cross direction may be determined in accordance with TAPPI T543 om-94 using a sample size of 2 in×2.5 in.

In embodiments in which a filter media comprises two or more backers, each backer may independently have a stiffness in the cross direction in one or more of the above-referenced ranges.

The backer described herein may have a variety of suitable dry Mullen burst strengths. The dry Mullen burst strength of a backer may be greater than or equal to 5 psi, greater than or equal to 7.5 psi, greater than or equal to 10 psi, greater than or equal to 20 psi, greater than or equal to 50 psi, greater than or equal to 75 psi, greater than or equal to 100 psi, greater than or equal to 125 psi, greater than or equal to 150 psi, greater than or equal to 175 psi, greater than or equal to 200 psi, greater than or equal to 225 psi, greater than or equal to 250 psi, or greater than or equal to 275 psi. The dry Mullen burst strength of a backer may be less than or equal to 300 psi, less than or equal to 275 psi, less than or equal to 250 psi, less than or equal to 225 psi, less than or equal to 200 psi, less than or equal to 175 psi, less than or equal to 150 psi, less than or equal to 125 psi, less than or equal to 100 psi, less than or equal to 75 psi, less than or equal to 50 psi, less than or equal to 20 psi, less than or equal to 10 psi, or less than or equal to 7.5 psi. Combinations of the above-referenced ranges are also possible (e.g., greater than or equal to 5 psi and less than or equal to 300 psi, greater than or equal to 10 psi and less than or equal to 200 psi, or greater than or equal to 20 psi and less than or equal to 100 psi). Other ranges are also possible.

The dry Mullen burst strength of a backer may be determined in accordance with the standard TAPPI T403 (1997) test.

As described elsewhere herein, in some embodiments, a filter media comprises two or more layers. One or more of the layers present in the filter media may be a non-woven fiber web of the first type as described elsewhere herein. In some embodiments, a filter media comprises one or more additional layers that comprise one or more of synthetic fibers, natural fibers, glass fibers, solvent spun fibers (e.g., electrospun fibers, such as melt-electrospun fibers, centrifugal spun fibers), spunbond fibers, and/or meltblown fibers, as described herein. When present, the one or more additional layer(s) may be positioned either upstream or downstream of a non-woven fiber web of the first type.

In some embodiments, one or more non-woven fiber webs and/or layers in a filter media (e.g., a non-woven fiber web of the first type) may, as described elsewhere herein, comprise two or more pluralities of undulations, comprise exactly one plurality of undulations, or lack undulations. As described elsewhere herein, the presence of a non-woven fiber web and/or layer may increase the surface area associated therewith, and thereby enhancing one or more of its physical properties (e.g., dust holding capacity, air permeability, etc.).

Undulating and/or creping a non-woven fiber web and/or layer (e.g., a non-woven fiber web of the first type) may increase its basis weight. In some embodiments, a non-woven fiber web and/or layer comprises undulations and/or that is creped has a basis weight of greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, greater than or equal to 300 gsm, greater than or equal to 350 gsm, greater than or equal to 400 gsm, greater than or equal to 500 gsm, or greater than or equal to 750 gsm. In some embodiments, a non-woven fiber web and/or layer that comprises undulations and/or that is creped has a basis weight of less than or equal to 1000 gsm, less than or equal to 750 gsm, less than or equal to 500 gsm, less than or equal to 400 gsm, less than or equal to 450 gsm, less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 30 gsm, less than or equal to 25 gsm, less than or equal to 20 gsm, or less than or equal to 15 gsm. Combinations of the above-referenced ranges are also possible (e.g., greater than or equal to 10 gsm and less than or equal to 1000 gsm, greater than or equal to 20 gsm and less than or equal to 500 gsm, or greater than or equal to 40 gsm and less than or equal to 300 gsm). Other ranges are also possible.

The basis weight of a non-woven fiber web and/or layer that comprises undulations and/or that is creped may be determined in accordance with ISO 536:2012.

When a filter media comprises two or more non-woven fiber webs and/or layers that comprise undulations and/or that are creped, each such non-woven fiber web and/or layer may independently have a basis weight in one or more of the above-referenced ranges.

Undulating and/or creping a non-woven fiber web and/or layer (e.g., a non-woven fiber web of the first type) may increase its thickness. In some embodiments, a non-woven fiber web and/or layer that comprises undulations and/or that is creped has a thickness of greater than or equal to 0.1 mm, greater than or equal to 0.15 mm, greater than or equal to 0.2 mm, greater than or equal to 0.25 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.1 mm, greater than or equal to 1.2 mm, greater than or equal to 1.3 mm, greater than or equal to 1.4 mm, greater than or equal to 1.5 mm, greater than or equal to 1.6 mm, greater than or equal to 1.7 mm, greater than or equal to 1.8 mm, greater than or equal to 1.9 mm, greater than or equal to 2 mm, greater than or equal to 2.25 mm, greater than or equal to 2.5 mm, greater than or equal to 3 mm, greater than or equal to 4 mm, greater than or equal to 5 mm, or greater than or equal to 7.5 mm. In some embodiments, a non-woven fiber web and/or layer that comprises undulations and/or is creped has a thickness of less than or equal to 10 mm, less than or equal to 7.5 mm, less than or equal to 5 mm, less than or equal to 4 mm, less than or equal to 3 mm, less than or equal to 2.5 mm, less than or equal to 2.25 mm, less than or equal to 2 mm, less than or equal to 1.9 mm, less than or equal to 1.8 mm, less than or equal to 1.7 mm, less than or equal to 1.6 mm, less than or equal to 1.5 mm, less than or equal to 1.4 mm, less than or equal to 1.3 mm, less than or equal to 1.2 mm, less than or equal to 1.1 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, less than or equal to 0.3 mm, less than or equal to 0.2 mm, or less than or equal to 0.15 mm. Combinations of the above-referenced ranges are also possible (e.g., greater than or equal to 0.1 mm and less than or equal to 10 mm, greater than or equal to 0.2 mm and less than or equal to 2 mm, or greater than or equal to 0.3 mm and less than or equal to 1.5 mm). Other ranges are also possible.

The thickness of a non-woven fiber web and/or layer that comprises undulations and/or that is creped may be determined in accordance with ISO 534 (2011) under an applied pressure of 2 N/cm².

When a filter media comprises two or more non-woven fiber webs and/or layers that comprise undulations and/or that are creped, each such non-woven fiber web and/or layer may independently have a thickness in one or more of the above-referenced ranges.

Undulating and/or creping a non-woven fiber web and/or layer (e.g., a non-woven fiber web of the first type) may increase its air permeability. In some embodiments, a non-woven fiber web and/or layer that comprises undulations and/or that is creped has an air permeability of greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, or greater than or equal to 325 CFM, greater than or equal to 350 CFM, greater than or equal to 375 CFM, greater than or equal to 400 CFM, greater than or equal to 450 CFM, greater than or equal to 500 CFM, greater than or equal to 600 CFM, greater than or equal to 700 CFM, or greater than or equal to 800 CFM. In some embodiments, a non-woven fiber web and/or layer that comprises undulations and/or that is creped has an air permeability of less than or equal to 1000 CFM, less than or equal to 800 CFM, less than or equal to 700 CFM, less than or equal to 600 CFM, less than or equal to 500 CFM, less than or equal to 450 CFM, less than or equal to 400 CFM, less than or equal to 375 CFM, less than or equal to 350 CFM, less than or equal to 325 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, or less than or equal to 2 CFM. Combinations of the above-referenced ranges are also possible (e.g., greater than or equal to 1 CFM and less than or equal to 1000 CFM, greater than or equal to 2 CFM and less than or equal to 500 CFM, or greater than or equal to 5 CFM and less than or equal to 200 CFM). Other ranges are also possible.

The air permeability of a non-woven fiber web and/or layer that comprises undulations and/or that is creped may be determined in accordance with the standard TAPPI T-2551 (1985) using a test area of 38 cm² and a pressure drop of 125 Pa, which corresponds to 0.5 inches of water.

When a filter media comprises two or more non-woven fiber webs and/or layers that comprise undulations and/or that are creped, each such non-woven fiber web of and/or layer may independently have an air permeability in one or more of the above-referenced ranges.

Undulating and/or creping a non-woven fiber web and/or layer (e.g., a non-woven fiber web of the first type) may increase its dry tensile elongation at break in the machine direction and/or the cross direction. The dry tensile elongation at break of a non-woven fiber web and/or layer that comprises undulations and/or that is creped may be greater than or equal to 5%, greater than or equal to 10%, greater than or equal to 20%, greater than or equal to 30%, greater than or equal to 40%, greater than or equal to 50%, greater than or equal to 75%, greater than or equal to 100%, greater than or equal to 125%, greater than or equal to 150%, greater than or equal to 175%, greater than or equal to 200%, greater than or equal to 250%, greater than or equal to 300%, greater than or equal to 350%, or greater than or equal to 400%. The dry tensile elongation at break of a non-woven fiber web and/or layer that comprises undulations and/or that is creped may be less than or equal to 500%, less than or equal to 400%, less than or equal to 350%, less than or equal to 300%, less than or equal to 250%, less than or equal to 200%, less than or equal to 175%, less than or equal to 150%, less than or equal to 125%, less than or equal to 100%, less than or equal to 75%, less than or equal to 50%, less than or equal to 40%, less than or equal to 30%, less than or equal to 20%, or less than or equal to 10%. Combinations of the above-referenced ranges are also possible (e.g., greater than or equal to 5% and less than or equal to 500%, greater than or equal to 20% and less than or equal to 300%, or greater than or equal to 40% and less than or equal to 150%). Other ranges are also possible.

The dry tensile elongations at break in the machine direction and the cross direction of a non-woven fiber web and/or layer that comprises undulations and/or that is creped may be determined in accordance with the standard T494 om-96 (1996) test using a test span of 5 inches and a jaw separation speed of 12 in/min.

When a filter media comprises two or more non-woven fiber webs and/or layers that comprise undulations and/or that are creped, each such non-woven fiber web and/or layer may independently have a dry tensile elongation at break in the machine direction in one or more of the above-referenced ranges. Similarly, when a filter media comprises two or more non-woven fiber webs and/or layers that comprise undulations and/or that are creped, each such non-woven fiber web and/or layer may independently have a dry tensile elongation at break in the cross direction in one or more of the above-referenced ranges.

Undulating and/or creping a non-woven fiber web and/or layer (e.g., a non-woven fiber web of the first type) may increase its dust holding capacity. The dust holding capacity of a non-woven fiber web and/or layer that comprises undulations and/or that is creped may be greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 150 gsm, greater than or equal to 200 gsm, greater than or equal to 300 gsm, greater than or equal to 400 gsm, greater than or equal to 500 gsm, greater than or equal to 600 gsm, greater than or equal to 700 gsm, greater than or equal to 800 gsm, or greater than or equal to 900 gsm. The dust holding capacity of a non-woven fiber web and/or layer that comprises undulations and/or that is creped may be less than or equal to 1000 gsm, less than or equal to 900 gsm, less than or equal to 800 gsm, less than or equal to 700 gsm, less than or equal to 600 gsm, less than or equal to 500 gsm, less than or equal to 400 gsm, less than or equal to 300 gsm, less than or equal to 200 gsm, less than or equal to 150 gsm, less than or equal to 100 gsm, less than or equal to 90 gsm, less than or equal to 80 gsm, less than or equal to 70 gsm, or less than or equal to 60 gsm. Combinations of the above-referenced ranges are also possible (e.g., greater than or equal to 50 gsm and less than or equal to 1000 gsm, greater than or equal to 100 gsm and less than or equal to 500 gsm, or greater than or equal to 150 gsm and less than or equal to 500 gsm). Other ranges are also possible.

As mentioned, references herein to dust holding capacity refer to the injected dust holding capacity. In other words, the ranges provided above relate to the injected dust holding capacity of the non-woven fiber webs and/or layers that comprise undulations and/or that are creped. This dust holding capacity may be measured as described elsewhere herein according to ISO 19438 (2013) using ISO medium test dust (A3) and a flow velocity of 0.06 cm/s; dust holding capacity is measured when the pressure drop across the fiber web reaches 100 kPa.

When a filter media comprises two or more non-woven fiber webs and/or layers that comprise undulations and/or that are creped, each such non-woven fiber web and/or layer may independently have a dust holding capacity in one or more of the above-referenced ranges.

In some embodiments, the dust holding capacity of a non-woven fiber web and/or layer comprising two or more plurality of undulations is at least 1.2 times (e.g., at least 1.5 times, at least 2 times, at least 2.5 times, at least 3 times, at least 4 times, or at least 5 times) as large as the dust holding capacity of a non-woven fiber web and/or layer that does not comprise the two or more plurality of undulations.

As described above, in some embodiments, a filter media comprises a non-woven fiber web and/or a layer comprising two or more pluralities of undulations. In some such embodiments, a second plurality of undulations may be positioned within the first plurality of undulations. In some embodiments, a filter media comprises a first plurality of undulations for which, for an appreciable fraction of the undulations, a second plurality of undulations is positioned therein. In some embodiments, second pluralities of undulations are positioned within greater than or equal to 1%, greater than or equal to 2%, greater than or equal to 5%, greater than or equal to 7.5%, greater than or equal to 10%, greater than or equal to 15%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, or greater than or equal to 95% of the undulations within a first plurality of undulations. In some embodiments second pluralities of undulations are positioned within less than or equal to 99%, less than or equal to 95%, less than or equal to 90%, less than or equal to 80%, less than or equal to 70%, less than or equal to 60%, less than or equal to 50%, less than or equal to 40%, less than or equal to 30%, less than or equal to 20%, less than or equal to 15%, less than or equal to 10%, less than or equal to 7.5%, less than or equal to 5%, or less than or equal to 2% of the undulations in a first plurality of undulations. Combinations of the above-referenced ranges are also possible (e.g., greater than or equal to 1% and less than or equal to 99%, or greater than or equal to 1% and less than or equal to 80%). Other ranges are also possible.

Undulations in a first plurality of undulations may have a variety of suitable heights. In some embodiments, a filter media, non-woven fiber web, and/or layer comprises a first plurality of undulations comprising undulations having an average height of greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 15 mm, or greater than or equal to 20 mm. In some embodiments, a filter media, non-woven fiber web, and/or layer comprises a first plurality of undulations comprising undulations having an average height of less than or equal to 25 mm, less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, less than or equal to 0.2 mm, less than or equal to 0.1 mm, or less than or equal to 0.075 mm. Combinations of the above-referenced ranges are also possible (e.g., greater than or equal to 0.05 mm and less than or equal to 25 mm). Other ranges are also possible.

The height of an undulation in a first plurality of undulations may be determined by: (1) drawing a first line segment connecting two directly adjacent troughs in a first plurality of undulations; (2) drawing a second line segment connecting the peak positioned between the two troughs with the first line segment that is also perpendicular to the first line segment; and (3) measuring the length of the second line segment. The average height of the undulations in a first plurality of undulations may be determined by averaging the individual heights for each undulation in the first plurality of undulations.

Undulations in a second plurality of undulations may also have a variety of suitable heights. Such undulations may have smaller heights than the undulations in which they are positioned (e.g., a first plurality of undulations). In some embodiments, a filter media, non-woven fiber web, and/or layer comprises a second plurality of undulations comprising undulations having an average height of greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 15 mm, or greater than or equal to 20 mm. In some embodiments, a filter media, non-woven fiber web, and/or layer comprises a second plurality of undulations comprising undulations having an average height of less than or equal to 24.99 mm, less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, or less than or equal to 0.02 mm. Combinations of the above-referenced ranges are also possible (e.g., greater than or equal to 0.01 mm and less than or equal to 24.99 mm). Other ranges are also possible.

The height of an undulation in a second plurality of undulations may be determined by: (1) drawing a first line segment connecting a peak in the first plurality of undulations and a directly adjacent trough in the first plurality of undulations within which the second plurality of undulations is positioned; (2) drawing a second line segment connecting a point in the plurality of second undulations having a local maximum distance from the first line segment with the first line segment that is also perpendicular to the first line segment; and (3) measuring the length of the second line segment. In step (3), the length will always be considered to be a positive value (i.e., second line segments connecting portions of the second undulation on one side of the first line segment thereto and second line segments connecting portions of the second undulation on the opposite side of the first line segment thereto will be considered to have lengths having positive values). This set of heights for each undulation is indexed with respect to the first line segment. Accordingly, the average height for the undulations in a second plurality of undulations may be determined by averaging the individual heights for each undulation in the second plurality of undulations and then multiplying the resultant value by 2.

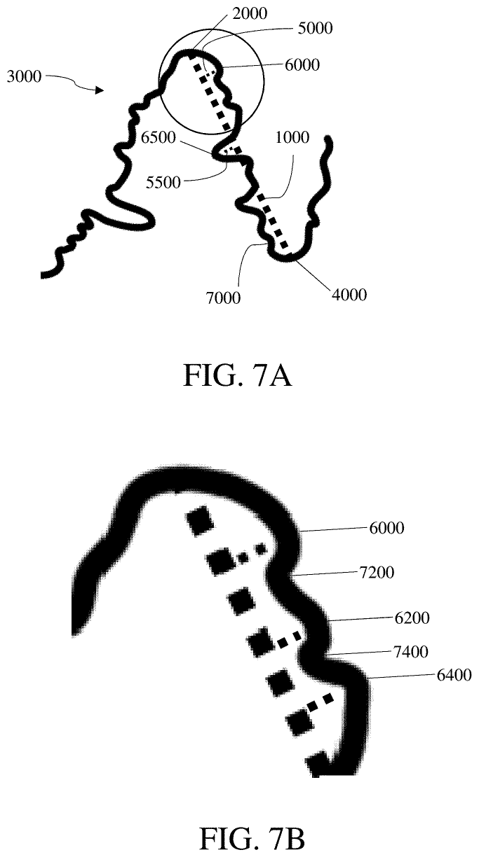

This calculation method can be understood further with reference to FIGS. 7A and 7B. In FIG. 7A, a first line segment 1000 connects a peak 2000 in a first plurality of undulations 3000 with a trough 4000. FIG. 7A also shows two examples of second line segments: the second line segment 5000 connecting the first line segment 1000 with a first point 6000 in the plurality of second undulations having a local maximum distance from the first line segment; and the second line segment 5500 connecting the first line segment 1000 with a second point 6500 in the plurality of second undulations having a local maximum distance from the first line segment. It should be noted that there may be some local minima in distances between the first line segment and the second line segment (e.g., like the local minimum 7000). Such local minima are not included in the calculations for the average height of the undulations.

FIG. 7B shows an enlarged portion of the area enclosed in the circle in FIG. 7A. As shown in FIG. 7B, the points 6000, 6200, and 6400 having local maximum distances from the first line segment are each considered to be undulations having heights for the purposes of the above-described calculation. Accordingly, second line segments are drawn between these points and the first line segment and employed in the calculation of the average height of the undulations in the second plurality of undulations. Additionally, as also shown in FIG. 7B, the points 7200 and 7400 having local minimum distances from the first line segment are not factored into this calculation.

The second pluralities of undulations described herein may comprise a variety of suitable numbers of undulations within a first plurality of undulations. In some embodiments, the average number of undulations in a second plurality undulations positioned within an undulation in a first plurality of undulations (i.e., the average number of undulations in the second plurality of undulations positioned between a peak in a first plurality of undulations and an adjacent trough) is greater than or equal to 1, greater than or equal to 2, greater than or equal to 3, greater than or equal to 4, greater than or equal to 5, greater than or equal to 6, greater than or equal to 7, greater than or equal to 8, greater than or equal to 10, greater than or equal to 12, greater than or equal to 14, greater than or equal to 16, or greater than or equal to 18. In some embodiments, the average number of undulations in a second plurality undulations positioned within an undulation in a first plurality of undulations is less than or equal to 20, less than or equal to 18, less than or equal to 16, less than or equal to 14, less than or equal to 12, less than or equal to 10, less than or equal to 8, less than or equal to 7, less than or equal to 6, less than or equal to 5, less than or equal to 4, less than or equal to 3, or less than or equal to 2. Combinations of the above-referenced ranges are also possible (e.g., greater than or equal to 1 and less than or equal to 20, or greater than or equal to 8 and less than or equal to 20). Other ranges are also possible.

For the purpose of the ranges in the preceding paragraph, the number of undulations positioned in a second plurality of undulations is equivalent to the sum of the numbers of peaks and troughs in the second plurality of undulations divided by two.

In some embodiments, one or more additional layers (e.g., a prefilter layer, an efficiency layer, and/or a supporter layer) of a filter media described herein and/or the filter media as a whole may have a waved configuration. That is, two or more pluralities of undulations may be introduced to the one or more additional layers of the filter media and/or the filter media as a whole. As noted above, the one or more additional layers may comprise any suitable layers described herein, such as a prefilter layer (e.g., a synthetic media layer, a meltblown layer, a non-woven fiber web of the first type, etc.), an efficiency layer (e.g., a non-woven fiber web of the first type), and/or a support layer (e.g., a backer, a spunbonding layer, etc.). For example, in one set of embodiments, a filter media comprising a single layer of fiber web (e.g., a non-woven fiber web of a first type) may have a waved configuration. In another example, in embodiments directed to a filter media comprising a prefilter layer (e.g., synthetic media layer, meltblown layer) in addition to an efficiency layer (e.g., a non-woven fiber web of a first type), the prefilter and efficiency layers may be passed through a creper (e.g., a microcreper) together, such that the whole filter media has an undulated configuration.

The filter media described herein may have a variety of suitable basis weights. In some embodiments, a filter media has a basis weight of greater than or equal to 5 gsm, greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 80 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, greater than or equal to 450 gsm, greater than or equal to 500 gsm, greater than or equal to 600 gsm, greater than or equal to 700 gsm, greater than or equal to 800 gsm, or greater than or equal to 900 gsm. In some embodiments, a filter media has a basis weight of less than or equal to 1000 gsm, less than or equal to 900 gsm, less than or equal to 800 gsm, less than or equal to 700 gsm, less than or equal to 600 gsm, less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 80 gsm, less than or equal to 50 gsm, less than or equal to 40 gsm, less than or equal to 30 gsm, less than or equal to 25 gsm, less than or equal to 20 gsm, less than or equal to 15 gsm, or less than or equal to 10 gsm. Combinations of the above-referenced ranges are also possible (e.g., greater than or equal to 5 gsm and less than or equal to 1000 gsm, greater than or equal to 15 gsm and less than or equal to 400 gsm, greater than or equal to 30 gsm and less than or equal to 1000 gsm, greater than or equal to 30 gsm and less than or equal to 200 gsm, greater than or equal to 50 gsm and less than or equal to 500 gsm, or greater than or equal to 80 gsm and less than or equal to 300 gsm). Other ranges are also possible.

The basis weight of the filter media described herein may be determined in accordance with ISO 536:2012.

The filter media described herein may have a variety of suitable thicknesses. In some embodiments, a filter media has a thickness of greater than or equal to 0.05 mm, greater than or equal to 0.075 mm, greater than or equal to 0.1 mm, greater than or equal to 0.15 mm, greater than or equal to 0.2 mm, greater than or equal to 0.25 mm, greater than or equal to 0.3 mm, greater than or equal to 0.4 mm, greater than or equal to 0.5 mm, greater than or equal to 0.75 mm, greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 6 mm, greater than or equal to 7 mm, greater than or equal to 8 mm, or greater than or equal to 9 mm. In some embodiments, a filter media has a thickness of less than or equal to 10 mm, less than or equal to 9 mm, less than or equal to 8 mm, less than or equal to 7 mm, less than or equal to 6 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, less than or equal to 1.5 mm, less than or equal to 1 mm, less than or equal to 0.75 mm, less than or equal to 0.5 mm, less than or equal to 0.4 mm, less than or equal to 0.3 mm, less than or equal to 0.2 mm, less than or equal to 0.15 mm, less than or equal to 0.1 mm, or less than or equal to 0.075 mm. Combinations of the above-referenced ranges are also possible (e.g., greater than or equal to 0.05 mm and less than or equal to 10 mm, greater than or equal to 0.1 mm and less than or equal to 2 mm, greater than or equal to 0.15 mm and less than or equal to 10 mm, greater than or equal to 0.2 mm and less than or equal to 1 mm, greater than or equal to 0.3 mm and less than or equal to 2 mm, or greater than or equal to 0.5 mm and less than or equal to 1.5 mm). Other ranges are also possible.

The thickness of the media described herein may be determined in accordance with ISO 534 (2011) under an applied pressure of 2 N/cm².

The filter media described herein may a variety of suitable mean flow pore sizes. The mean flow pore size of the filter media may be greater than or equal to 0.1 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 40 microns, greater than or equal to 60 microns, greater than or equal to 80 microns, greater than or equal to 100 microns, or greater than or equal to 125 microns. The mean flow pore size of the filter media may be less than or equal to 150 microns, less than or equal to 100 microns, less than or equal to 80 microns, less than or equal to 60 microns, less than or equal to 40 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 microns and less than or equal to 150 microns, greater than or equal to 1 micron and less than or equal to 100 microns, or greater than or equal to 1 microns and less than or equal to 60 microns). Other ranges are also possible.

The mean flow pore size of the filter media described herein may be determined in accordance with ASTM F316 (2003).

The filter media described herein may have any suitable solidity value. In some embodiments, a filter media has a solidity of greater than or equal to 0.001%, greater than or equal to 0.002%, greater than or equal to 0.004%, greater than or equal to 0.006%, greater than or equal to 0.008%, greater than or equal to 0.01%, greater than or equal to 0.02%, greater than or equal to 0.04%, greater than or equal to 0.06%, greater than or equal to 0.08%, greater than or equal to 0.1%, greater than or equal to 0.5%, greater than or equal to 1%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, or greater than or equal to 45%. The solidity of a filter media may be less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, less than or equal to 1%, less than or equal to 0.5%, less than or equal to 0.1%, less than or equal to 0.08%, less than or equal to 0.06%, less than or equal to 0.04%, less than or equal to 0.02%, less than or equal to 0.01%, less than or equal to 0.008%, less than or equal to 0.006%, less than or equal to 0.004%, or less than or equal to 0.002. Combinations of the above-referenced ranges are also possible (e.g., greater than or equal to 0.001% and less than or equal to 50%, greater than or equal to 0.01% and less than or equal to 40%, or greater than or equal to 0.1% and less than or equal to 30%). Other ranges are also possible.

The solidity of a filter media may be determined as described elsewhere herein with respect to the determination of the solidity of a non-woven fiber web of the first type.

The filter media described herein may have a variety of suitable air permeabilities. In some embodiments, a filter media has an air permeability of greater than or equal to 0.1 CFM, greater than or equal to 0.2 CFM, greater than or equal to 0.5 CFM, greater than or equal to 0.75 CFM, greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, or greater than or equal to 325 CFM. In some embodiments, a filter media has an air permeability of less than or equal to 350 CFM, less than or equal to 325 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, less than or equal to 2 CFM, less than or equal to 1 CFM, less than or equal to 0.75 CFM, less than or equal to 0.5 CFM, or less than or equal to 0.2 CFM. Combinations of the above-referenced ranges are also possible (e.g., greater than or equal to 0.1 CFM and less than or equal to 350 CFM, greater than or equal to 1 CFM and less than or equal to 250 CFM, or greater than or equal to 1 CFM and less than or equal to 100 CFM). Other ranges are also possible.

The air permeability of the filter media described herein may be determined in accordance with the standard TAPPI T-2551 (1985) using a test area of 38 cm² and a pressure drop of 125 Pa, which corresponds to 0.5 inches of water.

The filter media described herein may have a relatively high dry Mullen burst strength. The dry Mullen burst strength of the filter media described herein may be greater than or equal to 1 psi, greater than or equal to 2 psi, greater than or equal to 3 psi, greater than or equal to 4 psi, greater than or equal to 5 psi, greater than or equal to 6 psi, greater than or equal to 7 psi, greater than or equal to 8 psi, greater than or equal to 10 psi, greater than or equal to 15 psi, greater than or equal to 20 psi, greater than or equal to 25 psi, greater than or equal to 30 psi, greater than or equal to 40 psi, greater than or equal to 50 psi, greater than or equal to 60 psi, greater than or equal to 70 psi, greater than or equal to 80 psi, greater than or equal to 90 psi, greater than or equal to 100 psi, greater than or equal to 125 psi, greater than or equal to 150 psi, greater than or equal to 175 psi, greater than or equal to 200 psi, greater than or equal to 225 psi, greater than or equal to 250 psi, greater than or equal to 300 psi, greater than or equal to 350 psi, or greater than or equal to 400 psi. The dry Mullen burst strength of the filter media described herein may be less than or equal to 450 psi, less than or equal to 400 psi, less than or equal to 350 psi, less than or equal to 300 psi, less than or equal to 250 psi, less than or equal to 225 psi, less than or equal to 200 psi, less than or equal to 175 psi, less than or equal to 150 psi, less than or equal to 125 psi, less than or equal to 100 psi, less than or equal to 90 psi, less than or equal to 80 psi, less than or equal to 70 psi, less than or equal to 60 psi, less than or equal to 50 psi, less than or equal to 40 psi, less than or equal to 30 psi, less than or equal to 25 psi, less than or equal to 20 psi, less than or equal to 15 psi, less than or equal to 10 psi, less than or equal to 8 psi, less than or equal to 7 psi, less than or equal to 6 psi, less than or equal to 5 psi, less than or equal to 4 psi, less than or equal to 3 psi, or less than or equal to 2 psi. Combinations of the above-referenced ranges are also possible (e.g., greater than or equal to 1 psi and less than or equal to 450 psi, greater than or equal to 1 psi and less than or equal to 250 psi, greater than or equal to 5 psi and less than or equal to 450 psi, greater than or equal to 5 psi and less than or equal to 100 psi, greater than or equal to 8 psi and less than or equal to 60 psi, greater than or equal to 10 psi and less than or equal to 300 psi, or greater than or equal to 25 psi and less than or equal to 200 psi). Other ranges are also possible.

The dry Mullen burst strength of the filter media described herein may be determined in accordance with the standard TAPPI T403 (1997) test.

The filter media described herein may have a relatively high dry tensile strength in the machine direction. The dry tensile strength in the machine direction of the filter media described herein may be greater than or equal to 1 lb/in, greater than or equal to 2 lb/in, greater than or equal to 3 lb/in, greater than or equal to 4 lb/in, greater than or equal to 5 lb/in, greater than or equal to 7.5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 40 lb/in, greater than or equal to 50 lb/in, greater than or equal to 60 lb/in, greater than or equal to 75 lb/in, greater than or equal to 100 lb/in, greater than or equal to 125 lb/in, greater than or equal to 150 lb/in, or greater than or equal to 175 lb/in. The dry tensile strength in the machine direction of the filter media may be less than or equal to 200 lb/in, less than or equal to 175 lb/in, less than or equal to 150 lb/in, less than or equal to 150 lb/in, less than or equal to 125 lb/in, less than or equal to 100 lb/in, less than or equal to 75 lb/in, less than or equal to 60 lb/in, less than or equal to 50 lb/in, less than or equal to 40 lb/in, less than or equal to 30 lb/in, less than or equal to 25 lb/in, less than or equal to 20 lb/in, less than or equal to 15 lb/in, less than or equal to 10 lb/in, less than or equal to 7.5 lb/in, less than or equal to 5 lb/in, less than or equal to 4 lb/in, less than or equal to 3 lb/in, or less than or equal to 2 lb/in. Combinations of the above-referenced ranges are also possible (e.g., greater than or equal to 1 lb/in and less than or equal to 200 lb/in, greater than or equal to 1 lb/in and less than or equal to 150 lb/in, greater than or equal to 1 lb/in and less than or equal to 50 lb/in, greater than or equal to 4 lb/in and less than or equal to 20 lb/in, greater than or equal to 5 lb/in and less than or equal to 200 lb/in, greater than or equal to 10 lb/in and less than or equal to 100 lb/in, or greater than or equal to 15 lb/in and less than or equal to 50 lb/in). Other ranges are also possible.

The dry tensile strengths in the machine direction of the filter media described herein may be determined in accordance with the standard T494 om-96 (1996) test using a test span of 5 inches and a jaw separation speed of 12 in/min.

The filter media described herein may have a relatively high dry tensile strength in the cross direction of the filter media. The dry tensile strength in cross direction of the filter media described herein may be greater than or equal to 1 lb/in, greater than or equal to 2 lb/in, greater than or equal to 3 lb/in, greater than or equal to 4 lb/in, greater than or equal to 5 lb/in, greater than or equal to 7.5 lb/in, greater than or equal to 10 lb/in, greater than or equal to 15 lb/in, greater than or equal to 20 lb/in, greater than or equal to 25 lb/in, greater than or equal to 30 lb/in, greater than or equal to 40 lb/in, greater than or equal to 50 lb/in, greater than or equal to 60 lb/in, greater than or equal to 80 lb/in, greater than or equal to 100 lb/in, or greater than or equal to 125 lb/in. The dry tensile strength in the cross direction of the filter media may be less than or equal to 150 lb/in, less than or equal to 125 lb/in, less than or equal to 100 lb/in, less than or equal to 80 lb/in, less than or equal to 60 lb/in, less than or equal to 50 lb/in, less than or equal to 40 lb/in, less than or equal to 30 lb/in, less than or equal to 25 lb/in, less than or equal to 20 lb/in, less than or equal to 15 lb/in, less than or equal to 10 lb/in, less than or equal to 7.5 lb/in, less than or equal to 5 lb/in, less than or equal to 4 lb/in, less than or equal to 3 lb/in, or less than or equal to 2 lb/in. Combinations of the above-referenced ranges are also possible (e.g., greater than or equal to 1 lb/in and less than or equal to 150 lb/in, greater than or equal to 1 lb/in and less than or equal to 50 lb/in, greater than or equal to 2 lb/in and less than or equal to 150 lb/in, greater than or equal to 4 lb/in and less than or equal to 20 lb/in, greater than or equal to 5 lb/in and less than or equal to 80 lb/in, or greater than or equal to 10 lb/in and less than or equal to 40 lb/in). Other ranges are also possible.

The dry tensile strengths in the cross direction of the filter media described herein may be determined in accordance with the standard T494 om-96 (1996) test using a test span of 5 inches and a jaw separation speed of 12 in/min.

The filter media described herein may have a relatively high dry tensile elongation at break in the machine direction and/or in the cross direction. The dry tensile elongation at break of the filter media may be greater than or equal to 1%, greater than or equal to 1.5%, greater than or equal to 2%, greater than or equal to 2.5%, greater than or equal to 5%, greater than or equal to 7.5%, greater than or equal to 10%, greater than or equal to 15%, greater than or equal to 20%, greater than or equal to 25%, greater than or equal to 30%, greater than or equal to 35%, greater than or equal to 40%, greater than or equal to 50%, greater than or equal to 75%, greater than or equal to 100%, greater than or equal to 125%, greater than or equal to 150%, greater than or equal to 175%, greater than or equal to 200%, greater than or equal to 250%, greater than or equal to 300%, greater than or equal to 350%, or greater than or equal to 400%. In some embodiments, the dry tensile elongation at break of the filter media may be less than or equal to 500%, less than or equal to 400%, less than or equal to 350%, less than or equal to 300%, less than or equal to 250%, less than or equal to 200%, less than or equal to 175%, less than or equal to 150%, less than or equal to 125%, less than or equal to 100%, less than or equal to 75%, less than or equal to 50%, less than or equal to 40%, less than or equal to 35%, less than or equal to 30%, less than or equal to 25%, less than or equal to 20%, less than or equal to 15%, less than or equal to 10%, less than or equal to 7.5%, less than or equal to 5%, less than or equal to 2.5%, less than or equal to 2%, or less than or equal to 1.5%. Combinations of the above-referenced ranges are also possible (e.g., greater than or equal to 1% and less than or equal to 500%, greater than or equal to 1% and less than or equal to 40%, greater than or equal to 1% and less than or equal to 30%, greater than or equal to 5% and less than or equal to 500%, greater than or equal to 5% and less than or equal to 20%, greater than or equal to 20% and less than or equal to 300%, or greater than or equal to 40% and less than or equal to 150%). Other ranges are also possible.

The dry tensile elongations at break in the machine direction and the cross direction of a filter media may be determined in accordance with the standard T494 om-96 (1996) test using a test span of 5 inches and a jaw separation speed of 12 in/min.

In some embodiments, a filter media has a dry elongation at break in the machine direction in one or more of the ranges described above. In some embodiments, a filter media has a dry elongation at break in the cross direction in one or more of the ranges described above.

The filter media described herein may have relatively high values of stiffness in the cross direction. A filter media may have a stiffness in the cross direction of greater than or equal to 80 mg, greater than or equal to 90 mg, greater than or equal to 100 mg, greater than or equal to 125 mg, greater than or equal to 150 mg, greater than or equal to 175 mg, greater than or equal to 200 mg, greater than or equal to 250 mg, greater than or equal to 300 mg, greater than or equal to 400 mg, greater than or equal to 500 mg, greater than or equal to 750 mg, greater than or equal to 1000 mg, greater than or equal to 1250 mg, greater than or equal to 1500 mg, greater than or equal to 1750 mg, greater than or equal to 2000 mg, greater than or equal to 2500 mg, greater than or equal to 3000 mg, greater than or equal to 4000 mg, greater than or equal to 5000 mg, greater than or equal to 7500 mg, greater than or equal to 10000 mg, or greater than or equal to 15000 mg. A filter media may have a stiffness in the cross direction of less than or equal to 20000 mg, less than or equal to 15000 mg, less than or equal to 10000 mg, less than or equal to 7500 mg, less than or equal to 5000 mg, less than or equal to 3000 mg, less than or equal to 2500 mg, less than or equal to 2000 mg, less than or equal to 1750 mg, less than or equal to 1500 mg, less than or equal to 1250 mg, less than or equal to 1000 mg, less than or equal to 750 mg, less than or equal to 500 mg, less than or equal to 400 mg, less than or equal to 300 mg, less than or equal to 250 mg, less than or equal to 200 mg, less than or equal to 175 mg, less than or equal to 150 mg, less than or equal to 125 mg, less than or equal to 100 mg, or less than or equal to 90 mg. Combinations of the above-referenced ranges are also possible (e.g., greater than or equal to 80 mg and less than or equal to 20000 mg, greater than or equal to 80 mg and less than or equal to 5000 mg, greater than or equal to 100 mg and less than or equal to 20000 mg, greater than or equal to 100 mg and less than or equal to 3000 mg, greater than or equal to 300 mg and less than or equal to 2000 mg, greater than or equal to 500 mg and less than or equal to 15000 mg, or greater than or equal to 1000 mg and less than or equal to 10000 mg). Other ranges are also possible.

The stiffness of a filter media in the cross direction may be determined in accordance with TAPPI T543 om-05 (2005) using a sample size of 2 in×2.5 in.

The filter media described herein may have a variety of suitable fuel gamma values. In some embodiments, the filter media described herein may have a relatively high initial fuel gamma value. The initial fuel gamma of the filter media described herein may be greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, greater than or equal to 95, greater than or equal to 100, greater than or equal to 125, greater than or equal to 140, greater than or equal to 160, greater than or equal to 180, greater than or equal to 200, greater than or equal to 220, greater than or equal to 240, greater than or equal to 260, greater than or equal to 280, greater than or equal to 300, greater than or equal to 325, greater than or equal to 350, greater than or equal to 375, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, greater than or equal to 850, greater than or equal to 900, greater than or equal to 950, greater than or equal to 1000, greater than or equal to 2000, greater than or equal to 5000, or greater than or equal to 8000. The initial fuel gamma value of the filter media may be less than or equal to 10000, less than or equal to 8000, less than or equal to 5000, less than or equal to 2000, less than or equal to 1000, less than or equal to 950, less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 375, less than or equal to 350, less than or equal to 325, less than or equal to 300, less than or equal to 280, less than or equal to 260, less than or equal to 240, less than or equal to 220, less than or equal to 200, less than or equal to 180, less than or equal to 160, less than or equal to 140, less than or equal to 125, less than or equal to 100, less than or equal to 95, less than or equal to 90, less than or equal to 85, less than or equal to 80, less than or equal to 75, less than or equal to 70, less than or equal to 65, less than or equal to 60, or less than or equal to 55. Combinations of the above-referenced ranges are also possible (e.g., greater than or equal to 50 and less than or equal to 10000, greater than or equal to 75 and less than or equal to 8000, or greater than or equal to 125 and less than or equal to 5000). Other ranges are also possible.

The initial fuel gamma for a filter media may be determined by the same procedure described above with respect to the determination of an initial fuel gamma for a non-woven fiber web of the first type.

In some embodiments, the filter media described herein may have a relatively high overall fuel gamma value. The overall fuel gamma value of the filter media described herein may be greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, greater than or equal to 95, greater than or equal to 100, greater than or equal to 120, greater than or equal to 140, greater than or equal to 160, greater than or equal to 180, greater than or equal to 200, greater than or equal to 220, greater than or equal to 240, greater than or equal to 260, greater than or equal to 280, greater than or equal to 300, greater than or equal to 325, greater than or equal to 350, greater than or equal to 375, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, greater than or equal to 850, greater than or equal to 900, or greater than or equal to 950. The overall fuel gamma value of the filter media may be less than or equal to 1000, less than or equal to 950, less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 375, less than or equal to 350, less than or equal to 325, less than or equal to 300, less than or equal to 280, less than or equal to 260, less than or equal to 240, less than or equal to 220, less than or equal to 200, less than or equal to 180, less than or equal to 160, less than or equal to 140, less than or equal to 120, less than or equal to 100, less than or equal to 95, less than or equal to 90, less than or equal to 85, less than or equal to 80, less than or equal to 75, less than or equal to 70, less than or equal to 65, less than or equal to 60, or less than or equal to 55. Combinations of the above-referenced ranges are also possible (e.g., greater than or equal to 50 and less than or equal to 1000, greater than or equal to 75 and less than or equal to 500, or greater than or equal to 120 and less than or equal to 300). Other ranges are also possible.

The overall fuel gamma for a filter media may be determined by the same procedure described above with respect to the determination of an overall fuel gamma for a non-woven fiber web of the first type.

Some filter media described herein may have a relatively high initial efficiency at 4 microns. The initial efficiency at 4 microns of the filter media may be greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 97%, greater than or equal to 98%, greater than or equal to 99%, greater than or equal to 99.5%, greater than or equal to 99.6%, greater than or equal to 99.7%, greater than or equal to 99.8%, greater than or equal to 99.9%, greater than or equal to 99.95%, greater than or equal to 99.99%, or greater than or equal to 99.999%. The initial efficiency at 4 microns of the filter media may be less than or equal to 100%, less than or equal to 99.999%, less than or equal to 99.99%, less than or equal to 99.95%, less than or equal to 99.9%, less than or equal to 99.8%, less than or equal to 99.7%, less than or equal to 99.6%, less than or equal to 99.5%, less than or equal to 99%, less than or equal to 98%, less than or equal to 97%, less than or equal to 95%, less than or equal to 90%, less than or equal to 80%, less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 10% and less than or equal to 100%, greater than or equal to 20% and less than or equal to 99.999%, or greater than or equal to 30% and less than or equal to 99.99%). Other ranges are also possible.

The initial efficiency at 4 microns for a filter media may be determined by the same procedure described above with respect to the determination of an initial efficiency for a non-woven fiber web of the first type.

Some filter media described herein may have a relatively high overall efficiency at 4 microns. The overall efficiency at 4 microns of the filter media may be greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 97%, greater than or equal to 98%, greater than or equal to 99%, greater than or equal to 99.5%, greater than or equal to 99.6%, greater than or equal to 99.7%, greater than or equal to 99.8%, greater than or equal to 99.9%, greater than or equal to 99.95%, greater than or equal to 99.99%, or greater than or equal to 99.999%. The overall efficiency at 4 microns of the filter media may be less than or equal to 100%, less than or equal to 99.999%, less than or equal to 99.99%, less than or equal to 99.95%, less than or equal to 99.9%, less than or equal to 99.8%, less than or equal to 99.7%, less than or equal to 99.6%, less than or equal to 99.5%, less than or equal to 99%, less than or equal to 98%, less than or equal to 97%, less than or equal to 95%, less than or equal to 90%, less than or equal to 80%, less than or equal to 70%, less than or equal to 60%, less than or equal to 50%, less than or equal to 40%, less than or equal to 30%, or less than or equal to 20%. Combinations of the above-referenced ranges are also possible (e.g., greater than or equal to 10% and less than or equal to 100%, greater than or equal to 20% and less than or equal to 99.999%, or greater than or equal to 30% and less than or equal to 99.99%). Other ranges are also possible.

The overall efficiency at 4 microns for a filter media may be determined by the same procedure described above with respect to the determination of an overall efficiency for a non-woven fiber web of the first type.

Some filter media described herein may have a relatively high dust holding capacity. The dust holding capacity of the filter media may be greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 200 gsm, greater than or equal to 300 gsm, greater than or equal to 400 gsm, greater than or equal to 500 gsm, greater than or equal to 600 gsm, greater than or equal to 700 gsm, greater than or equal to 800 gsm, or greater than or equal to 900 gsm. The dust holding capacity of the filter media may be less than or equal to 1000 gsm, less than or equal to 900 gsm, less than or equal to 800 gsm, less than or equal to 700 gsm, less than or equal to 600 gsm, less than or equal to 500 gsm, less than or equal to 400 gsm, less than or equal to 300 gsm, less than or equal to 200 gsm, less than or equal to 100 gsm, less than or equal to 90 gsm, less than or equal to 80 gsm, less than or equal to 70 gsm, less than or equal to 60 gsm, less than or equal to 50 gsm, or less than or equal to 40 gsm. Combinations of the above-referenced ranges are also possible (e.g., greater than or equal to 30 gsm and less than or equal to 1000 gsm, greater than or equal to 60 gsm and less than or equal to 700 gsm, or greater than or equal to 90 gsm and less than or equal to 500 gsm). Other ranges are also possible.

As mentioned, references herein to dust holding capacity refer to the injected dust holding capacity. In other words, the ranges provided above relate to the injected dust holding capacity of the filter media. This dust holding capacity may be determined by the same procedure described above with respect to the determination of dust holding capacity for a non-woven fiber web of the first type.

One or more layers of the filter media may include one or more additives, as appropriate. In some embodiments, various layers of the filter media (e.g., a non-woven fiber web of a first type, prefilter layer(s), backer(s), etc.) may include one or more additives or agents (typically in small amounts/percentages), such as anti-bacterial agents, fungicides, flame retardants, dyes, dispersants, surfactants, defoamers, coupling agents, crosslinking agents, thickeners, catalysts, ammonia, fillers, optical brighteners, absorbents, and/or anti-static agents, amongst others.

In some embodiments, the filter media and/or one or more layers of the filter media (e.g., a non-woven fiber web of a first type, prefilter layer(s), backer(s), etc.) may be subjected to one or more optional surface treatments. For instance, chemical vapor deposition (CVD) (e.g., plasma enhanced CVD, audio frequency and/or radio frequency plasma enhanced CVD, microwave discharge CVD, atmospheric plasma discharge CVD, DC plasma discharge CVD) may be used to functionalize a surface thereof. As one example, a layer may be exposed to an oxygen plasma. This treatment may cause surface oxidation of the layer, may create functional groups such as alcohols and carboxylic acids at the surface of the layer, and/or may increase the hydrophilicity of the layer. As another example, one or more monomers (e.g., acrylic acid monomers such as hydroxyethylmethacrylate, fluorinated monomers such as hexafluorobutanoic acid, CF₄, CHF₃, C₂F₆, C₃F₈, C₄F₈, C₂F₄, C₃F₆, and the like) may be deposited onto the layer using CVD. In some embodiments, the monomers may be deposited in the presence of a carrier gas (e.g., an inert gas such as helium or argon). Depositing these monomers may affect the hydrophobicity of the surface of the layer (e.g., acrylic acid monomers may cause the surface to become more hydrophilic, fluorinated monomers may cause the surface to become more hydrophobic). In some embodiments, a CVD treatment may comprise exposing the layer to ammonia optionally accompanied by one or more inert gases (e.g., helium, argon). Other surface treatments (e.g., other CVD treatments) are also possible.

In some embodiments, the filter media (and/or one or more layers of the filter media) may be fire resistant. As used herein, the term “fire resistant filter media” has its ordinary meaning in the art and may refer to a filter media which passes a glow wire test according to IEC60695-2-11 (2010). As used herein, the term “fire resistant fiber” has its ordinary meaning in the art and may refer to a fiber having a fire resistant additive distributed within and/or throughout the fiber. In general, the fiber may comprise any suitable fire resistant additive that has sufficient fire resistance properties.

In general, the fiber may comprise any suitable fire resistant additive that has sufficient fire resistance properties. In some such embodiments, the fire resistant fibers comprise a fire resistant additive. For example, the fire resistant additive fibers may comprise a phosphorus-based fire resistant additive and/or a nitrogen-based fire resistant additive. Non-limiting examples of fire resistant additives include phosphorous-based additives (e.g., propionylmethylphosphinate), dioxaphosphorinane and derivatives thereof, triazine-based compounds, phosphoramidate and derivates thereof, allyl-functionalized polyphosphazene, and non-halogenated compounds such as hydroxymethylphosphonium salts and N-methylol phosphonopropionamide and derivatives thereof.

In some embodiments, a filter media described herein may be a component of a filter element. That is, the filter media may be incorporated into an article suitable for use by an end user.

Non-limiting examples of suitable filter elements include flat panel filters, V-bank filters (comprising, e.g., between 1 and 24 Vs), cartridge filters, cylindrical filters, and conical filters. Filter elements may have any suitable height (e.g., between 2 in and 124 in for flat panel filters, between 4 in and 124 in for V-bank filters, between 1 in and 124 in for cartridge and cylindrical filter media). Filter elements may also have any suitable width (between 2 in and 124 in for flat panel filters, between 4 in and 124 in for V-bank filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

As described above, in some embodiments, a filter media described herein may be a component of a filter element and may be pleated. The pleat height and pleat density (number of pleats per unit length of the media) may be selected as desired. In some embodiments, the pleat height may be greater than or equal to 3 mm, greater than or equal to 5 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 15 mm, less than or equal to 10 mm, or less than or equal to 5 mm. Combinations of the above-referenced ranges are also possible (e.g., greater than or equal to 3 mm and less than or equal to 510 mm, greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

The filter media described herein may be employed to filter a variety of suitable fluids. Some methods may comprise passing a fluid through a filter media. One example of a suitable type of fluid is hydraulic fluid. Another is fuel.

A filter media described herein is incorporated into a fuel filter element (e.g., a cylindrical fuel filter element). Fuel filter elements can be of varying types, e.g., fuel filter elements to remove particulates, fuel-water separators to remove water from diesel fuel, and fuel filter elements that perform both particulate separation and water separation. The fuel filter element may be a single stage element or multiple stage element. In some cases, the filter media can be pleated or wrapped, supported or unsupported, cowrapped/copleated with multiple filter media. In some designs, the filter media is pleated with a wrapped core in the center.

### EXAMPLE 1

This Example describes a non-woven fiber web comprising glass fibers, fibrillated fibers, and multicomponent fibers and compares its physical properties to non-woven fiber webs that lack one or more of these components.

Three non-woven fiber webs (Sample 1, Sample 2, and Sample 3) were formed from the furnish shown in Table 1 by a wet laying process. Sample 1 was formed from a furnish comprising fibrillated fibers and binder fibers. Sample 2 was formed from a furnish comprising glass fibers, fibrillated fibers, and binder fibers. Sample 3 was formed from a furnish comprising glass fibers and binder fibers. The same types of fibrillated fibers (i.e., lyocell fibers having a Canadian Standard Freeness value of 120 mL) and glass fibers (i.e., microglass fibers having an average diameter of 0.8 microns) were used in each of the three samples.

The fabrication process of Sample 2 was as follows. The fibrillated fibers (e.g., lyocell) were first dispersed in a high-speed Waring blender for 30 seconds, and then mixed with binder fibers and glass fibers in a TAPPI disintegrator for another 2 minutes to form a mixed slurry. The mixed slurry was placed in a handsheet mold and the non-woven fiber web was formed on a wire. After that, the non-woven fiber web was drained and dried, then moving into a 160° C. oven for 10 minutes to activate the binder fibers. Sample 1 and Sample 3 were formed in manner similar to that employed for Sample 2. However, microglass fibers were not added in Sample 1 and fibrillated fibers was not added to Sample 3. In Sample 3, a Waring blending was not used because no fibrillation fibers were added. Selected physical properties of the three samples are tabulated in Table 2.

TABLE 1

| Fiber Type | Sample 1 | Sample 2 | Sample 3 |
|---|---|---|---|
| Fibrillated fibers (wt %) | 70% | 40% | None |
| Binder fibers (wt %) | 30% | 30% | 30% |
| Microglass fibers (wt %) | None | 30% | 70% |

TABLE 2

| | Sample 1 | Sample 2 | Sample 3 |
|---|---|---|---|
| Basis Weight (gsm) | 65 | 65 | 65 |
| Air Permeability (CFM) | 7.2 | 7.5 | 6.9 |
| Initial Efficiency (%) at 4 microns | 98.60 | 99.80 | 99.67 |
| Overall Efficiency (%) at 4 microns | 99.70 | 99.93 | 99.73 |
| Dust Holding Capacity (gsm) | 151 | 165 | 151 |

As shown in Table 2, Sample 2 exhibited both high initial efficiency and high overall efficiency. For example, Sample 2 exhibited substantially better initial efficiency than Sample 1. Without wishing to be bound by any particular theory, it is believed that the glass fibers present in Sample 2 fill in any pores that are relatively large in size and would otherwise be unfilled. It is believed that the filling of these pores enhances the initial efficiency of the filter media. Additionally, Sample 2 exhibited better wet strength, less fiber migration, less shedding, and better rotary pleatability compared to Sample 3. In short, a fiber web including a blend of fibrillated fibers and glass fibers exhibited both advantages some advantages associated with the presence of fibrillated fibers (good wet strength, limited fiber migration, limited shedding issues, rotary pleatability) and an advantage associated with the presence of glass fibers (high initial efficiency).

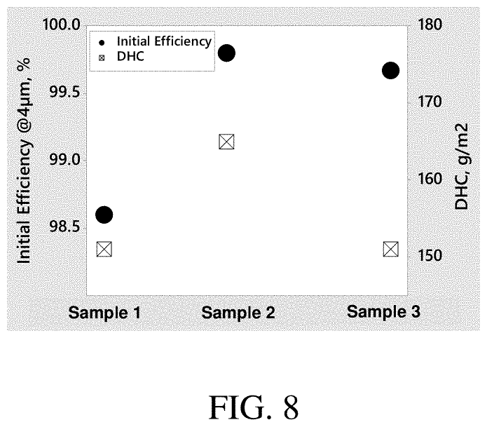

In addition to having a higher initial efficiency than both Samples 1 and 3, Sample 2 also exhibited a higher dust holding capacity than these samples. FIG. 8 is a plot of initial efficiency and dust holding capacity of the three samples described herein.

Sample 1 and Sample 3 had similar overall efficiencies. Without wishing to be bound by any particular theory, it is believed that this evidences the proposition that the overall efficiency is mostly determined by the fiber size in the non-woven fiber web, as the fibrillated fibers in Sample 1 had fibrils with similar fiber size (e.g., average fiber diameter) as that of the microglass fibers in Sample 3.

However, Sample 1 had a lower initial efficiency than Sample 3. Without wishing to be bound by any particular theory, it is believed that the lower initial efficiency of Sample 1 may be attributed to the presence of small amounts of parent fibers in the fibrillated fibers, which are believed to have caused the formation of a limited number of relatively big pores in the non-woven web. It is also believed that those relatively big pores constituted only a small portion of the total amount of pores and so did not substantially affect the overall efficiency, as shown in Table 2.

### EXAMPLE 2

This Example describes a process for selecting a combination of glass fibers and fibrillated fibers for use in a non-woven fiber web.

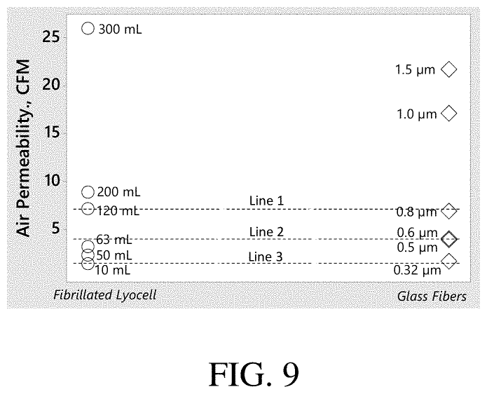

First, the effect of changing the Canadian Standard Freeness value of fibrillated fibers in a non-woven fiber web on the air permeability of the non-woven fiber web was investigated. Non-woven fiber webs comprising fibrillated fibers and binder fibers were fabricated by the same procedure described in Example 1. A set of non-woven fiber webs of this type but including lyocell having different levels of fibrillation was formed. Specifically, the air permeabilities of otherwise equivalent non-woven fiber webs comprising fibrillated lyocell having CSF values of 10 mL, 50 mL, 63 mL, 120 mL, 200 mL, and 300 mL were compared to each other (FIG. 9).

Second, the effect of changing the level of average fiber diameter of glass fibers in a non-woven fiber web on the air permeability of the non-woven fiber web was investigated. Non-woven fiber webs comprising glass fibers and binder fibers were fabricated by the same procedure described in Example 1. Since fibrillated fibers were not present in these samples, a Waring blender was not used and a TAPPI disintegrator was used to disperse glass and binder fibers. A set of non-woven fiber webs of this type but including glass fibers having different average fiber diameters was formed. Specifically, the air permeabilities of otherwise equivalent non-woven fiber webs comprising glass fibers having average fiber diameters of 0.32 microns, 0.5 microns, 0.6 microns, 0.8 microns, 1 micron, and 1.5 microns were compared to each other (FIG. 9).

For both of the above analyses, the non-woven fiber webs had the same basis weight and same amount of binder fibers. This allowed for a comparison of the air permeabilities otherwise equivalent non-woven fiber webs comprising different types of fibers (i.e., glass instead of lyocell, lyocell fibers having different levels of fibrillation, glass fibers having different average fiber diameters). From this comparison, some non-woven fiber webs comprising fibrillated lyocell fibers but not glass fibers were observed to have similar air permeability to non-woven fiber webs comprising glass fibers but not fibrillated lyocell fibers. This air permeability matching was then employed to determine a relationship between the Canadian Standard Freeness value of the lyocell fibers and the average fiber diameter of the glass fibers that would allow for the selection of a pair of lyocell fibers and glass fibers that would be expected to contribute to the air permeability of a non-woven fiber web in a substantially similar manner.

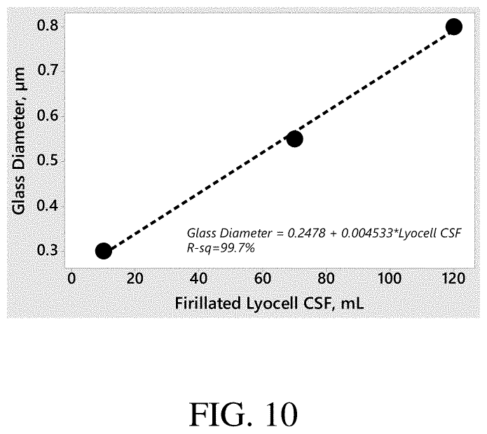

As shown in FIG. 9, the non-woven fiber web formed by lyocell with an average Canadian Standard Freeness value of about 120 mL had the same air permeability as the non-woven fiber web formed by glass fibers having an average fiber diameter of 0.8 micron (e.g., as represented by line 1); hence the lyocell fibers with a CSF of 120 mL affected the air permeability of the non-woven fiber web in which they were positioned in a similar manner to glass fibers having a 0.8 micron average fiber diameter. Similarly, fibrillated lyocell fibers having an air permeability of about 70 mL affected the air permeability of the non-woven fiber web in which they were positioned in a similar manner to glass fibers having an average fiber diameter of 0.55 microns (e.g., as represented by line 2). As a third example, fibrillated lyocell fibers having an air permeability of about 10 mL affected the air permeability of the non-woven fiber web in which they were positioned in a similar manner to glass fibers having an average fiber diameter of 0.3 microns (e.g., as represented by line 3). By plotting and fitting the Canadian Standard Freeness value of lyocell fibers against the average fiber diameter of the glass fibers with which they were matched (FIG. 10), the average fiber diameter of glass fibers (D_{glass}) could be linearly correlated (with a high R² value of 99.7%) to a Canadian Standard Freeness value of the fibrillated fibers:

D_{glass}=0.25+0.0045 CSF_{fibrillated} [1]

Equation 1 provided a rough guideline for selecting combinations of fibrillated fibers having a certain Canadian Standard Freeness value and glass fibers of a corresponding average fiber diameter.

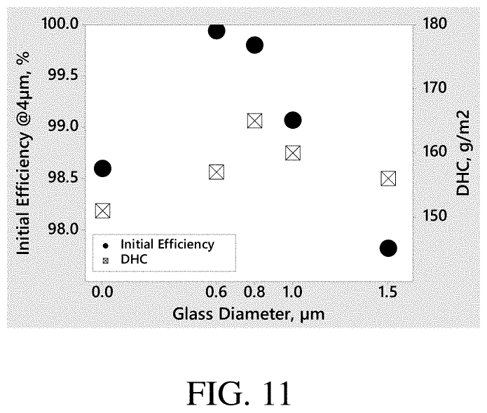

Subsequently, experiments were carried out to analyze the filtration performance of non-woven webs containing different blends of glass fibers, fibrillated fibers, and binder fibers. Specifically, non-woven fiber webs comprising lyocell fibers with a Canadian Standard Freeness value of 120 mL and glass fibers having average fiber diameters of 0.6 microns, 0.8 microns, 1 micron, or 1.5 microns were fabricated. The same fabrication method from Example 1 was used to make these non-woven fiber webs. The non-woven fiber web basis weight and the relative amounts of the different fibers were kept constant (40 wt % of lyocell, 30 wt % glass fibers, and 30 wt % binder fibers), allowing for the effect of varying glass average fiber diameter to be analyzed (FIG. 11).

As shown in FIG. 11, non-woven fiber webs comprising lyocell fibers having a Canadian Standard Freeness value of 120 mL and glass fibers having an average fiber diameter 0.6 microns exhibited an increased initial efficiency of the non-woven web compared to non-woven fiber webs lacking glass fibers (the average fiber diameter of 0 microns for the glass fibers shown in FIG. 11 indicates that the relevant sample lacks glass fibers). Non-woven fiber webs comprising lyocell fibers having a Canadian Standard Freeness value of 120 mL and glass fibers having higher average fiber diameters exhibited reduced initial efficiencies in comparison to the previously-described non-woven fiber web. The initial efficiencies decreased with increasing average fiber diameter of the glass fibers.

The dust holding capacities of the non-woven fiber webs also mostly decreased with increasing average fiber diameter of the glass fibers. However, the dust holding capacity of the non-woven fiber web comprising glass fibers having an average fiber diameter of 0.8 microns was higher than the dust holding capacity of the non-woven fiber web comprising glass fibers having an average fiber diameter of 0.6 microns (e.g., as shown in FIG. 11).

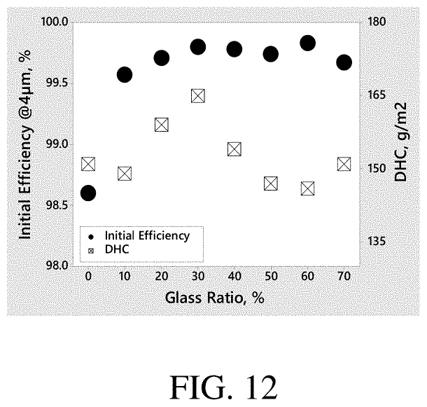

Next, experiments were carried out to assess the filtration performance of non-woven webs having different relative amounts of glass fibers. Non-woven fiber webs comprising lyocell fibers having a Canadian Standard Freeness value of 120 mL, glass fibers having an average fiber diameter of 0.8 microns, and binder fibers were fabricated. These non-woven fiber webs had different relative amounts of the fibrillated lyocell fibers and the glass fibers, but were otherwise equivalent. As shown in FIG. 12, increasing glass fiber content correlated with increasing initial efficiency for non-woven fiber webs including less than 30 wt % glass fibers, after which the initial efficiency remained relatively constant. Additionally, non-woven fiber webs including 30 wt % glass fibers exhibited the highest dust holding capacity, indicating that non-woven fiber webs including approximately 30 wt % glass fibers may display a variety of desirable physical properties.

Similar experiments were carried out for different types of fibrillated fibers and glass fibers. Specifically, non-woven fiber webs comprising lyocell fibers having a Canadian Standard Freeness value of 50 mL and glass fibers having an average fiber diameter of 0.6 microns were prepared. These non-woven fiber webs included different relative amounts of lyocell fibers and glass fibers (e.g., the wt % of glass fiber varied from 0 wt % to 70 wt %) but were otherwise equivalent. The same fabrication method from Example 1 was used to make these non-woven fiber webs.

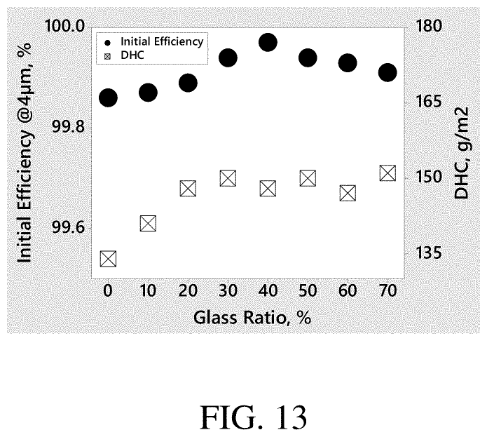

As shown in FIG. 13, the initial efficiency first increased with an increase in the amount of glass in the non-woven fiber web until the amount of glass in the non-woven fiber web reached about 40 wt %, after which the initial efficiency decreased. Meanwhile, the dust holding capacity increased with an increase in the amount of glass in the non-woven fiber web until reaching a plateau at a glass content of about 30 wt %. Taken together, this data indicates that non-woven fiber webs including approximately 40 wt % glass fibers may display a variety of desirable physical properties.

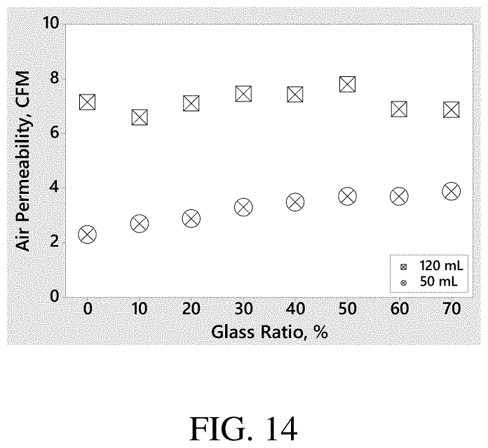

Next, the air permeability value was compared for non-woven fiber webs containing different blends of fibrillated and glass fibers. FIG. 14 plots the air permeability for the same samples shown in FIG. 12 (i.e., samples comprising lyocell fibers having a Canadian Standard Freeness value of 120 mL blended with glass fibers having an average diameter of 0.8 microns) and FIG. 13 (i.e., samples comprising lyocell fibers having a Canadian Standard Freeness value of 50 mL blended with glass fibers having an average diameter of 0.6 microns). As can be seen in FIG. 14, non-woven fiber webs including fibrillated fibers having a higher Canadian Standard Freeness value (i.e., CSF value of 120 mL) exhibited higher air permeabilities than non-woven fiber webs including fibrillated fibers having a lower Canadian Standard Freeness value (i.e., CSF value of 50 mL). Overall, as shown in FIGS. 12-14, both the non-woven fiber webs including fibrillated fibers having a higher Canadian Standard Freeness value (i.e., CSF value of 120 mL) and the non-woven fiber webs including fibrillated fibers having a lower Canadian Standard Freeness value (i.e., CSF value of 50 mL) exhibited initial efficiencies at 4 microns of greater than or equal to 99.5%; however, the non-woven fiber webs including fibrillated fibers having a higher Canadian Standard Freeness value exhibited both higher air permeability and higher dust holding capacities compared to the non-woven fiber webs including fibrillated fibers having a lower Canadian Standard Freeness value.

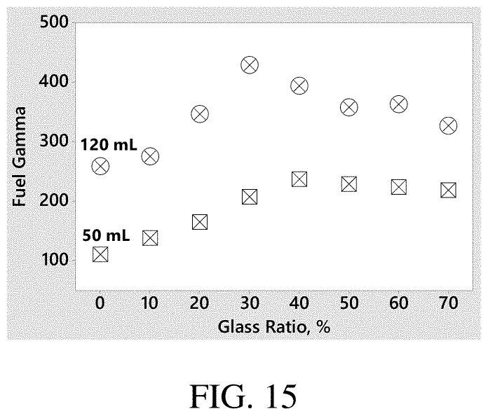

Initial fuel gammas for the above-described nonwoven fiber webs were computed and are shown in FIG. 15. As can be seen from FIG. 15, the non-woven fiber webs comprising the fibrillated fibers having the higher Canadian Standard Freeness value had higher values of fuel gamma than the non-woven fiber webs comprising the fibrillated fibers having the lower Canadian Standard Freeness value. Additionally, the initial fuel gamma generally increased with increasing glass fiber content.

### EXAMPLE 3

This Example compares selected properties of a non-woven fiber web comprising a plurality of undulations to an otherwise equivalent non-woven fiber web lacking the plurality of undulations.

Two non-woven fiber webs comprising glass fibers, fibrillated fibers, and binder fibers were fabricated using the wetlaying process described in Example 1. Sample 4 was a non-woven fiber web that comprised lyocell fibers with a Canadian Standard Freeness value of 120 mL and glass fibers having an average fiber diameter of 0.8 microns. It had the following composition: 28 wt % lyocell fibers, 20 wt % glass fibers, 20 wt % unfibrillated polyethylene terephthalate fibers, and 32 wt % bicomponent fibers. Sample 5 had the same composition as Sample 4. In fact, to make Sample 5, Sample 4 was subjected to a microcreping process, after which Sample 4 gained two pluralities of undulations and became Sample 5. The basis weight increased significantly after the microcreping process (e.g., as shown by the basis weight of Sample 5 in Table 2). Selected physical properties were measured, which are presented in Table 3.

TABLE 3

| | Sample 4 | Sample 5 |
|---|---|---|
| Basis weight (gsm) | 63 | 200 |
| Air permeability (CFM) | 6.4 | 10.6 |
| Initial efficiency (%) at 4 microns | 99.87 | 99.87 |
| Overall efficiency (%) at 4 microns | 99.92 | 99.64 |
| Dust holding capacity (gsm) | 162 | 373 |

As shown in Table 3, the sample that was microcreped and included the pluralities of undulations (Sample 5) had a dust holding capacity that was more than 2 times the dust holding capacity of the sample lacking the pluralities of undulations (Sample 4). In addition, the sample that included the pluralities of undulations (Sample 5) had a higher air permeability than the sample lacking the pluralities of undulations (Sample 4).

### EXAMPLE 4

This Example shows selected properties of filter media comprising a non-woven fiber web of the first type.

Three different filter media comprising a non-woven fiber web of the first type were fabricated: a filter media including a single layer that was a non-woven fiber web of the first type (Sample 7); a filter media including that same non-woven fiber web of the first type and further including a synthetic media layer comprising monocomponent synthetic staple fibers (Sample 8); and a filter media including that same non-woven fiber web of the first type and further including a meltblown layer (Sample 9). For Sample 8, the two layers were formed in a single wet laying process and, after the conclusion of this procedure, comprised fibers that intermingled between both layers. For Sample 9, the meltblown layer had an air permeability of 60 CFM and was bonded to the non-woven fiber web of the first type by adhesive lamination.

Below, Table 4 shows the composition of the non-woven fiber web of the first type, Table 5 shows the composition of the synthetic media layer, and Table 6 shows the selected properties of these three filter media. As can be seen from Table 6, these filter media had comparable air permeabilities and all showed good initial efficiency at 4 microns, overall efficiency at 4 microns, and dust holding capacity. Additionally, Samples 8 and 9 showed further improved dust holding capacity while maintaining high initial and overall efficiencies at 4 microns.

TABLE 4

| | Wt % with Respect to |
|---|---|
| | Non-Woven Fiber Web |
| Fiber Type | of the First Type |
| Binder Fibers | 30 |
| Fibrillated Fibers | 40 |
| Microglass Fibers | 30 |

TABLE 5

| | Wt % with Respect to |
|---|---|
| | Non-Woven Fiber Web |
| Fiber Type | of the First Type |
| Monocomponent PET Staple Fibers | 70 |
| Multicomponent Fibers | 30 |

TABLE 6

| Filter Media | Sample 7 | Sample 8 | Sample 9 |
|---|---|---|---|
| Basis weight (gsm) | 49 | 74 | 89 |
| Air permeability (CFM) | 5.6 | 5.2 | 5.0 |
| Initial efficiency (%) at 4 microns | 99.95 | 99.92 | 99.81 |
| Overall efficiency (%) at 4 microns | 99.97 | 99.96 | 99.96 |
| Dust holding capacity (gsm) | 146 | 190 | 185 |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A filter media, comprising:
a non-woven fiber web comprising fibrillated fibers, glass fibers, and binder fibers, wherein:
the fibrillated fibers have an average Canadian Standard Freeness value of greater than or equal to 105 mL,
the glass fibers are present in an amount of greater than 20 wt % of the non-woven fiber web, and
the binder fibers are present in an amount of greater than or equal to 11 wt % of the non-woven fiber web.

2. A filter media, comprising:
a non-woven fiber web comprising fibrillated fibers and glass fibers, wherein:
the glass fibers have an average fiber diameter D_{glass},
D_{glass} is measured in microns,
the fibrillated fibers have an average Canadian Standard Freeness value measured in mL,
the average Canadian Standard Freeness value of the fibrillated fibers deviates from CSF_{fibrillated} in the following equation by less than or equal to 50%:
D_{glass}=0.25+0.0045 CSF_{fibrillated}, and
CSF_{fibrillated} is measured in mL.

3. The filter media of claim 1, wherein the average Canadian Standard Freeness value of the fibrillated fibers deviates from CSF_{fibrillated} in the following equation by less than or equal to 20%.

4. The filter media of claim 1, wherein the filter media comprises a single non-woven fiber web.

5. The filter media of claim 1, further comprising one or more additional layers, wherein the one or more additional layers comprise synthetic fibers, natural fibers, glass fibers, solvent spun fibers, melt-electrospun fibers, spunbond fibers, and/or meltblown fibers.

6-10. (canceled)

11. The filter media of claim 1, wherein the fibrillated fibers comprise lyocell.

12. The filter media of claim 1, wherein the fibrillated fibers make up greater than or equal to 1 wt % and less than or equal to 69 wt % of the non-woven fiber web.

13. (canceled)

14. The filter media of claim 1, wherein the fibrillated fibers comprise parent fibers and fibrils, wherein the parent fibers have an average fiber diameter of greater than or equal to 1 micron and less than or equal to 20 microns, and wherein the fibrils have an average fiber diameter greater than or equal to 0.1 micron and less than or equal to 4 microns.

15. The filter media of claim 1, wherein the glass fibers are present in an amount of less than or equal to 88 wt % of the non-woven fiber web.

16. (canceled)

17. The filter media of claim 1, wherein the glass fibers have an average fiber diameter of greater than or equal to 0.1 micron and less than or equal to 30 microns.

18-19. (canceled)

20. The filter media of claim 1, wherein the binder fibers comprise bicomponent fibers.

21. The filter media of claim 1, wherein the binder fibers make up less than or equal to 79 wt % of the non-woven fiber web.

22. The filter media of any preceding claim 1, wherein the binder fibers have an average fiber diameter of greater than or equal to 1 micron and less than or equal to 20 microns.

23. The filter media of claim 1, wherein a weight ratio of the fibrillated fibers to the glass fibers is greater than or equal to 1:50 and less than or equal to 50:1.

24-34. (canceled)

35. The filter media of claim 1, wherein the non-woven fiber web has a dry Mullen burst strength of greater than or equal to 1 psi and less than or equal to 150 psi.

36. The filter media of claim 1, wherein the non-woven fiber web has a dry tensile strength in the machine direction and/or cross direction of greater than or equal to 1 lb/in and less than or equal to 80 lb/in.

37. The filter media of claim 1, wherein the non-woven fiber web has a dry tensile breaking elongation at break in the machine direction and/or cross direction of greater than or equal to 1% and less than or equal to 40%.

38. The filter media of claim 1, wherein the non-woven fiber web has an air permeability value of greater than or equal to 0.1 CFM and less than or equal to 350 CFM.

39. The filter media of claim 1, wherein the non-woven fiber web has an initial fuel gamma value of greater than or equal to 50.

40-41. (canceled)

42. The filter media of claim 1, wherein the non-woven fiber web has mean flow pore size of greater than or equal to 0.1 microns and less than or equal to 150 microns.

43. The filter media of claim 1, wherein the glass fibers comprise microglass fibers.
